(19) United States
(12) Patent Application Publication
(10) Pub. No.: US 2011/0231478 A1
(43) Pub. Date: Sep. 22, 2011

(54) System, Server, and Mobile Device for Content Provider Website Interaction and Method Therefore

(75) Inventors: Maxon R. WHEELER, San Jose, CA (US); William N. CAMP, II, Mountain View, CA (US); Lien T. MAMITSUKA, San Jose, CA (US); Christopher A. MITRA, Minneapolis, MN (US); Scott I. PUTTERMAN, Cupertino, CA (US); Paul W. HANGAS, San Jose, CA (US); Cyrus P. MASTER, Riverdale, UT (US); Xin HU, San Jose, CA (US); Sapna SAWHNEY, Sunnyvale, CA (US); Heather M. LEROY, Saratoga, CA (US); Christopher RYPINSKI, Sunnyvale, CA (US); Tony ROBINSON, Sunnyvale, CA (US); Stephen J. SEWERYNEK, Foster City, CA (US); Milan S. BRAHMBHATT, Milpitas, CA (US); Anish M. SHAH, San Jose, CA (US); Kai WEI, San Jose, CA (US)

(73) Assignee: Motorola, Inc., Schaumburg, IL (US)

(21) Appl. No.: 12/878,705

(22) Filed: Sep. 9, 2010

Related U.S. Application Data
(60) Provisional application No. 61/241,370, filed on Sep. 10, 2009.

(51) Int. Cl. G06F 15/16; G06F 15/173

(52) U.S. Cl. 709/203; 709/224

(57) ABSTRACT

An aggregate service server, configured to communicate with a user device and a plurality of different content providers. A processor configured to obtain content from the plurality of different content providers and further configured to push the obtained content to the user device.

### CLAIM OF PRIORITY

This application claims priority from U.S. Provisional Patent Application A METHOD GENERATING A MESSAGE FOR ONE OR MORE CONTENT PROVIDER WEBSITES; Application No. 61/241,370, filed Sep. 10, 2009, which is incorporated herein by reference.

### FIELD OF THE INVENTION

The present invention relates to communications involving mobile devices and, more particularly, to communications between such mobile devices and internet content provider websites.

### BACKGROUND OF THE INVENTION

Content provider websites (CPWs), such as social networking websites (SNWs), news feeds, music and photograph websites, as well as other types of websites such as business-to-business (b2b) or business-to-consumer (b2c) websites, are interactive websites that allow for the downloading and/or uploading (e.g., posting) of various forms of data, such as news, weather, personal and/or business information, pictures, videos, and songs, and thereby facilitate the creation and maintaining of interpersonal connections among persons and groups of persons. The uploading of data to a CPW by one user can allow other users to access and/or download the uploaded data. Typically, a SNW provides the architecture for countless users to create respective personal or professional spaces that respectively identify the respective users and allow uploaded data to be associated with the respective spaces.

CPWs can be in communication with users who are operating any of a variety of different types of devices, which are in contact with the CPWs often by way of internet-type networks. Increasingly, users employ mobile devices to interact with the CPWs. As such communications activities increase, there is developing an increased need for improving the quality and/or user-friendliness in conducting such communications activities. Further, there is also developing an increased need for improving the efficiency of such communications activities to improve battery performance of mobile devices and reduce data transmissions for all devices.

It would therefore be advantageous if improvements, in the form of improved mobile devices and/or other devices, and/or improved methods for allowing mobile devices to communicate with CPWs, can be provided that will help to address, at least partly, one or more of the aforementioned developing needs.

### BRIEF DESCRIPTION OF THE DRAWINGS

FIG. 1 shows in schematic form an example communications system involving a plurality of mobile devices in communication with a plurality of content provider websites, where some of the communications occur via an intermediary web server;

FIG. 2 is a block diagram showing example components of one of the mobile devices of FIG. 1;

FIG. 3 is a block diagram showing example components of the intermediary web server of FIG. 1; and

FIGS. 4-9 are exemplary flow charts showing various example steps of operation of the intermediary web server and mobile devices of FIG. 1;

FIG. 10 is an exemplary flow chart illustrating operation of an intermediary server;

FIG. 11 is an exemplary flow chart illustrating operation of a mobile device;

FIG. 12 is an exemplary flow chart illustrating operation of an intermediary server;

FIG. 13 is an exemplary flow chart illustrating operation of an intermediary server;

FIG. 14 illustrates and exemplary operation of a mobile device;

FIG. 15 is an exemplary low chart illustrating operation of a mobile device;

FIG. 16 is an exemplary low chart illustrating operation of an intermediary server;

FIG. 17 is another exemplary communications system in accordance with an embodiment;

FIG. 18 is yet another exemplary communications system in accordance with an embodiment;

FIG. 19 illustrates an exemplary communication between a client device and an intermediate server;

FIG. 20 illustrates an exemplary push service of the back-end of an intermediate server;

FIG. 21 illustrate an exemplary method for importing contacts in accordance with one embodiment;

FIG. 22 illustrates an exemplary sequence in accordance with an embodiment;

FIG. 23-30 illustrate exemplary screens from a client device in accordance with an embodiment;

FIG. 31 illustrates another exemplary communications system in accordance with an embodiment; and

FIG. 32 illustrates an exemplary protocol in accordance with one embodiment.

### DETAILED DESCRIPTION OF THE INVENTION

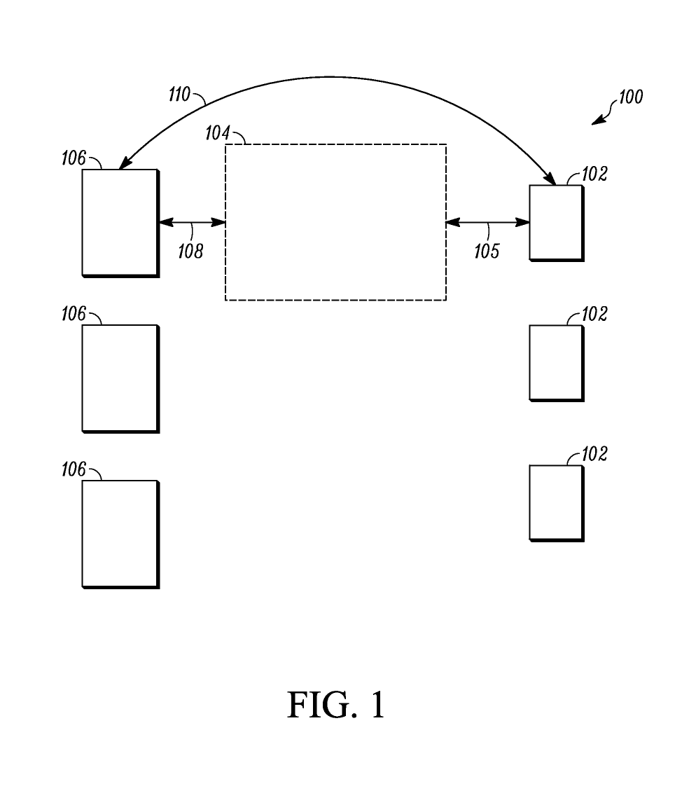

Referring to FIG. 1, a block diagram of an example communications system 100 is shown in a simplified schematic form. As shown, the communications system 100 includes in this embodiment three mobile devices 102, one of which is shown to be in communication via a communication link 105 with a server, which in the present embodiment is a web server 104. The mobile devices 102 are respectively representative of communication devices operated by persons (or users) or possibly by other entities (e.g., netbooks or other computers) desiring or requiring communication capabilities. In some embodiments, for example, the mobile devices 102 can be any of cellular telephones, other wireless devices such as personal digital assistants, and/or devices such as laptops and desktop computers that are capable of connecting to and communicating with a network (communication link 105).

The communications system 100 additionally is shown to include three content provider websites (CPWs) 106, one of which is shown to be in communication with the intermediary web server 104 via a communication link 108. Further, a communication link 110 is also provided that allows for that one of the mobile devices 102 that is in communication with the web server 104 to directly communicate with that one of the CPWs 106 that is also in communication with the web server, without the intermediation of the web server 104. Although only one of the mobile devices 102 and one of the CPWs 106 are shown in to be in communication with the web server 104, it will be understood that depending upon the time or operational circumstance, any or all of the mobile devices 102 and CPWs 106 can be in communication with the web server. Likewise, depending upon the time or operational circumstance, any of the mobile devices 102 can enter into communication with any of the CPWs 106 by way of direct communication links such as the link 110.

Although three mobile devices 102 are shown in FIG. 1, in other embodiments only one mobile device is in communication with the web server 104, or alternatively any arbitrary number of mobile devices can be in communication with the web server 104. Likewise, although three CPWs 106 are shown in FIG. 1, in other embodiments only one CPW is in communication with the web server 104, or alternatively any arbitrary number of CPWs can be in communication with the web server 104. Additionally, any arbitrary number of mobile device(s) can be in communication with any arbitrary number of CPW(s) by way of direct communication links such as the link 110 in other embodiments. That is, FIG. 1 is intended to be representative of any of a variety of systems employing any arbitrary number of mobile devices and any arbitrary number of CPWs that are in communication with one another either indirectly via a web server interface or directly with one another.

Depending upon the embodiment, the communication links 105, 108 and 110 can be part of a single network or multiple networks, and each link can include one or more wired and/or wireless communication pathways, for example, landline (e.g., fiber optic, copper) wiring, microwave communication, radio channel, wireless path, intranet, internet, and/or World Wide Web communication pathways (which themselves can employ numerous intermediary hardware and/or software devices including, for example, numerous routers, etc.). In addition, a variety of communication protocols and methodologies can be used to conduct the communications via the communication links 105, 108 and 110 between the mobile devices 102, web server 104, and CPWs 106, including for example, transmission control protocol/internet protocol (TCP/IP), extensible messaging and presence protocol (XMPP), file transfer protocol (FTP), etc. In other embodiments, other types of communication links for facilitating the transfer of signals between the plurality of mobile devices 102 and the CPWs 106 can be utilized as well. Although in the present embodiment the communication links/network and server are each discussed as being web-based, in other embodiments, the links/network and server can assume various non-web-based forms.

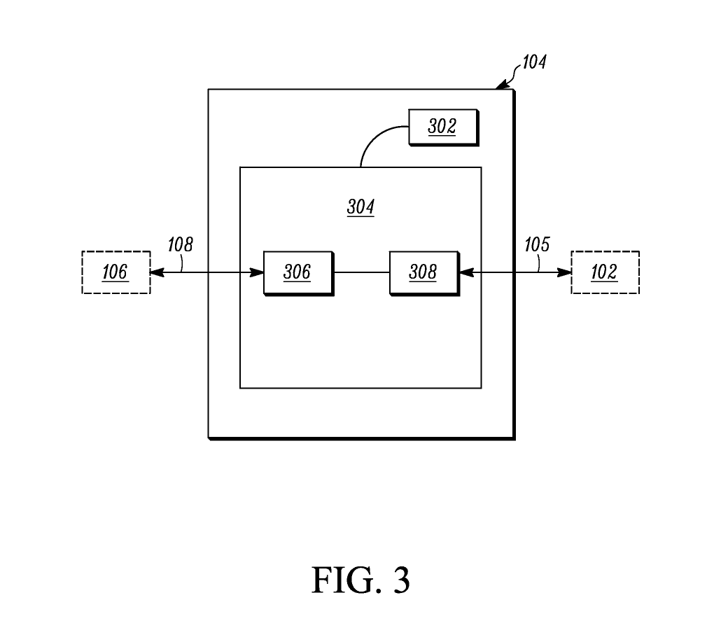

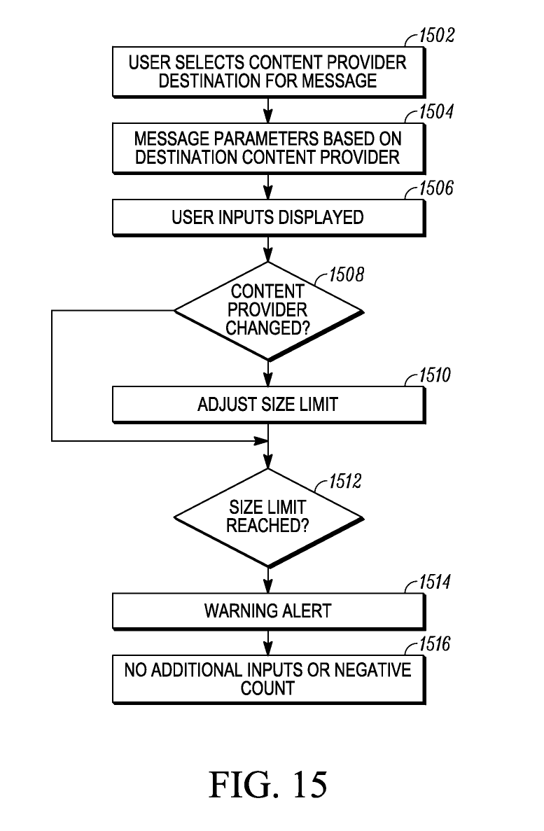

As will be discussed below in more detail with regard to FIGS. 3-16, the web server 104 is configured to serve as an intermediary between the mobile devices 102 and the CPWs 106. Various types of communications between the mobile devices 102 and CPWs 106 are passed through, processed and/or monitored by the web server 104 including, for example, communications involving the uploading and downloading of files (e.g. photos, music, videos, text entries, etc.), blog postings, and messaging (e.g., Short Message Service (SMS), Multimedia Messaging Service (MMS), and Instant Messaging (IM)). The CPWs are generally intended to encompass a variety of interactive websites that allow for the downloading and uploading (e.g., posting) of various forms of data, such as personal and/or business information, pictures, videos, and songs and thereby facilitate the creation and maintaining of interpersonal connections among persons and groups of persons. Examples of CPWs include, for example, Facebook™ MySpace™, hi5™, LinkedIn™, and Twitter™. For purposes of the present invention, CPWs can also be understood to encompass various other types of websites (e.g., business-to-business or business-to-consumer websites) that, while not focused entirely or predominantly upon social networking, nevertheless also include social networking-type features. Other content provider websites include sources of RSS or other news feeds, photograph services such as Picasa™ or Photobucket™, and music services such as LastFM™.

Really Simple Syndication (RSS) refers to web feed formats used to publish frequently updated works such as blog entries, news headlines, audio, and video. An RSS document (which is called a “feed” or “channel”) includes full or summarized text, plus metadata such as publishing dates and authorship, and may include a photograph.

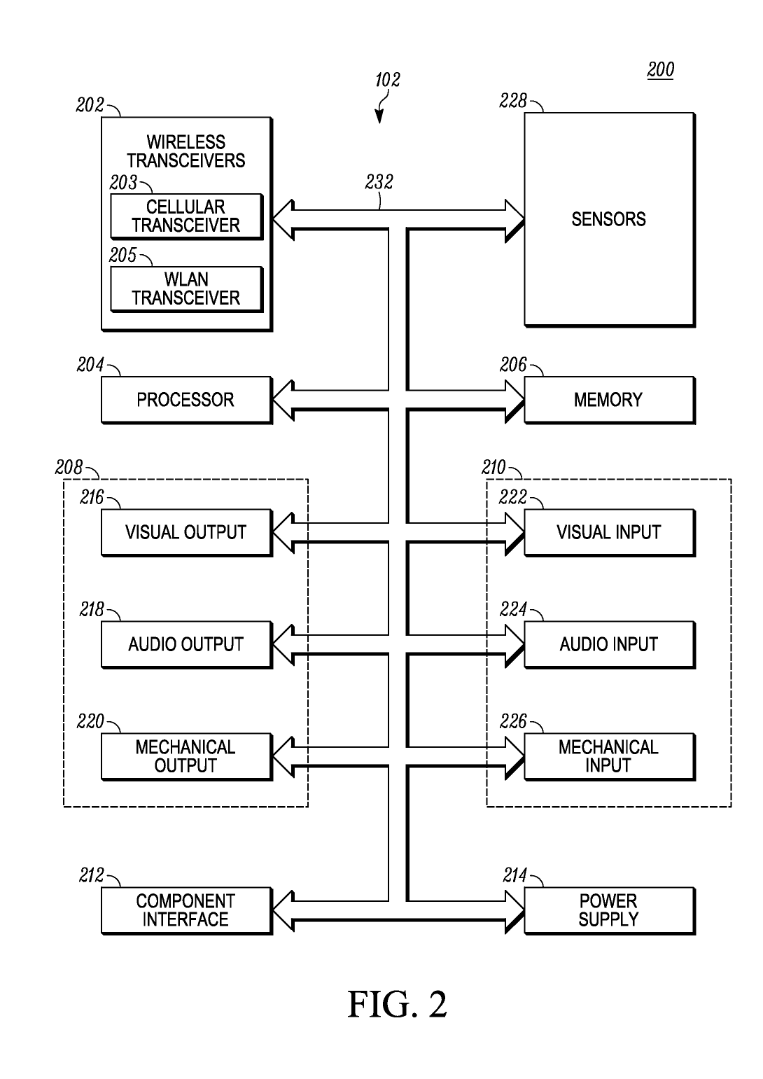

Referring to FIG. 2, there is provided a block diagram illustrating example internal components 200 of a mobile device such as the mobile device 102 in accordance with one embodiment. As shown in FIG. 2, the components 200 include one or more wireless transceivers 202, 203, 205, a processor 204 (e.g., a microprocessor, microcomputer, application-specific integrated circuit, etc.), a memory portion 206, one or more output devices 208, and one or more input devices 210. In at least some embodiments, a user interface is present that comprises one or more output devices 208, such as a display, and one or more input device 210, such as a keypad or touch sensor. The internal components 200 can further include a component interface 212 to provide a direct connection to auxiliary components or accessories for additional or enhanced functionality. The internal components 200 preferably also include a power supply 214, such as a battery, for providing power to the other internal components while enabling the mobile device to be portable. All of the internal components 200 can be coupled to one another, and in communication with one another, by way of one or more internal communication links 232 (e.g., an internal bus).

Each of the wireless transceivers 202 utilizes a wireless technology for communication, which can include for example (but are not limited to) cellular-based communication technologies such as analog communications (using AMPS), digital communications (using CDMA, TDMA, GSM, iDEN, GPRS, EDGE, etc.), and next generation communications (using UMTS, WCDMA, LTE, IEEE 802.16, etc.) or variants thereof, or peer-to-peer or ad hoc communication technologies such as HomeRF (radio frequency), Bluetooth and IEEE 802.11 (a, b, g or n), or other wireless communication technologies such as infrared technology. In the present embodiment, the wireless transceivers 202 include a cellular transceiver 203 and a wireless local area network (WLAN) transceiver 205, although in other embodiments only one of these types of wireless transceivers (and possibly neither of these types of wireless transceivers, and/or other types of wireless transceivers) is present. By virtue of the use of the wireless transceivers 202, the mobile device 102 is capable of communicating both with the CPW 106 by way of the communication link 110 and also with the web server 104 (and thus indirectly again with the CPW 106) by way of the communication link 105.

Example operation of the wireless transceivers 202 in conjunction with others of the internal components 200 of the mobile device 102 can take a variety of forms and can include, for example, operation in which, upon reception of wireless signals, the internal components detect communication signals and the transceiver 202 demodulates the communication signals to recover incoming information, such as voice and/or data, transmitted by the wireless signals. After receiving the incoming information from the transceiver 202, the processor 204 formats the incoming information for the one or more output devices 208. Likewise, for transmission of wireless signals, the processor 204 formats outgoing information, which may or may not be activated by the input devices 210, and conveys the outgoing information to one or more of the wireless transceivers 202 for modulation to communication signals. The wireless transceiver(s) 202 convey the modulated signals by way of wireless and (possibly wired as well) communication links to other devices such as the web server 104 and one or more of the CPWs 106 (as well as possibly to other devices such as a cell tower, access point, or another server or any of a variety of remote device).

Depending upon the embodiment, the input and output devices 208, 210 of the internal components 200 can include a variety of visual, audio and/or mechanical outputs. For example, the output device(s) 208 can include one or more visual output devices 216 such as a liquid crystal display and light emitting diode indicator, one or more audio output devices 218 such as a speaker, alarm and/or buzzer, and/or one or more mechanical output devices 220 such as a vibrating mechanism or other haptic feedback systems. The visual output devices 216 among other things can include a video screen. Likewise, by example, the input device(s) 210 can include one or more visual input devices 222 such as an optical sensor (for example, a camera), one or more audio input devices 224 such as a microphone, and one or more mechanical input devices 226 such as a flip sensor, keyboard, keypad, selection button, navigation cluster, touch pad, touchscreen, capacitive sensor, motion sensor, and switch. Actions that can actuate one or more of the input devices 210 can include not only the physical pressing/actuation of buttons or other actuators, but can also include, for example, opening the mobile device, unlocking the device, moving the device to actuate a motion, moving the device to actuate a location positioning system, and operating the device.

As shown in FIG. 2, the internal components 200 of the mobile device 102 also can include one or more of various types of sensors 228. The sensors 228 can include, for example, proximity sensors (a light detecting sensor, an ultrasound transceiver or an infrared transceiver), touch sensors, altitude sensors, a location circuit that can include, for example, a Global Positioning System (GPS) receiver, a triangulation receiver, an accelerometer, a tilt sensor, a gyroscope, or any other information collecting device that can identify a current location or user-device interface (carry mode) of the mobile device 102.

The memory portion 206 of the internal components 200 can encompass one or more memory devices of any of a variety of forms (e.g., read-only memory, random access memory, static random access memory, dynamic random access memory, etc.), and can be used by the processor 204 to store and retrieve data. The data that is stored by the memory portion 206 can include, but need not be limited to, operating systems, applications, and informational data. Each operating system includes executable code that controls basic functions of the communication device, such as interaction among the various components included among the internal components 200, communication with external devices via the wireless transceivers 202 and/or the component interface 212, and storage and retrieval of applications and data, to and from the memory portion 206. Each application includes executable code that utilizes an operating system to provide more specific functionality for the communication devices, such as file system service and handling of protected and unprotected data stored in the memory portion 206. Informational data is non-executable code or information that can be referenced and/or manipulated by an operating system or application for performing functions of the communication device.

Referring next to FIG. 3, additional example components of the web server 104 of FIG. 1 are shown in more detail. As shown, the web server 104 includes a memory portion 302, a processor portion 304 in communication with that memory portion, and one or more input/output (I/O) interfaces (not shown) for interfacing the communication links 105, 108 with the processor 304. The processor portion 304 further includes a back end portion 306 (or Social Network Processor) and a front end portion 308. The back end portion 306 communicates with the CPWs 106 (shown in dashed lines) via the communication link 108 and the front end portion 308 communicates with the mobile device 102 (also shown in dashed lines) via the communication link 105.

As discussed in further detail below, in at least some embodiments the back end portion 306 supports pull communications with CPWs such as the CPW 106. The pull communications can for example be implemented using Representation State Transfer (REST) architecture, of the type typical to the web, and as such the back end portion 306 is configured to generate requests for information to be provided to the back end portion 306 from the CPWs such as the CPW 106 at times/circumstances determined by the web server 104, in response to which the CPWs 106 search for and provide back to the web server 104 the requested data. Also as discussed in further detail below, in at least some embodiments the front end portion 308 establishes a push channel in conjunction with mobile devices such as the mobile device 102.

In at least some such embodiments, the push channel allows the front end portion 308 to provide notifications from the web server 104 (generated by the front end portion) to the mobile device 102 at times/circumstances determined by the web server 104. The notifications can be indicative of information content that is available to be provided to the mobile device. The mobile device 102 in turn is able to respond to the notifications, in manner(s) deemed appropriate by the mobile device 102. Such responses often (but not necessarily always) constitute requests that some or all of the available information content be provided from the front end portion of the intermediary web server 104 to the mobile device.

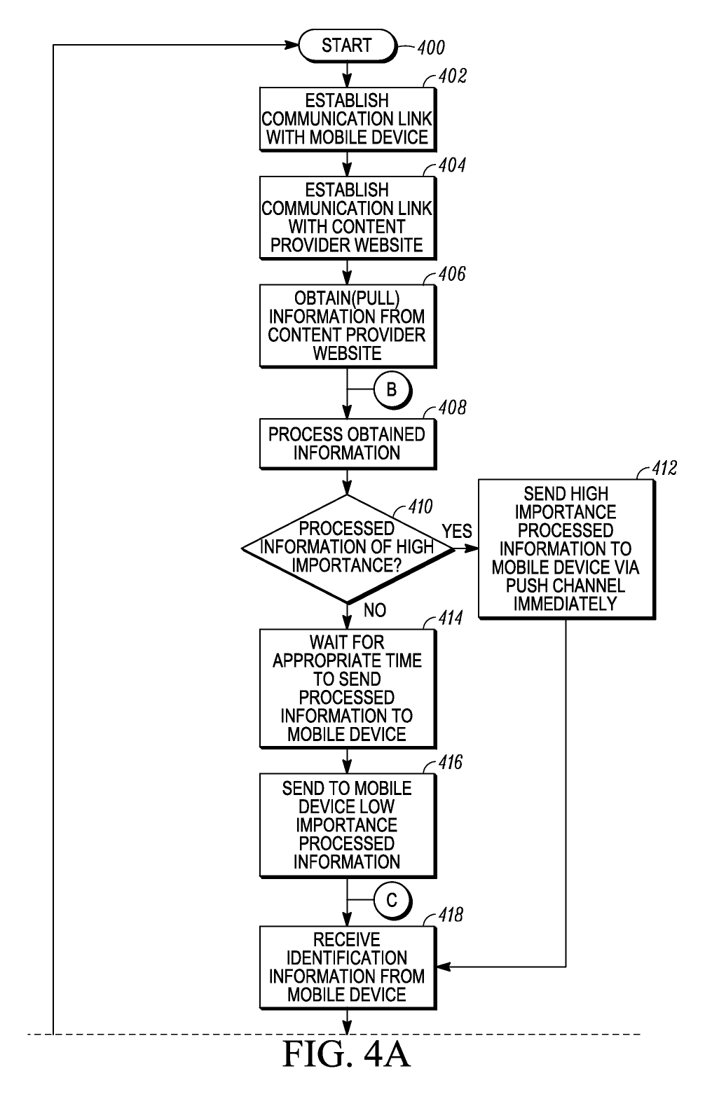

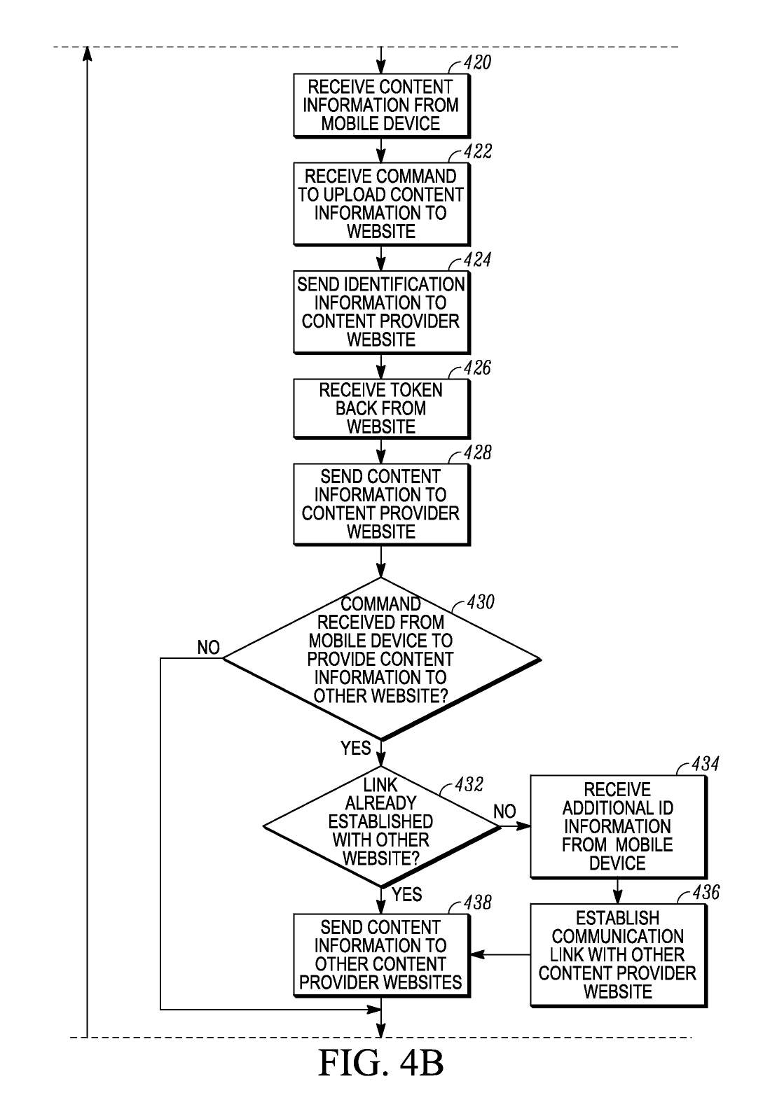

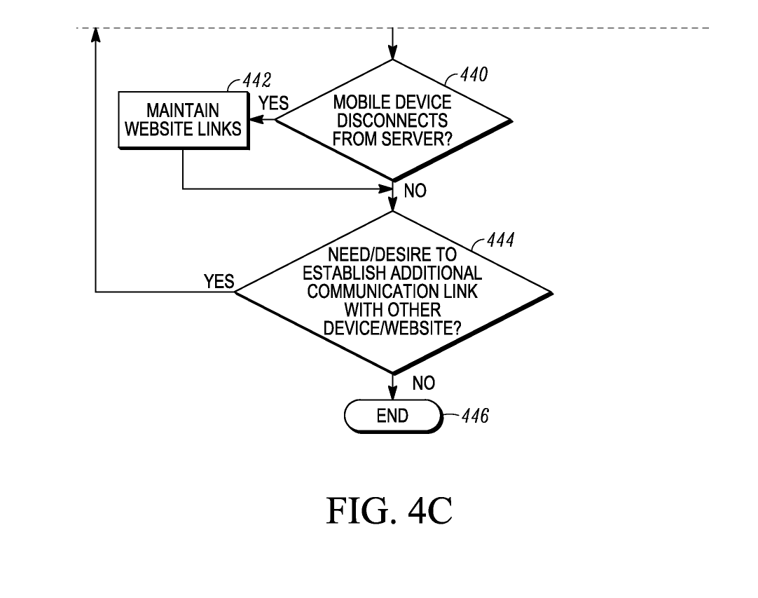

Referring to FIG. 4, a flowchart is provided showing example steps of operation of the web server 104 of FIGS. 1 and 3, particularly when interacting with and intermediating communications between mobile devices and CPWs such as the mobile devices 102 and CPWs 106 shown in FIG. 1. Upon beginning the process represented by the flowchart of FIG. 4 at a start step 400, the web server 104 begins operation at a step 402 by establishing a communication link with a mobile device, such as the communication link 105 with the mobile device 102 of FIG. 1. As will be described in further detail below, the establishment of the communication link with the mobile device can, depending upon the embodiment, actually involve the establishment of multiple communication links (that can exist in parallel or at different times) with that mobile device.

In some such cases, the multiple communication links are of different types, for example, involving a push channel or communication protocols other than push channels. Also, while the establishment of a communication link with a mobile device 102 typically involves establishing a circuit switch connection with a base station, and thus the communication device providing identification information to the base station by which the mobile device identifies itself to the telecommunication network, the connection to the web server 104 can also be via an internet protocol (IP) connection or a point-to-point (P2P) telecommunications connection between the base station with which the mobile device is communicating and a load balancer/firewall, and also can involve the providing of a response signal from the web server back from to the mobile device by which the mobile device recognizes that it is in contact with the web server.

Upon completion of the step 402, at a step 404 the web server 104 further establishes a communication link with a CPW, such as the communication link 108 with the CPW 106 shown in FIG. 1. Establishment of the communication link at the step 404 can involve, for example, the providing of one or more web services calls and/or other techniques. Subsequent to the step 404, the web server 104 maintains ongoing communications, which can be (but need not be) periodic communications, with the CPW 106 and at one or more times obtains (pulls) information from the CPW. The information obtained from the CPW can include any of a variety of different types of information, including for example, information concerning contacts or friends (including a contacts list), new friends or updated contacts, special messages, news, happenings, and other types of information including possibly files (such as image files or text files) or other forms of data. Upon obtaining the information at the step 406, the web server then processes the obtained information at a step 408.

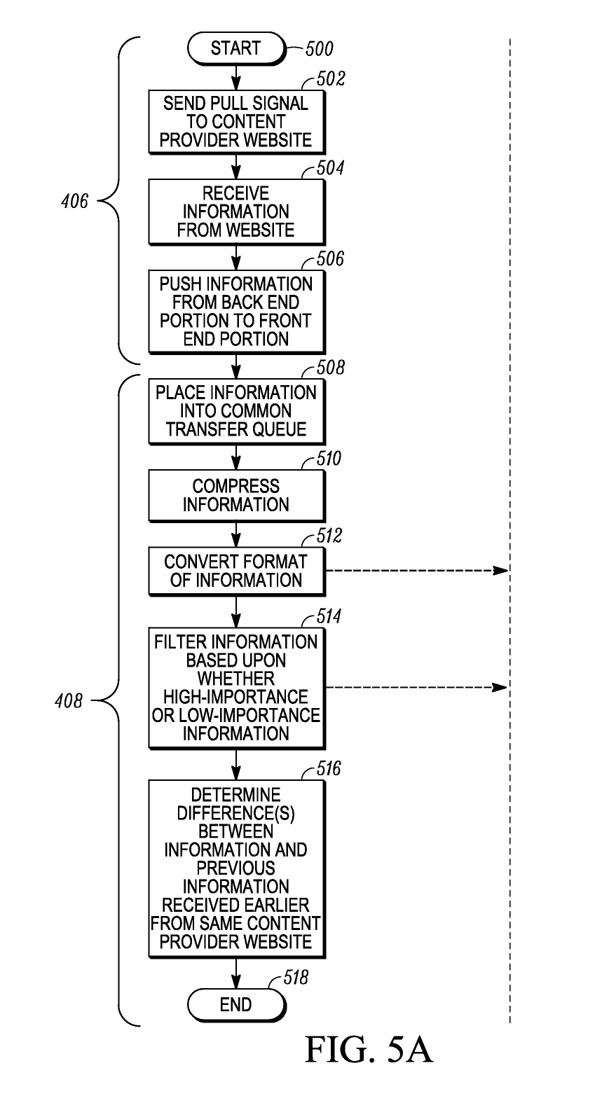

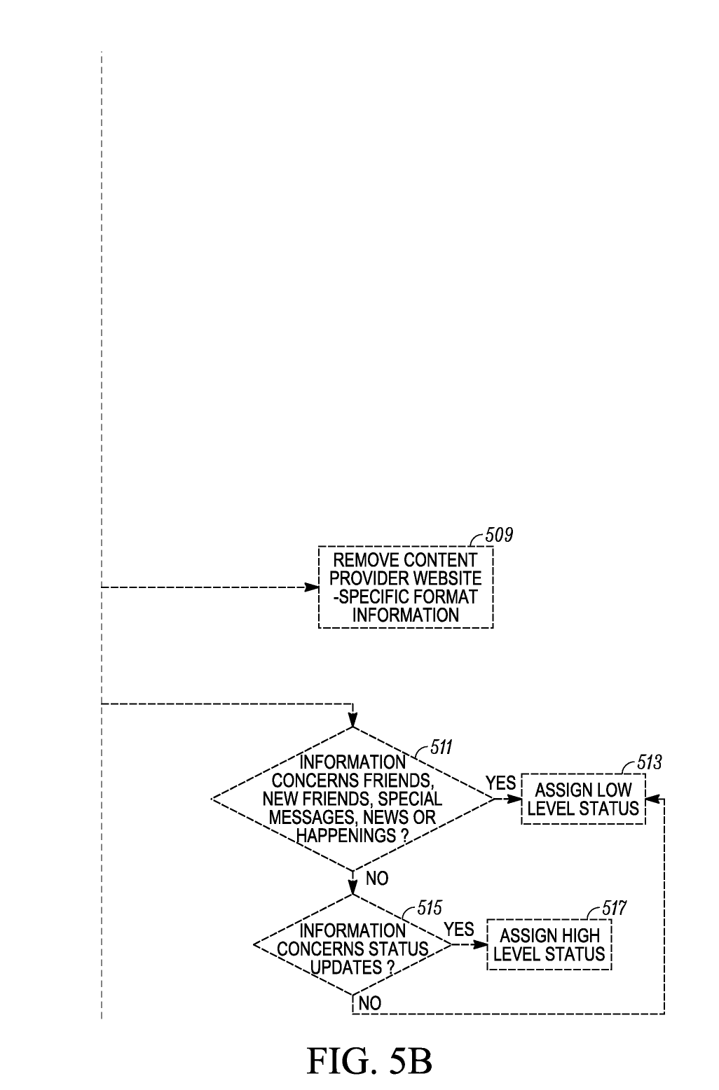

Referring additionally to FIG. 5, example substeps corresponding to the steps 406 and 408 of FIG. 4 are shown in accordance with one embodiment. As shown, the step 406 (the obtaining step) can be understood as encompassing several substeps beginning with a start substep 500 and further including three additional substeps 502, 504 and 506. More particularly, in the substep 502, the web server 104 sends a pull signal to the CPW 106, and at the substep 504, information is received back from the CPW at the back end portion 306 of the web server. After the information is received at the back end portion 306, at the step 506 this information is then pushed from the back end portion to the front end portion 308 of the web server 104.

Further as shown in FIG. 5, the step 408 (the processing step) can include in one embodiment several substeps beginning at a substep 508 prior to ending at a substep 518 (FIG. 5 shows the substeps corresponding to the step 408 as being a continuation of the substeps corresponding to the step 406). More particularly, at the substep 508, upon the front end portion 308 of the web server 104 receiving the information pushed from the back end 306 portion at the substep 506, that information is then placed into a common transfer queue. Next, at a substep 510 the information can optionally be compressed. Further, at a substep 512, the information can optionally be converted into a different format, for example, a binary format. As additionally represented by a block 509 (shown in dashed lines), the format conversion occurring at the substep 512 can include a removal of specific formatting information that was provided by the CPW 106, so as to standardize the formatting of the information and remove site-specific format information, though not the source identity, or otherwise to modify the formatting of the information to be of a uniform, or universal, format provided to the mobile device regardless of the CPW formatting that was the source of the information.

Next, at a substep 514, the information is filtered based upon whether it is high importance or low importance information. As further represented by substeps 511, 513, 515 and 517 (shown in dashed lines), this filtering operation can involve further determinations. Namely, as shown at a substep 511, the web server 104 can determine whether the information concerns friends, new friends, special messages, news or happenings. If so, then at a substep 513 that information is assigned a low level status. However, if the information does not fall into one of those groupings, then the filtering process proceeds to the substep 515, at which the web server determines whether the information concerns status updates. If it does, then a high level status is assigned to the information at the substep 517. In the present example embodiment, if the information is determined not to concern status updates at the substep 515, then the process again returns to the substep 513. It will be recognized that the web server 104 can determine whether the information is a status update for the user, and if it is, treat the information as high level, or high priority, and if it is not, treat the information as low level, or low priority. Other types of information may be also be treated as high priority, though it is desirable to restrict the number of messages that result in increased activity for the communication device.

Upon completion of the filtering substep 514, the process then advances to a substep 516, in which the web server 104 (specifically the front end portion 308 of the web server) determines one or more differences that may exist between the information that was obtained at the step 406 from the CPW 106 and previous information that was received earlier from the same CPW. In the present embodiment, it is only such difference information that is ultimately transmitted back to the mobile device 102. As already noted, the substeps represented by FIG. 5, and corresponding to the step 408 of FIG. 4, end at the substep 518. It will be recognized the step 516 can advantageously occur in the back-end portion 306 between steps 504 and 506, in which case the information will only be further processed in the web server 104 if there is a change in CPW information from the previous time content was pulled for the particular subscriber. This will free up server resources to continue to pull information from the CPW for the user of device 102 or other users who use the intermediary web server and the CPW.

Returning to FIG. 4, upon the completion of the step 408, the web server 104 considers whether one or more portions of the processed information are of high importance or not of high importance (e.g., of low importance, or possibly of medium importance or some other importance level). If it is determined that the processed information is of high importance, then at a step 412 the front end portion 308 of the web server 104 sends the high importance processed information to the mobile device 102 via the push channel established across the communication link 105. This occurs immediately, at the time determined by the web server, as made possible by way of using the push channel. If at the step 410 it is determined that the processed information is not of high importance, then the sending of the processed information can be delayed until another more appropriate time to thereby reduce the communication activity between the device and server, and thus reduce the battery drain on the device. Thus, at a step 414, the web server 104 waits for an appropriate time to send the processed information to the mobile device 102. Then, once an appropriate time has occurred, at a step 416 the information is then sent to the mobile device 102 by the web server 104.

The appropriate time at which low importance processed information is sent by the web server 104 to the mobile device 102 can be based upon various considerations. For example, in some embodiments, such appropriate times are merely periodically-occurring times at which the mobile device 102 polls the web server 104 for information. Such polling typically involves the repeated sending of inquiry signals from the mobile device 102 to the web server 104. In other cases, an appropriate time occurs when the particular circumstances have arisen. For example, an appropriate time for sending low importance processed information can occur when the mobile device 102 makes a request if additionally it is the case that by that same time the web server 104 has determined that a certain quantity of low importance processed information has been stored for transmission to the mobile device. Although in the above description the obtaining of information by the web server 104 is described as involving pulling while the obtaining by the mobile device of low importance information from the web server is described as involving polling, it should be understood that either pulling or polling operations (and either periodic or asynchronous communications) can be used by either of the web server and the mobile device, respectively, to obtain information from the CPW 106 and the web server 104, respectively, depending upon the embodiment. Additionally, it is envisioned that the server can be pulling information from the content provider website 106 when the mobile device 102 is not connected to the system 100, as a consequence of which the server will hold information until the mobile device reconnects, or when enough time elapses that the server deletes the information.

Regardless of whether high importance or low importance information is sent to the mobile device 102 at steps 412 and 416, respectively, upon completion of these steps, a series of additional steps are performed by the web server 104 in interacting with the mobile device, the CPW, or additional mobile devices/CPWs. More particularly in this regard, upon the completion of steps 412 and 416, at steps 418-428, information from the mobile device 102 can be uploaded to the web server 104 and further provided to the CPW 106. As shown in FIG. 4, at the step 418, such interaction can begin by the web server 104 receiving identification information from the mobile device 102. Receipt of such identification information need not always occur, for example, if such identification information was already received at the step 402. Then, at a step 420, the web server 104 additionally receives content information from the mobile device 102. Content information can include, for example, files such as image files or text files or other data that the user of the mobile device wishes to have uploaded to a user profile (e.g., a “wall”) existing at the CPW.

Next, at a step 422, the web server 104 receives a command from the mobile device 102 instructing the web server to upload the content information to the CPW 106. In alternate embodiments, this command need not be expressly provided by the mobile device 102 to the web server 104 since, in such embodiments, it is presumed by the web server that all content information provided by the mobile device should be further uploaded to any CPW with respect to which that mobile device is associated. Further then at a step 424, the web server 104 sends the identification information received from the mobile device 102 to the CPW 106 so as to authenticate the relationship between the web server and the CPW. In response to sending this identification information, typically a token is received back from the CPW if the authentication is satisfactory, as indicated by a step 426. As with respect to the step 418, the steps 424 and 426 need not be expressly performed at this time in all embodiments, particularly where such actions were taken as part of the establishment of the communication links in the step 402, 404. Regardless of when the authentication occurs, the authentication process allows the web server 104 to interact with the CPW 106 on behalf of, and as a proxy of, the mobile device 102. Assuming that proper authentication has occurred, then at the step 428 the content information is sent by the web server 104 to the CPW 106.

It is envisioned that the user ID and password required for the web server 104 to upload and download content to and from the content provider website 106 for a particular user account on the content provider website can be loaded into the web server 104 by the user when the mobile device 102 first connects to the server and sets up the content provider website on the web server. The web server 104 will store the user ID and password in the memory 302, and access the CPW using the user ID and password as long as the user does not change them, to maintain a persistent connection with the CPW regardless of whether the mobile device 102 is connected. It is further envisioned, that the pulling of information from the content providers 106 can be reduced, either in frequency or completely paused, if the mobile device does not request information from the web server 104 for a predetermined time period, or if the user device queue for downloading content to the device exceeds an age threshold and/or a storage capacity threshold.

In addition to the previously-described uploading process, in some circumstances a user operating the mobile device 102 will desire that the contents be uploaded to more than one of the CPWs 106. Such a process can be facilitated by the web server 104, as indicated by steps 430-438 of FIG. 4, particularly where the content information has already been provided to the web server by the mobile device 102. More particularly as shown, at the step 430 it is determined by the web server 104 whether a further command has been received by the web server from the mobile device 102 instructing the web server to provide the content information to another CPW. If such a command has been received, then at a next step 432 the web server 104 determines whether a communication link has already been established with the other CPW. If such a communication link has not already been established, then the process advances to a step 434, in which additional identification information is received from the mobile device 102 and subsequently at a step 436 that communication link is established between the web server 104 and the other CPW 106. That is, if a communication link has not already been established with the other CPW as determined at the step 432, then in order to establish such a communication link the web server 104 again must be provided with identification information from the mobile device 102 allowing that web server to be authenticated in relation to that other CPW so as to operate as a proxy for the mobile device in relation to that other CPW (e.g., substantially the same operations as described above in relation to the steps 424-426).

Upon the establishment of the communication link at the step 436, or if it is determined at the step 432 that a communication link was already established with the other CPW, then the process advances to the step 438, at which the content information is uploaded to the other CPW. Thus, by virtue of the steps 430-438 the content information already provided to a first CPW at the step 428 is additionally provided to another CPW. It will be understood that, although FIG. 4 does not show immediate looping in the repeat performing of the steps 418-438, the steps can be repeated numerous times in relation to numerous portions of information and more than one additional CPW. It is envisioned that the content will be provided from the mobile device 102 in a uniform format, and that the server back-end will format the data separately and appropriately for each of the target CPWs to which the content is being uploaded.

Further with respect to FIG. 4, upon the completion of the step 438, or in the event it is determined by the web server 104 at the step 430 that no command was received, then the web server additionally proceeds to determine whether the mobile device 102 has disconnected from the web server, at a step 440. Even though the mobile device 102 has disconnected from the web server 104, as a general rule the web server will still maintain its communication links with the CPWs 106 to which it has previously entered into communications and in relation to which the web server is capable of acting as a proxy on behalf of the mobile device that has been disconnected, as represented by a step 442. Thus, the web server 104 can continue to operate in relation to the CPWs 106 on an ongoing basis even though the mobile device 102 on whose behalf the web server is acting is temporarily out of communications. Consequently, the web server 104 can continue to operate to pull information from the various CPWs 106 and can access and monitor such information over time, such that when a previously-disconnected mobile device is reconnected to the web server, the web server is able to immediately (if appropriate) provide the most recent, updated CPW information available.

Notwithstanding the above description, and although not shown in FIG. 4, in certain embodiments it is also possible for the mobile device 102 to communicate an instruction to the web server 104 that the web server cease acting on its behalf in relation to one or more of the CPWs 106, in which case the web server will do so. Finally, as also shown in FIG. 4, both when the step 442 has been completed or in the event that at the step 440 it is determined that the mobile device 102 is still connected, the web server 104 proceeds to determine if there is a need or desire to establish additional communication links with other ones of the mobile devices 102 and/or CPWs 106. In accordance with the present flow chart, if there is no such need or desire, the process ends at a step 446 while, if there is such a need or desire, then the process returns to the start step 400.

It should be understood that, notwithstanding the particular steps as shown in FIG. 4, a variety of additional or different steps can be performed by the web server 104 depending upon the embodiment, and one or more of the particular steps shown in FIG. 4 can be rearranged, repeated or eliminated entirely depending upon the embodiment. Also, some of the steps performed according to the flow chart of FIG. 4 can be repeated on an ongoing or continuous basis simultaneously while others of the steps are performed. For example, the steps 406-412 relating to the obtaining and processing of information received from the CPWs 106 and the immediate (or substantially immediate) sending of high importance information to the mobile device 102 can be repeated on an ongoing or continuous basis even while other interactions such as those represented by the steps 418-438 relating to the uploading of content information from the mobile device to the web server and then to one or more of the CPWs is also being conducted. Further, while FIG. 4 describes in some detail the possibility of the web server 104 being in communication with multiple CPWs 106 in succession or simultaneously, and illustrates example interactions facilitated by the web server between a given mobile device and such one or more CPWs, it should be understood that the same process can be performed at the same or substantially the same time by the web server in terms of allowing similar interactions to occur between any number of other mobile devices and such one or more CPWs.

It is envisioned that the back-end portion 116 can include a separate plug-in for each CPW 106, including respective APIs appropriate for its respective CPW. Each of the plug-ins includes APIs for its respective CPW by which the plug-in pulls information from the web site and reformats the information into the universal format of the mobile device 102 client. Additionally, content from the mobile device will be reformatted from the uniform format of the mobile device 102 client program to the appropriate format specified by the CPW associated with that plug-in when uploaded by the back-end portion. In this way, content from the user device can be sent in a single message having a uniform format and it will be routed as selected by the user and formatted by each of the back-end portion plug-ins for each of the respective CPWs 106 to which it is targeted.

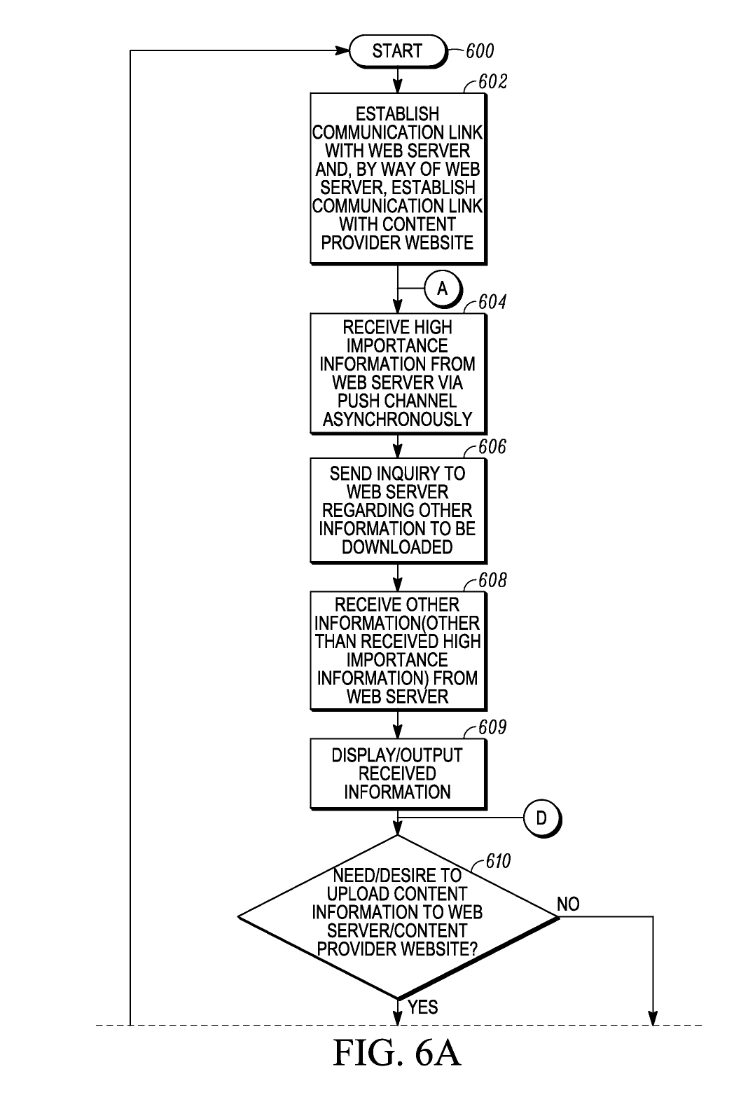

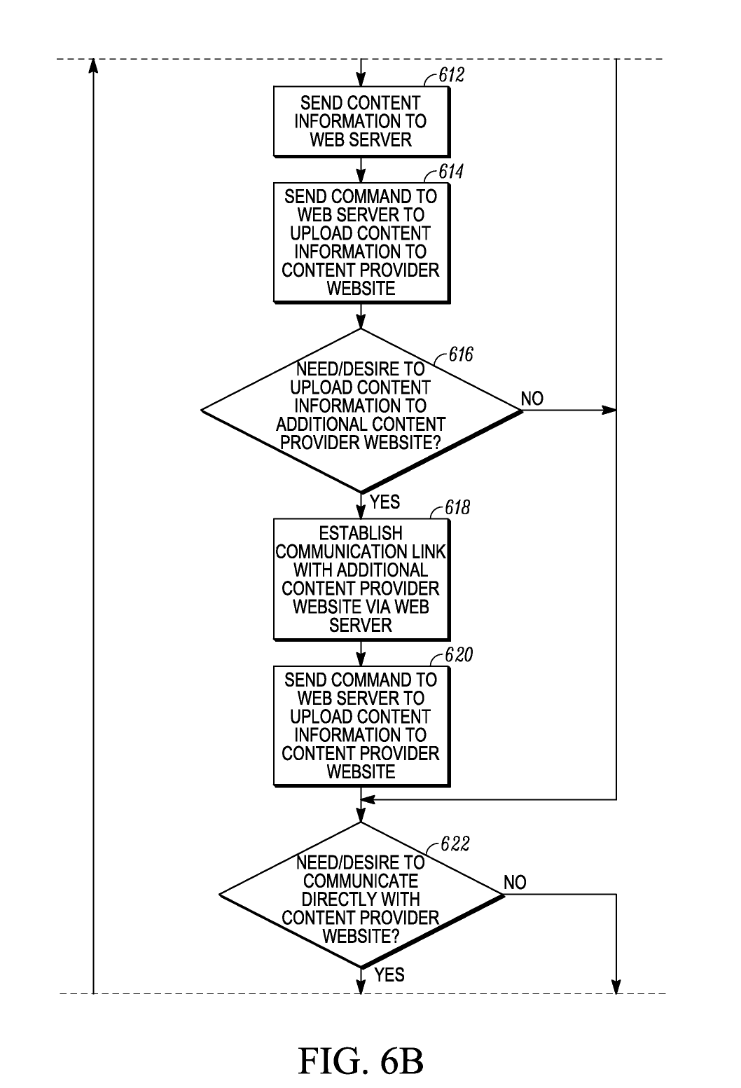

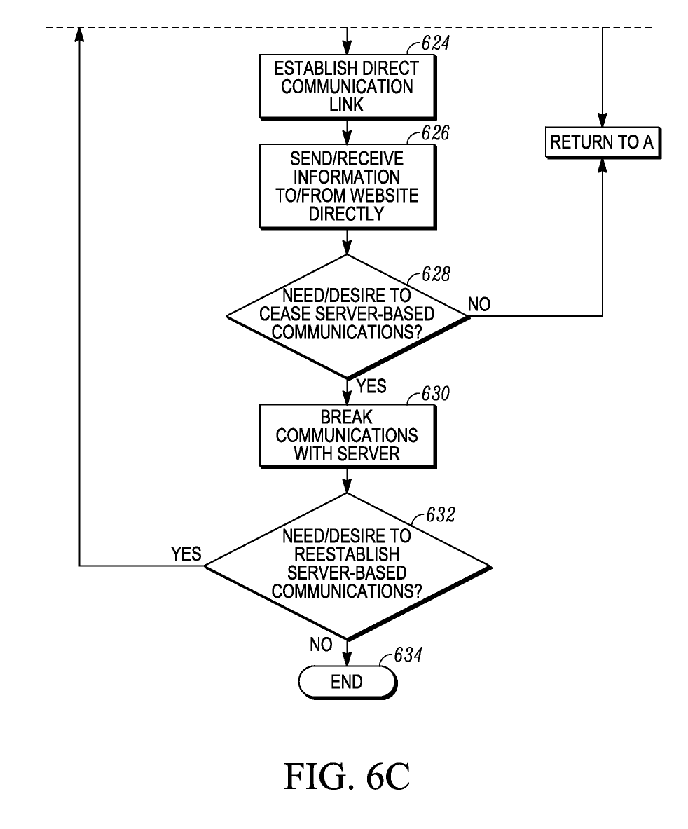

Turning to FIG. 6, an additional flow chart is provided showing example steps of operation of the mobile device 102 as it interacts with the web server 104 and, by virtue of this interaction, is able to interact with one or more CPWs 106. That is, FIG. 6 is intended to illustrate example steps of operation of the mobile device 102 that are complementary with (or largely complementary with) respect to a number of the steps performed by the web server 104 as illustrated in FIGS. 4 and 5 above. Additionally, as will be described further below, FIG. 6 also includes steps by which the mobile device 102 is capable of interacting directly with one or more of the CPWs 106 without intermediation by the web server 104, or simultaneously along with (but independent of) intermediation by the web server. As shown in FIG. 6, upon commencing operation at a start step 600, the mobile device 102 begins its interaction with the web server 104 by establishing a communication link with the web server and, by way of the web server thus establishing a communication link with the CPW, at a step 602.

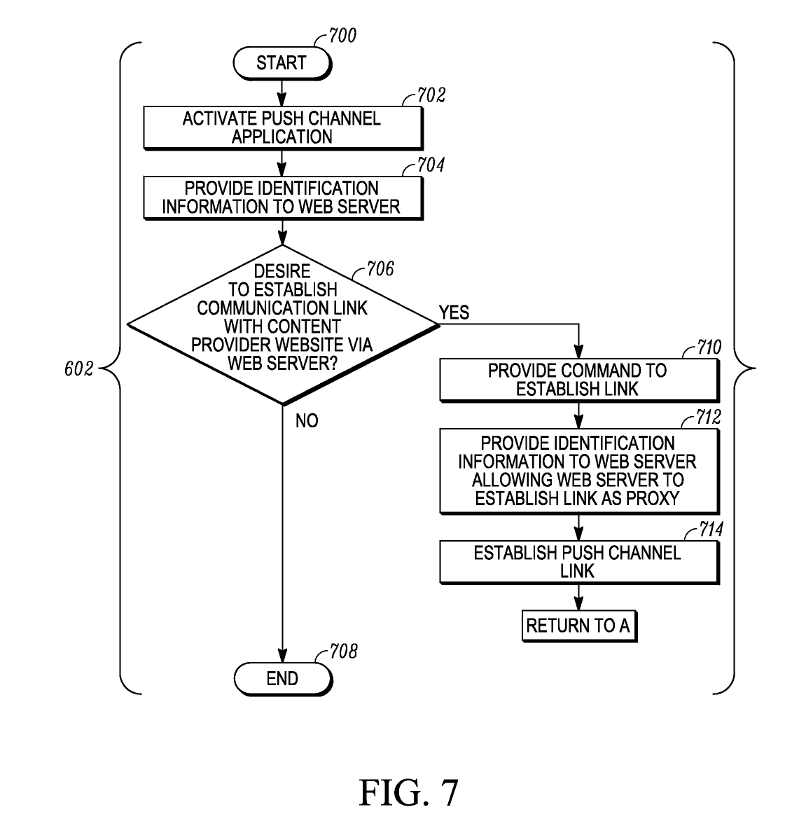

Referring additionally to FIG. 7, the step 602 can be understood as encompassing several substeps as illustrated in FIG. 7. As shown, upon starting at a substep 700, the mobile device 102 activates a push channel application supported on the mobile device, as indicated at a substep 702. Then, at a substep 704 the mobile device 102 provides identification information to the web server 104. Such identification information can include, for example, identification codes specifying the particular mobile device (e.g., a serial number, model number or product reference number), information relating to the identity of a user utilizing the mobile device, or other coding information such as login or password codes. Next at a substep 706, it is determined at the mobile device 102 whether there is a desire to establish a communication link with a particular one of the CPWs 106 via the web server. If there is no such desire at this time, then the process represented by FIG. 7 ends at a substep 708. Alternatively, if there is a desire to establish a communication link with the CPW 106 via the web server 104, as can be indicated by a user providing a command to the mobile device 102 indicating such a desire, then at a substep 710 the mobile device 102 additionally sends a command to the web server instructing the web server to establish such a communication link.

Further, at a substep 712, the mobile device 102 additionally sends to the web server 104 additional web identification information allowing the web server to establish the communication link with the CPW 106, and to act as a proxy for the mobile device in its communications with that CPW. The identification information sent at the substep 712 in some embodiments can be the same as that of the substep 704, in which case the substep 712 need not be performed. Once the identification information has been provided at the substep 712, a push channel link is established between the mobile device and the web server at a substep 714. Upon completion of the substep 714, the remaining steps of the process represented by FIG. 6 subsequent to the step 602 can be performed (as indicated by the block “Return to A”).

Returning to FIG. 6, upon establishment of the communication link with the web server 104 at the step 602, at a step 604 the mobile device 102 receives high importance information from the web server via the push channel (e.g., the push channel established at the substep 714). This information, as already described with reference to FIGS. 4-5, in the present embodiment is provided from the web server 104 to the mobile device 102 in an asynchronous manner, that is, at times not determined by the mobile device. In addition to receiving such high importance information on an asynchronous basis, as further represented by a subsequent step 606, the mobile device 102 can additionally send one or more inquiries to the web server 104 regarding other information to be downloaded by the web server to the mobile device. As discussed above with reference to FIG. 5, while high importance information can include information such as status update information, other information (e.g., low importance information) can include information such as contact/friend information, new friend information, contact lists, photos or videos, special messages, news or happenings information.

The inquiries provided by the mobile device 102 at the step 606 can be provided on a periodic basis or at other times as determined by the mobile device. Although in the present embodiment it is envisioned that the mobile device 102 will determine when inquiries to the web server 104 are made that in turn determine whether information other than high importance information is communicated from the web server to the mobile device, in other embodiments such inquiries and/or downloading of information can occur at times determined by mutual agreement between the web server and the mobile device, at times determined solely by the web server alone (e.g., when the web server has determined that a sufficient amount of low importance information has been collected), or at times determined by another entity or party such as a manufacturer who has programmed both devices. Regardless of whether it is inquiries from the mobile device 102 that prompt the sending of information by the web server 104 back to the mobile device or whether it is other triggers that prompt the sending of such information, as indicated at a step 608 eventually such other information is also received by the mobile device from the web server. While the step 602 can be considered complementary to the step 402 of FIG. 4, the steps 604-608 can be considered complementary to the web server operations represented by steps 406-412 (and particularly steps 414-412) of FIG. 4.

Referring still to FIG. 6, at a subsequent step 609 the information received by the mobile device 102 from the web server 104 is displayed or otherwise output by the mobile device. The extent to which such displaying/outputting of information occurs will depend upon the embodiment. In at least some embodiments, the information is displayed/output by the mobile device 102 in a standardized manner such that CPW-specific formatting information or features are not provided as part of the displayed/output information. More particularly in some such embodiments, CPW-specific formatting information and features are redacted by the web server 104 or, in some alternate embodiments, by the mobile device or the combination of both the web server and the mobile device.

In performing such redactions, similar types of information found at different CPWs, even if referred to in different manners by the different CPWs (e.g., as information found at a posting site or instead as information found on a wall), are recognized as being of similar type conceptually and, based upon such recognition, such information can be displayed (or output) in a common manner on the mobile device regardless of the origin of the information. That is, given the redaction of such CPW-specific formatting information or features, information of the same conceptual type from different CPWs, even if formatted differently at the different CPWs, is nevertheless displayed a same or similar, consistent manner on the mobile device regardless of the origin of that information, thus facilitating a user's review of such information. It should further be noted that such information can include not only text and image data but also a wide variety of other data, including data allowing for the display of interactive windows and data entry fields on the mobile device, into which the user as able to enter additional information or commands that can then be sent back to the web server.

Next, at a step 610 the mobile device 102 determines whether there is a need or desire to upload content information currently available at the mobile device to the web server and/or ultimately to the CPW 106. The need or desire can be determined automatically by the mobile device 102, for example, based upon whether a particular type of information has been received by the mobile device from a user or other source or whether a particular event has occurred or time has passed triggering such an uploading event. Often, such a need/desire will occur in response to a user command provided to the mobile device 102. If at the step 610 it is determined there is no such need/desire, then as shown the process advances to a step 622 discussed below. However, if it is determined at the step 610 that there is such a need/desire, then at a step 612 the mobile device 102 sends the content information to the web server 104 and at a step 614 the mobile device additionally sends a command to the web server to upload the content information to the CPW 106. The steps 610-614 can be understood as being generally complementary to the steps 418-428 of FIG. 4 except insofar as the identification information that is provided from the mobile device 102 for authentication purposes as discussed with reference to step 418 can be understood as having already been provided at the step 602 shown in FIG. 6 (alternatively, additional identification information suitable for this purpose can be provided just prior to the step 612).

Upon completion of the step 614, the mobile device 102 further determines whether there is a need/desire to upload the content information to one or more additional CPWs in addition to the first CPW to which that information was already uploaded, at a step 616. Again, that need or desire can be determined based upon a variety of factors including, among other things, one or more instructions provided by a user of the mobile device to the mobile device. If at the step 616 it is determined that there is no such need or desire, then the process advances again to the step 622 as discussed below. However, if it is determined at the step 616 that there is such a need or desire, then the process advances to a step 618, in which an additional communication link is established between the mobile device and such additional CPW via the web server. The step 618 can be considered complementary to the steps 432-436 of FIG. 4 and can, depending upon the embodiment include substeps where the mobile device first determines whether a communication link already exists with such additional CPW and, if it is determined that no such communication link already exists, then sends additional identification information to the web server to establish such a communication link with such additional CPW and to allow the web server to act as a proxy for the mobile device in such communications.

Upon the establishment of the additional communication link with the additional CPW 106 at the step 618, then the mobile device 102 further sends a command to the web server 104 to upload content information to that additional CPW 106 at a step 620. Performance of the step 620 can be understood as corresponding to the step 430 of FIG. 4, it being further understood that the order of performance of steps 618 and 620 is reversible so that those steps more closely correspond to the order of steps 430-436 of FIG. 4. Additionally with respect to FIG. 6, upon the completion of the step 620, it is presumed that the web server 104 in fact uploads the content information to the additional CPW. Although not shown, in some embodiments, upon completion of such uploading, the web server 104 sends an indication signal back to the mobile device 102 confirming that such uploading has occurred.

Although the above-described steps of FIG. 6 as well as the steps of FIG. 4 envision the use of the web server 104 as an intermediary between the mobile device 102 and the CPWs 106, the web server need not always intermediate such communications but rather in some circumstances the mobile device interacts directly (that is, directly by way of one or more networks that do not involve any web server, or at least not a web server as described above) with respect to one or more of the CPWs. In that regard, the mobile device 102, upon completing the step 620 (or, in some cases, the steps 610 and 616 as discussed above) further determines whether there is a need or desire for the mobile device to communicate directly with one or more of the CPWs 106 at the step 622.

If the mobile device 102 determines at the step 622 that this is not the case, then the mobile device can return in its operation to a node A, in response to which the process begins again at the step 604 and proceeds onward. Assuming this to occur, the mobile device 102 thus continues to both receive information from the web server 104 and also continues to operate to upload content information to the web server on a repeated, ongoing basis. If however at the step 622 the mobile device 102 determines that there is a need or desire to communicate directly with the CPW 106, then the mobile device proceeds to a step 624 at which the mobile device establishes such a direct communication link.

Whether there is a need or desire to communication directly with the CPW 106 can be determined based on a variety of considerations. In some circumstances, the mobile device 102 determines this automatically and as a result automatically proceeds to establish the direct communication link with the CPW 106. For example, if a user requests more information regarding a particular topic and downloading of that information from a given CPW is best accomplished (e.g., in terms of efficiency of data transfer or the like) by way of direct communications with the CPW, then the mobile device can attempt to connect directly to the CPW. Also it is possible in some circumstances that a user may wish to view information available at a particular CPW in the particular format associated with that CPW, and not wish to view a redacted view of such information as might be provided if the information was processed by the web server 104 en route to the mobile device. Also the determination of whether there is a need or desire to communicate directly with the CPW 106 can be determined based upon receipt of a user command that expressly requests such communications.

The establishment of a direct communication link at the step 624 can involve a variety of particular commands or operations by the mobile device, which in some circumstances can involve receiving inputs from a user, depending upon the embodiment. For example, in one circumstance, a user initiates the establishment of such a direct communication link by causing a browser application/program to be opened and run on the mobile device and by entering a URL (Universal Resource Locator) for the CPW into an input field provided by the browser, as a result of which the browser enters into communication with the CPW and the CPW in turn returns web pages or other information back to the browser by which the mobile device (and user) is able to engage in further communications with the CPW. In other embodiments, the establishment of the direct communication link is an automatic process that does not involve any specific user actions.

Regardless of how the direct communication link is established, upon establishment of that link then at a further step 626 the mobile device 102 sends and/or receives information to and/or from the CPW 106 directly (again, without the intermediation of the web server described above). Subsequently, at a step 628, the mobile device further determines whether there is a need or desire to cease the existing communication link with the web server 104. If there is no such need/desire, then the process returns to the node A and again the step 604 and subsequent steps are repeated. That is, both direct communications (without web server intermediation) and indirect communications (by way of the web server) between the mobile device and the CPW(s) can continue simultaneously. However, if at the step 628 it is determined that there is a need or desire to cease server-based communications, then the process advances to a step 630 at which the mobile devices communication with the web server is broken (which corresponds to the step 440 discussed above with respect to FIG. 4).

In the present embodiment, as discussed above, the web server 104 is configured to maintain itself in communications with the CPW or sites with which it was previously in communication on behalf of the mobile device even after the communications with the mobile device have been terminated, with the web server 104 continuing to act as a proxy for the mobile device. However, in other embodiments, the web server's communications with the CPWs 106 are severed when the mobile device terminates its communications with the web server 104. In any event, subsequent to the step 630, at a step 632 there may be a new need or desire on the part of the mobile device 102 to reestablish communications with the web server 104. As with the determinations of whether to enter into direct communications with the CPW 106 at the step 622 or cease communications with the web server 104 at the step 628, whether there is a need or desire on the part of the mobile device 102 to reestablish communications with the web server 104 at the step 632 can be determined based upon any of a variety of considerations including, for example, user commands that trigger such activities, battery power considerations, etc. If at the step 632 it is determined that server-based communications should be reestablished, then the process returns to the start step 600. If not, the process represented by FIG. 6 is ended at an end step 634.

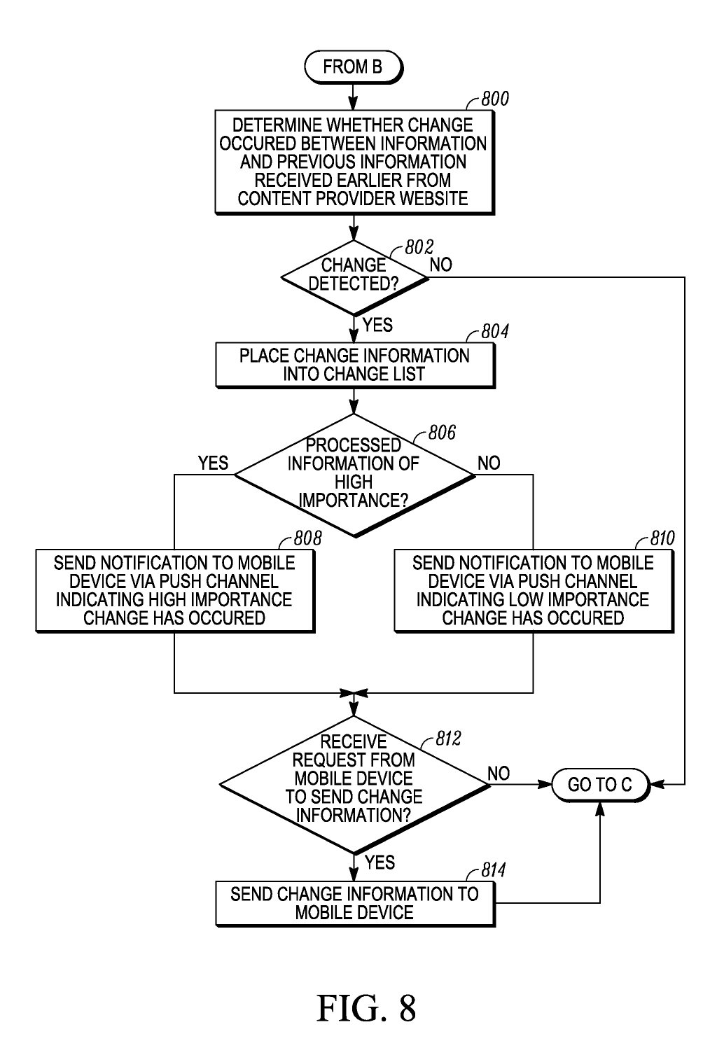

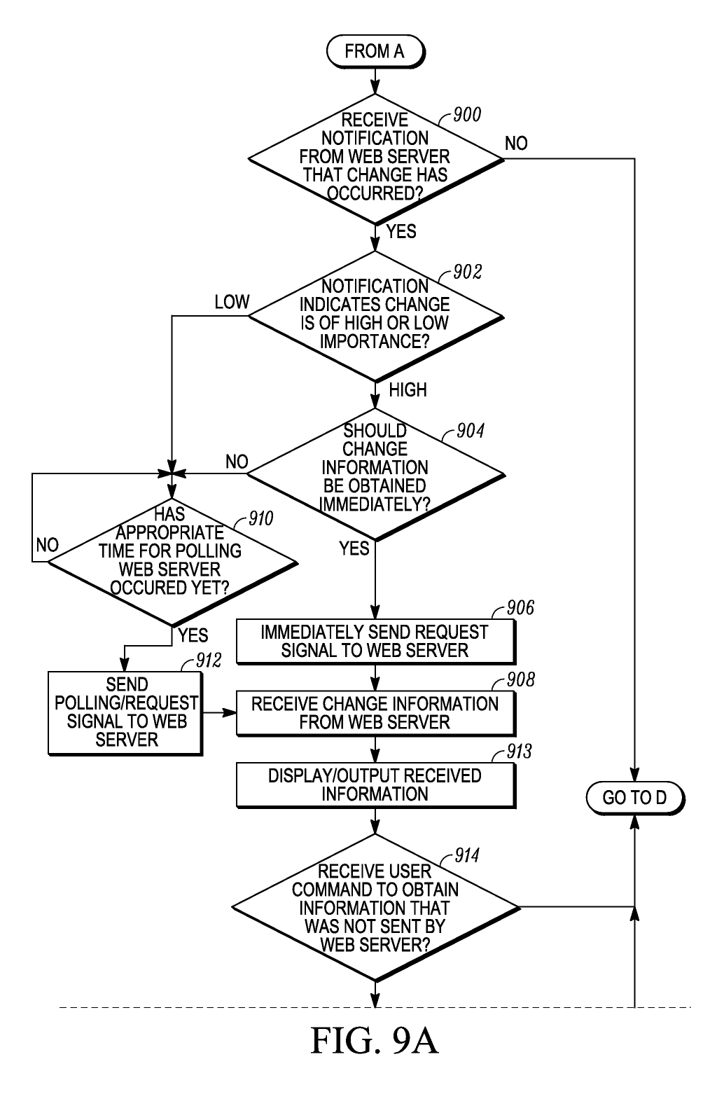

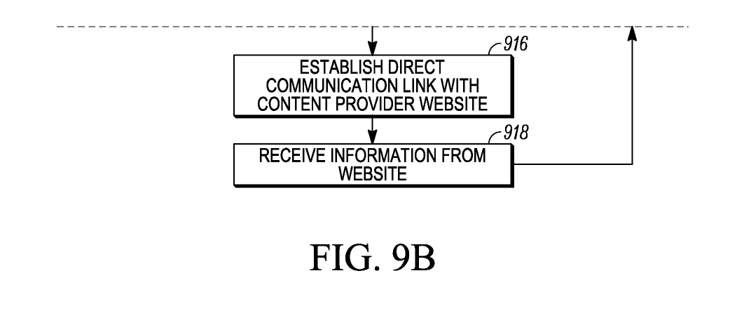

Turning to FIGS. 8 and 9, respectively, in further embodiments the operations performed by the web server 104 and the mobile device 102 can differ somewhat from those shown in FIGS. 4-7. More particularly, in some other embodiments, rather than performing the steps 408-416 between a node B and a node C shown in FIG. 4, the web server 104 instead operates in a different manner involving steps 800-814 shown in FIG. 8. As shown, upon proceeding from the node B, rather than performing the processing step 408 (and corresponding steps shown in FIG. 5) the web server 104 instead performs steps 800, 802 and 804. At the step 800 in particular, the web server 104 determines whether a change has occurred between information just obtained/pulled from the CPW 106 in the step 406 and information previously received from that CPW at an earlier time. If change(s) are detected at the step 802, then at a step 804 the front end portion 308 of the web server 104 places that change information into a change list. Where these steps are performed repeatedly in relation to multiple CPWs with which the web server 104 is in contact, the change information detected in relation to each of the CPWs can be all be put into the change list, which can in that case be termed a common change list.

Next, at a step 806, the front end portion 308 of the web server 104 determines whether the processed information is of high importance or not of high importance (e.g., low importance). In performing this determination, the same considerations can be taken into account as were discussed above in relation to the step 410 of FIG. 4, and for that reason the step 806 is also labeled as the step 410 in FIG. 8. Depending upon whether the processed information is determined to be of high importance or low importance, the process then advances either to the step 808 or the step 810, respectively. In the step 808, upon having determined that the processed information is of high importance (e.g., the information concerns a status update), the front end portion 308 of the web server 104 sends a notification to the mobile device 102 via the push channel indicating that a high importance change has occurred. Likewise, at the step 810, upon having determined that the processed information is of low importance, the front end portion 308 of the web server 104 sends a notification to the mobile device 102 also via the push channel indicating that a low importance change has occurred.

Once the notifications have been sent in either of the steps 808 or 810, then at a step 812 the front end portion 308 of the web server 104 at a later time can receive a request from the mobile device 102 to send the change information itself. The request can be received at any time as determined by the mobile device 102. Often, if the change information is of high importance, the mobile device 102 will immediately or very soon after receiving the notification at the step 808 send the request for the information. In contrast, if the change information is of low importance, the mobile device will often wait until a predetermined time (e.g., a periodic or non-periodic polling time) for such a request as been attained. For example, the device may wait no more than 5 minutes to request high importance information and wait 15-30 minutes between requests to download the low importance information. In any event, upon a request for transmission of the change information being received from the mobile device 102 at the step 812, then the requested change information is subsequently sent by the front end portion 308 of the web server 104 to the mobile device 102. In the present example, it is preferable that this change information is not sent by the push channel, or alternatively that only high-importance change information is sent by the push channel, to reduce the amount of time the mobile device is powered up to receive the change content, though it is recognized that in other embodiments all of the change information can be sent via the push channel. Upon the sending of this information at the step 814, or if no request for information is received (or at least not received within a predetermined time period) at the step 812 or if no change was detected in the information received from the CPW 106 at the step 802, then the process returns to the node C (and thus to the step 418) of FIG. 4. It will be recognized, that should no content be required for uploading to the content provider website, the server will return to step 406 as it will continue to pull content from the content provider website 106 independently of whether content is being uploaded to the mobile device 102 client.

Although in the present example, notifications of change information are provided in the same manner by way of the push channel at the steps 808 and 812 regardless of whether the change information is of high importance or of low importance, this need not always be the case. In other embodiments, for example, a notification regarding a high importance change can be sent more promptly than, or in some other manner than, a notification regarding a low importance change. Further, while in the present example of FIG. 8 the sending of the change information at the step 814 occurs at a different time than the sending of the notifications at the steps 808, 810, this need not always be the case. For example, in one other embodiment, in the event the content of high-importance change information is small (e.g., a text message of less than 100 characters), that content can be provided along with (or even serve as) the notification of the high importance change. From the above description, it should also be apparent that in at least some embodiments the operation of the back end portion can be largely or entirely independent from the operation of the front end portion in terms of the different portions' respective communications with the CPW 106 and the mobile device 102. A variety of different types of communications, for example those involving pulling or polling, or periodic or asynchronous communications, can be employed by either end portion irrespective of the operations of the other end portion depending upon the embodiment. Thus, the back-end can continuously pull content from CPWs and send changes to the front end portion independent of what the front end portion is doing. The front-end portion can likewise push to the mobile device and wait for requests to download change content or synchronize the server and mobile device without concern to what the back-end is doing at any a particular moment.

As for FIG. 9, the flow chart provided therein shows how in some other embodiments, rather than performing the steps 604-609 between the node A and a node D shown in FIG. 6, the mobile device 102 instead operates in a different manner involving steps 900-914. The steps 900-914 performed by the mobile device 102 shown in FIG. 9 are particularly complementary with respect to the steps 800-814 performed by the web server 104 shown in FIG. 8. As shown in FIG. 9, upon proceeding from the node A, rather than performing the receiving step 604 of FIG. 6, the mobile device 102 instead can receive a notification from the web server 104 (sent at one or both of the steps 808, 810) that one or more change(s) have been detected in the information provided most recently and at an earlier time from the CPW 106. If a notification is received at the step 900, then at the step 902 the mobile device 102 determines whether the notification indicates that the change is of high or low importance.

If at the step 902 it is determined that the change is of high importance, then the mobile device 102 at the step 904 determines whether the high importance change information should be immediately obtained from the web server 104. Although in some embodiments it is always the case that high importance change information should be obtained as soon as possible, in other embodiments the mobile device can still for various reasons determine that it would preferable to defer attempting to obtain that information from the web server (e.g., because the mobile device is low on power). Assuming that at the step 904 the mobile device 102 determines that the change information should be obtained immediately, then the process advances to the step 906 at which the mobile device immediately sends a request signal to the web server requesting that the high importance change information be provided to the mobile device right away. In response, at a step 908, the mobile device 102 ultimately receives the requested change information (or at least some of that information, as determined by the web server 104) from the web server. In this regard, the performing of the step 908 complements the performing of the step 814 of FIG. 8.

If alternatively at the step 902 it is determined by the mobile device that the notification indicates that the change information is of low importance, or if at the step 904 the mobile device determines that the change information should (or need) not be obtained immediately, then the process instead advances to the step 910. At the step 910, the mobile device 102 further determines whether an appropriate time for polling the web server 104 for change information has occurred. Such an appropriate time can be a periodically-occurring time or, in other embodiments, can be determined by the mobile device 102 based upon a variety of other considerations (e.g., a predetermined amount of time has elapsed since another event, or a user command as been received instructing the mobile device to obtain content information from the web server 104).

If at the step 910 the appropriate time for polling the web server has not yet occurred, then the process can repeat that step until such time occurs (or can advance to another step of the process and/or possibly return to the step 910 at a different time). If however at the step 910 the appropriate time has occurred, then the process advances to the step 912, at which a polling/request signal is sent by the mobile device 102 to the web server 104. Upon the sending of that signal, the process returns to the step 908 at which the mobile device 102 receives the requested change information. Further as shown in FIG. 9, upon completion of the step 908 the mobile device 102 proceeds to perform the step 913 in which the received information is displayed or otherwise output by the mobile device 102 to allow for review of the information by a user of the mobile device. The step 913, as shown, can be identical or similar to the step 609 of FIG. 6.

While the change information sent by the web server 104 at the step 908 is often of greatest interest to a user of the mobile device 102, this change information often excludes a variety of content (as well as formatting) information that was originally available at the CPW 106 prior to processing of that information by the web server. That is, while the information provided by the web server 104 can include various content such as happenings, recent status information, comments from others, etc., and while the mobile device 102 can also as matter of course display certain standard information as part of its user interface (e.g., the name of the user, the CPW with which the user is contact, etc.), significant amounts of content and/or other information can be excluded due to the intermediation of the web server 104. For this reason, upon the display of the change information at the step 913, a user may decide that it would be desirable not only to obtain the change information but also to obtain other content (or even formatting) information. Given that a user may wish to obtain such other information, the mobile device at the subsequent step 914 further determines whether a user command to obtain other information not received from the web server 104 at the step 908 has been received. Such a command can be received, for example, when a user selects an icon displayed by the mobile device, which might be displayed as part of the change information at the step 913.

If it is determined at the step 914 that such a command was received, then the mobile device 102 at a step 916 establishes a direct communication link with the CPW 106. This operation of establishing the direct communication link can be identical or similar to the operation associated with the step 624 discussed above, and can involve standard web-based client-server communications (e.g., involving the input/transmission of a uniform resource locator (URL) and/or interfacing with web pages of the CPW 106) that are designed to both establish the communication link and elicit the other information that was desired by the user. Thus, upon establishment of the direct communication link at the step 916, then at the step 918 the other information desired by the user is received from the CPW 106. Upon completion of the step 918, as well as in the event no user command was determined to have been received at the step 914 or in the event notification from the web server 104 was received at the step 900, then the process returns to the node D and continues on with the step 610 of FIG. 6.

In another alternate embodiment of the invention, the back-end portion 306 includes a plurality of plug-ins, or processors, each of which is associated with a respective CPW 106. Each plug-in includes application programming interfaces (APIs) for its associated content provider website 106. Each plug-in uses hypertext transfer protocol (HTTP) to persistently pull information from its respective content provider website 106.

When changes are detected by the back-end portion 306 plug-ins, the changes are loaded into a queue and the front end portion 308 pushes a notification to the device. All of the plug-ins in the back-end portion 306 will continue to load the queue with information formatted according to a common format that includes, for example, the ID of the source of the information (the source content provider website identification), the account ID of the user device, the content type, the priority, and the information. For status, for example, the format can be: type (STATUS, MOOD, STATUS_AND_MOOD), action (clear status or update status), provider, aggregation service account id, external id, friend id if the update is for a friend, status text, post date and time. The web server builds a unified feed for each user device (or user account) by combining the content pulled by all of the plug-ins into a common change list for each respective device (or user account). The content is built over time, and each entry can be time stamped.

The following algorithm can be used for detecting a change during server sync, with server sync being understood to involve syncing of the web server 104 with a CPW 106 (by comparison, client sync can be understood to involve syncing of a client such as the mobile device 102 with the web server). The web server 104 program maintains three numbers for each account: c1a, w1, and w2. The c1a is the change list anchor, w1 is the beginning time (sample) of the change list window, and w2 is the end time (sample) of the change list window. The server 104 stores the portion of the change list that falls inside the window [w1,w2]. All changes found during a server sync (i.e., the back-end pulling from the content provider website) are stamped with a sync anchor equal to the current w2 (i.e., before w2 is incremented by 1). The program suspends server sync (content provider web size sync) once the window size reaches or exceeds the maximum window size mw. Once suspended, the server will resume server sync when a new client poll is received. The other variables are ca is the client anchor, OFF is a flag indicating no sync activity. The values of c1a, w1, and w2 are updated according to the following state transition rules:

| Event | State transitions |
|---|---|
| initialization | cla = 0, w1 = 0, w2 = 0, off = 0 |
| server sync | w2 = w2 + 1, off = 1 if w2 − w1 >= mw |
| client sync, w1 <= ca <= w2 | w1 = ca, off = 0 |
| client sync, cla < w1 and | cla = w2 + 1, w1 = cla, w2 = cla, |
| (ca < w1 or ca > w2) | off = 0 (aka “change list reset”) |

When the client polls for changes, if the client anchor ca falls inside [w1, w2], then a partial sync will work and the server sends back changes that fall within [ca, w2] (and deletes changes older than ca). At the conclusion of the sync, ca will be updated. If when the client polls for changes, the client anchor fell outside of [w1, w2], a new full sync will occur between the web server 104 and the client program in mobile device 102.

It is envisioned that server sync (the back end plug-ins pulling content for a particular device 102) can be suspended for a particular device 102 account when the window size reaches mw, in which case a few missed pushes (notifications to the device) may cause service outage for a device in the absence of client polling. It is envisioned that it may be advantageous to sending pushes if there are pending changes since last w2, pushes can be sent as long as there are pending changes since w1.

It is further envisioned that the intermediary web server 104 described herein can be advantageously employed with the device polling manager described in U.S. provision application 61/180,301, entitled A MOBILE COMPUTING DEVICE AND METHOD WITH ENHANCED POLING MANAGEMENT, filed on May 21, 2009, the disclosure of which is incorporated herein by reference.

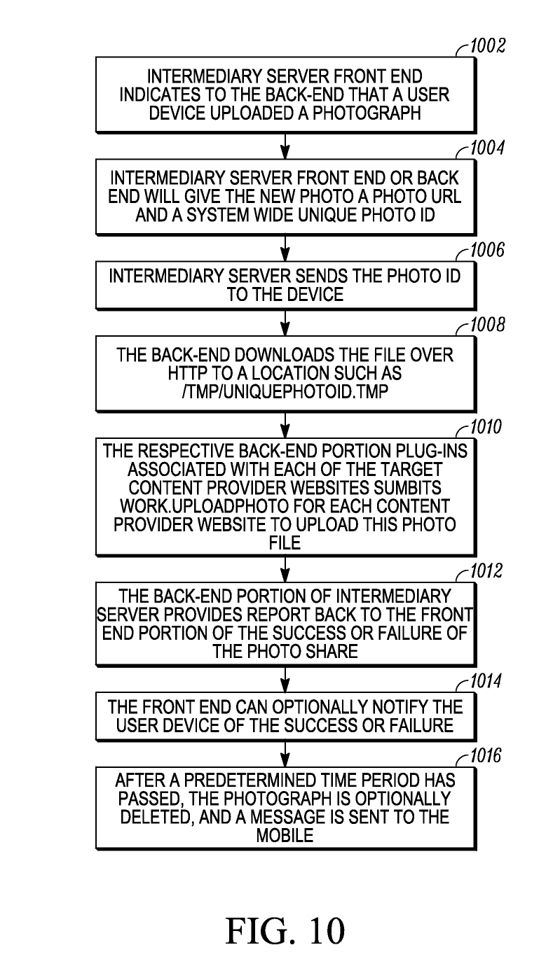

Photo, also referred to as picture, uploading will now be described as an example of uploading content. The intermediary web server 104 can be employed to optimize a process of uploading photos from a user device 102 to multiple social networking systems 106 by caching the photos at an intermediary server 104 memory 302. An exemplary flow can be as follows:
1. The intermediary web server front end 308 indicates to the back-end portion 306 that a user device 102 uploaded a photograph at step 1002 (FIG. 10)
2. The web server front end or back end will give the new photo a photo URL and a system wide unique photo ID at step 1004;
   3. The photo ID is downloaded to the device 102, responsive to which the device client program associates the photo ID with the photo name at step 1006;
   4. The back-end downloads the file over HTTP to a location such as /tmp/uniquephotoid.tmp at step 1008;
5. The respective back-end portion 306 plug-ins associated with each of the target content provider websites submit work.uploadPhoto for each content provider website 106 to upload this photo file at step 1010;
6. The back-end portion provides a report back to the front end portion of the success or failure of the photo share at step 1012;
7. The front end can optionally notify the user device 102 of the success or failure at step 1014;
8. After a predetermined time period has passed, the photograph is deleted at step 1016.

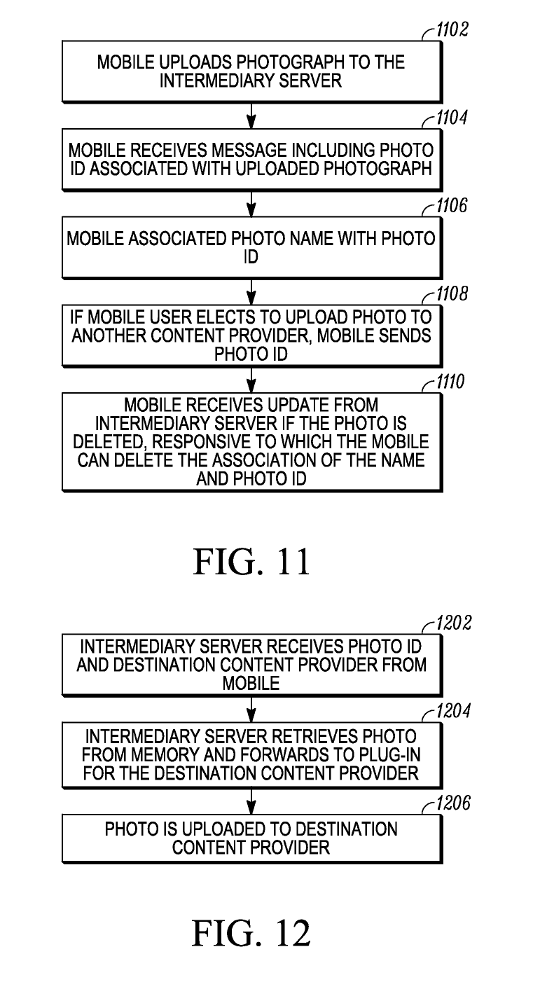

In operation, the photographs from the user device 102 are uploaded from the user device 102 to the front end portion 308 of the network, as indicated at step 1102 (FIG. 11). The front end portion 308 or the back end portion 306 caches the photos in the intermediary server memory 104 for a predetermined time period to allow the same photo to be submitted to the web sites of different systems in step 1206 (FIG. 12) without requiring that the photo be uploaded again by the user device 102. After the predetermined time period, the photo will be erased. The predetermined time period may be any time period, and is selected according to the memory constraints and the frequency of use. The time period may for example be 24 hours, which time period can start at the time the photograph is upload to the memory 302, whereby the time period is set once the picture is uploaded, or the time period may start upon the uploading of the photograph to a content provider 106, whereby the time period will be extended each time the picture is uploaded to a new content provider.

For one exemplary embodiment, a photograph is uploaded from mobile device 102 as an action, along with the identification of a specified content provider website 106, to the intermediary server front end 308 and stored in temporary storage of the network server at step 1102 (FIG. 11). The front end 308 forwards the photo to a plug-in in the back-end 306 at step 1004 (FIG. 10), the plug-in can for example be dedicated to the content provider website specified by the mobile device. The network server front end portion 308 also sends a message including a photo identification (ID) associated with the saved photograph back to the user device 102 at step 1006. The photo ID identifies a location or pointer to the location where the photo is stored at the web server memory 302. The mobile device receives the photo ID in step 1104 and associates (maps) the photo ID with the name of the photo as indicated in step 1106. Subsequently, if the mobile device 102 elects via the user interface to send the same photo to a different social networking system, the mobile device will send the photo ID, instead of the actual photo, to the network server in step 1108. In response the intermediary server 104 will retrieve the photo and forward it to another plug-in dedicated to the other content provider website 106 as indicated in step 1204 (FIG. 12). It is envisioned that once the photo is removed from the memory 302, an update will be sent to the user device 102 in order for the user device to remove the association of the photo name and the photo ID in step 1110, so that the device will upload the photograph. If on the other hand the photo is no longer stored, and the server receives a request to upload the photo associated with the photo ID, the front-end portion will send an error message to the subscriber device responsive to which the subscriber device will be invited to upload the photo again.

For other embodiments, the web server back-end portion 306 will determine whether the photo uploaded from the user device 102 is within the requisite limitations (i.e., dimensions and size) of the target social networking system. It is envisioned that this can be processed by the plug-in associated with each content provider website when a picture is removed from memory 302, as each plug-in can store the content provider websites limitations on photographs. If the limitations are met, the back-end 306 can send the photo through to the target content provider website. Otherwise, the photo will be resized according to the requirements of the content provider website. In order to resize the photograph, and/or scale the photo to a target size, a resize factor is determined A particularly advantageous algorithm that can be used to determine the resize factor X is as follows:

x/100=((t−f)/(kc))̂(0.5)

where
x is the resize percent
t is the target size in bytes, and may for example be approximately 1 megabyte or less, and can advantageously be less then 200,000 bytes, and in one implementation was 100,000 bytes.
f is a small fudge factor for the file size
k is a constant factor, and may be less than 1, and can advantageously be less then 0.5, and in one implementation was selected to be 0.23.
c is the original file's size in bytes.

By storing a photograph in the web server 104, the server helps reduce power consumption in the device and bandwidth burdens on the communication network by permitting the mobile device to send media to different social network servers at different times while uploading the media only once through the local area network or wide area network over which the device communicates. Additionally, the web server can adopt the media to the format desired by each content provider website, and the device need not know or accommodate these requirements to successfully upload the media.

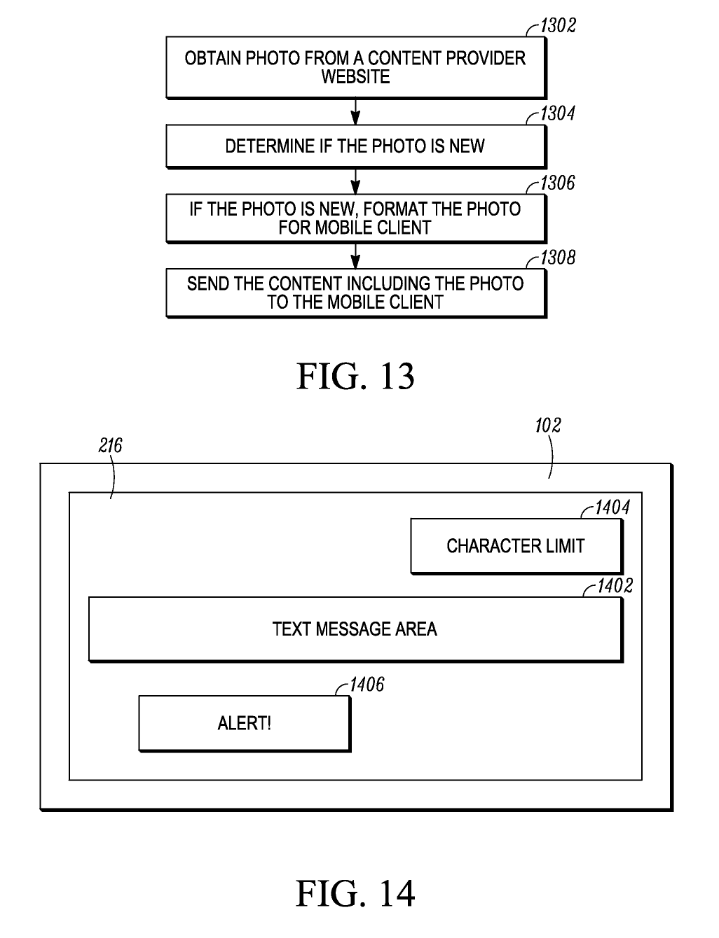

It is also envisioned that photographs can be downloaded in step 1302 (FIG. 13) to the devices 102 via the intermediary web server 104. For example, for RSS news feeds, photos from an RSS content source are pulled by the back-end news feed with a news feed summary. When the back-end 306 detects that such news information is new in step 1304, or in other words that a change has occurred since the previous RSS news feed was pulled from this CPW by the back end portion, the back-end portion 306 of the server 104 will transmit to the front end portion a feed properly formatted in step 1306 for the client device. The front end portion 308 will generate a low priority push notification to the client device 102 and the queue for the device 102 will be loaded with the summary and the photograph. When the client device thereafter sends a polling request to the front end portion for content, the front end will transmit the contents of the queue including the news feed, which contains the formatted photo and the summary in step 1308. The client program on the mobile device 102 will display the summary and associated photo on the mobile device 102 display 216. By way of example, if the input 210 includes a touch sensor over the display (commonly referred to as a touch-screen), the user can touch the screen at the summary and photo and the user interface will connect directly through link 110 to the content provider website associated with the news feed summary/photo and load additional information regarding the news feed on the display 216 for viewing by the user. The back end portion 306 thus detects and formats the new photo and summary for the device, and the front end portion 308 notifies the device that content is available and responds to a polling request from the device to download the news feed to the mobile device 102.

It is further envisioned that the client program in the mobile device 102 will store some definitions regarding the content types and characteristics for each content provider website that the user has a server account. The user interface of the device will vary depending on which accounts the user sets up on the server in step 1502. For example, assume the user enters Facebook™ and Twitter™ on their web server 104 account. When the user interacts with user interface to construct a message 1402 (FIG. 14) to be uploaded to a content provider website, the user interface display presents a choice (not shown) of “Facebook”, “Twitter” or “ALL” for the target content provider website where the message will be sent. Depending on which selection is made, the parameters for the message may be different (e.g., the number of characters) in step 1504. If the user selects all, the length 1404 will be the shorter of the two content provider website limitations. It is further envisioned that a length count 1404 and warning 1406 can be provided. As the user enters text in step 1506, the remaining characters permitted before the limit is reached is displayed in the character limit 1404. At some threshold, such as 30 characters, a warning 1406 will be displayed in step 1514. When the limit is exceeded, the remaining characters will go to a negative count, or the user will be prevented from inputting additional characters in step 1516. In the event that the user changes the destination content provider source, the limit will change appropriately. For example, if Twitter™ website is added as a destination after the message is created, the limit will be reduced. If Twitter™ website is removed as a destination, the limit increased.

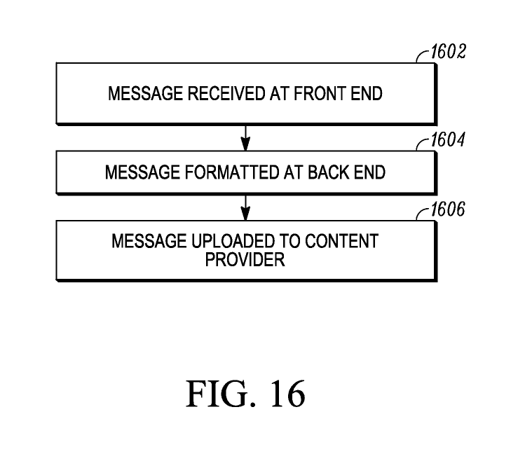

The mobile device 102 generates a user interface display 216 having operating parameters 1404 dependent on the one or more content provider websites to which the user device set up on the intermediary web server. For messages, the generic message entry field 1402 is presented on display 216 for the user to input text, the size upper limit based on the smallest maximum message size permitted by the one or more social networking websites selected to be the destination of the message text. The limit can be retained on the client device. The mobile device client program can generate a warning 1406 when the message size gets within a predetermined amount of the limit. The limit changes in step 1510 if the one or more social networking sites changes in step 1508. The content from the user interface input populates the message input area 1402, and can generate a warning when the limit is reached. The client program transmits the message which is received by the server front end at step 1602 (FIG. 16) with the identity of the one or more destination social networking web sites. The back-end portion formats the message in step 1604 for the one or more destination web sites and uploads the message in the format desired by the social networking website in step 1606.

From the above description, it should be evident that a variety of methods employing numerous different operational steps such as those discussed above, are encompassed by the present invention. Additionally, a variety of alternate embodiments are also intended to be encompassed by the present invention in addition to the specific embodiments discussed above, including embodiments employing methods having other operational steps in addition to or instead of those discussed above, as well as embodiments employing methods with steps in a variety of orders and combinations in addition to or instead of the particular orders or combinations of steps discussed above. Further it should be evident that systems in accordance with one or more of the embodiments described above are able to provide enhanced functionality in several regards in terms of facilitating interactions between mobile devices operated by users and social networking websites. Depending upon the embodiment, any one or more of the quality of communications between users and social networking websites, the user-friendliness of social networking websites and associated transactions as experienced by mobile device users, and/or the efficiency of communications between mobile devices and such websites can be enhanced.

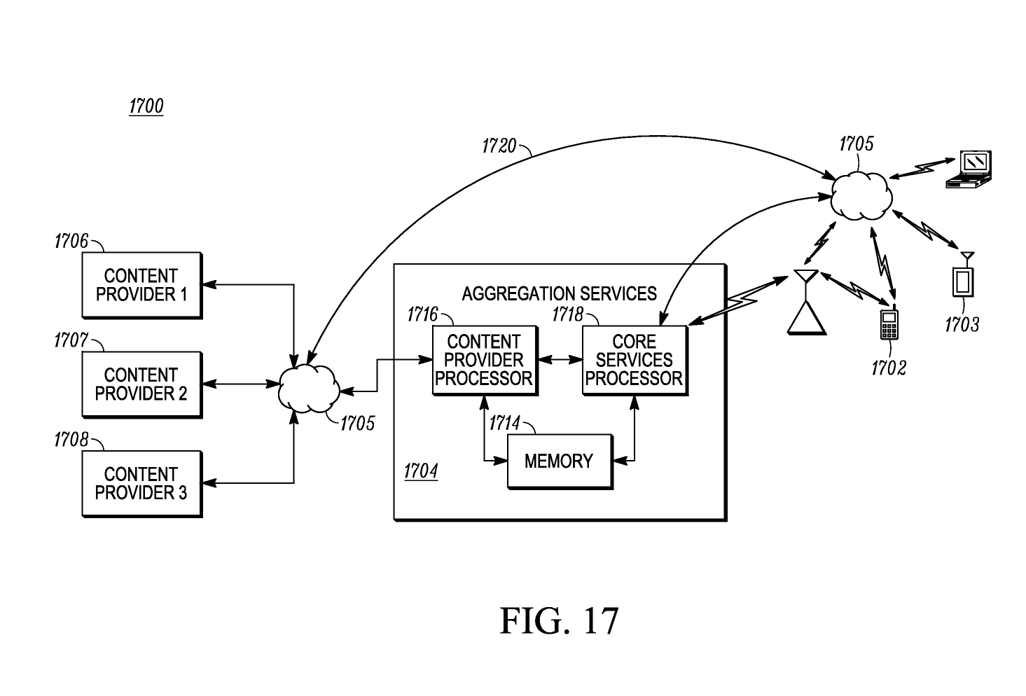

FIG. 17 illustrates another exemplary communications system 1700. The communications system 1700 in FIG. includes an intermediate web server 1704, also referred to herein as a web server, an intermediary web server, an aggregation server, or aggregation service. The web server 1704 may include a content provider processor 1716, a core services processor 1718 and a memory 1714 as described in further detail below.

The web server 1704 exchanges information between one or more user devices 1702 and 1703 and one or more content provider websites 1706-1708, which may also be referred to as content providers, social networking websites, news sources or news feeds. The user devices 1702 and 1703 may be any of the user devices discussed herein. The intermediate web server 1704 pulls information from the content provider websites 1706-1708 and makes the information available to the user devices 1702 and 1703, responsive to a poll from the user devices. The user device 1702 and 1703 can also push content to content provider websites via the intermediate web server 1704. Additionally, the user devices 1702, 1703 can access the content provider websites (CPWs) 1706-1708 directly through a direct connection 1720 over the internet 1705, which may also be referred to as the world-wide-web, or simply the web.

User devices 1702 and 1703, the intermediate web server 1704, and the content provider websites 1706 are connected via the internet 1705, and illustrated by a first internet network 1705′ and second internet network 1705″. The intermediate web server 1704 accesses the content that the content provider websites make accessible via the internet network 1705″, according to selected application program interface (APIs) associated with each particular content provider, according to settings for each device 1702 and 1703, and make the content available to the user device in an easily processed format. The intermediate web server 1704 also receives content originating from the user devices 1702 and 1703, communicated either through the internet 1705 or via another communication network, such as a cellular network, and provides the information to the appropriate content provider 1706-1708 in an appropriate format for the respective content provider website.

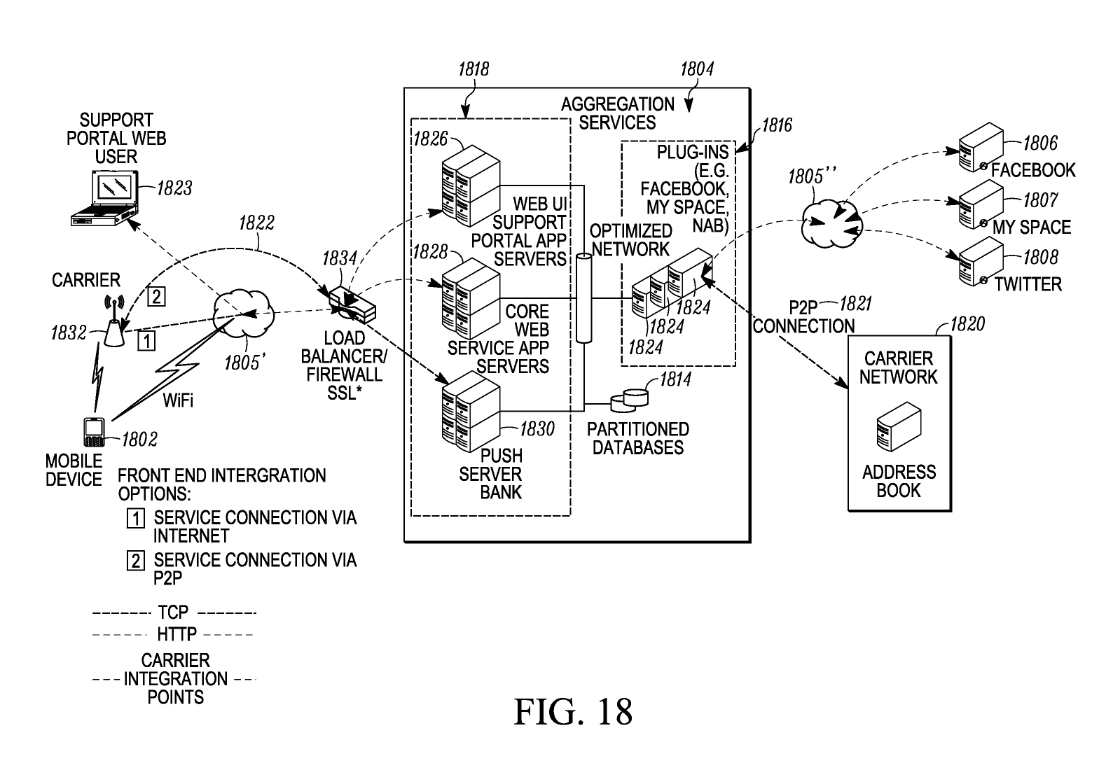

FIG. 18 illustrates yet another exemplary communications system 1800, wherein a user device 1802 is connected via an internet network 1805 to intermediate web server 1804. The user device 1802, illustrated as a mobile device in FIG. 18 may also to be connected to the intermediate web server 1804 via a P2P carrier connection 1822. The intermediate web server 1804 is connected to content provider websites 1806-1808 via the internet 1805, and to a carrier network 1820 via a P2P connection 1821. The carrier network 1820 may include an address book that may have a connection to a back-end plug-in.

The intermediate web server 1804 includes content provider processor 1816 to pull information from content provider websites 1806-1808, process information to identify new content, and generate a notification sent to core services processor 1818 if new information is identified. The information may be stored locally within the web server 1804 in memory 1814. Core service processor 1818 notifies user devices 1802, 103 that new information is available and stores user device information for synching with the user devices. The core service 1818 responds to polls from the user devices 1802 and 1803 to provide content to the respective user device.

Information transmitted by the user devices 1802 or 1803 may also be posted to content provider websites 1806-1808 through web server 1804. The content provided from the user devices 1802 or 1803 is received by the core service processor 1818, formatted by the content provider processor 1816 to be compatible with one or all of the content provider websites 1806-1808, and sent to the appropriate content provider 1806-1808.

Examples of content provider websites 1806-1808 include social network websites (SNWs) such as Facebook™, Twitter™, and Myspace™. Other content provider websites can be photo sites such as Photobucket™, or news sources, including any source providing a Really Simple Syndication (RSS) feed or any other source of news content. The above examples are not considered exhaustive, but rather examples of the types of sources that can provide content for user devices. The sources may include special content for mobile devices, or content for personal computers.

The content provider processor 1816, which may also be referred to as the back-end, the back-end portion, or the social network processor (SNP), of the intermediate web server, includes a respective plug-in 1824 for each content provider. Each plug-in 1824 may have a respective processor and/or program storing definitions, or APIs, for pulling content from its respective content provider and uploading information from the device to the respective content provider with the appropriate formatting.

The core services processor 1818 is also referred to as the front-end. The core services processor 1818 includes a web support portal application server 1826, a core web services application server 1828, and a push server 1830. The core services processor 1818 and content provider processor 1816 are connected to memory 1814, which serves as a temporary store or cache, which can for example be implemented using a large memory system partitioned into databases.

As illustrated in FIG. 18, the mobile devices 1802 can be connected via a local area network, such as a wired Ethernet or a wireless 802.xx connection, or via the cellular network to base station 1832. The carrier can connect to the intermediate web server through a P2P connection 1822 between the base station 1832 and a load balancer and firewall SSL 1834. The carrier base station 1832 can also connect to the intermediate web server 1804 through the Internet 1805. A P2P connection 1821 may also exist between the plug-ins 1824 and a carrier network 1820.

The Push server 1830 may, for example, be connected to the user device 1802 by a TCP connection. The core web service servers 1828 and the web support portal 1826 may be connected via an HTTP connection. The plug-ins 1824 may also communicate with the content provider websites 1806-1808 via HTTP connections.

As discussed above, the respective plug-ins 1824 support social networking sites such as Facebook™, Twitter™, MySpace™, and content feeds such as RSS, ATOM, Podcasts, and the like. Additionally, plug-ins 1824 may be provided for messaging portals such as Yahoo™ mail, Google™ mail, and Microsoft™ mail. Email services, however, may still be directly accessed by the mobile devices 1802 and 1803, and the contact lists from the mail services backed up via the front end services. Data aggregation (information from the content provider to the device) and notification APIs (from the device to the content provider) may support a variety of activities, such as status, notifications (new mail, feed change), friend feed, and friends/contacts. The web server 1804 also supports a push channel (to provide notifications to the device), over-the-air software provisioning, setup and configuration of the intermediate web server for the device (e.g., the user's accounts, preferences, etc.) and web services. The intermediate web server 1804 features user device security, widget-based web access, device backup and restore, and carrier support tools.

The intermediate web server 1804 may provides account management, push and data services to a device 1802 or 1803. The account management service may provide settings and device setup, supporting service identification, server settings for the user and other account/user configuration. The push service may provide a service to notify a device that it has new content, or data available, thus allowing for timely presentation of dynamic data such as status, news and friend updates to the user without the user device having to poll the content provider directly. The data services may include upload, retrieve and synchronization services for various types of data to the device. For example, feeds provide information retrieved from the content provider websites to the devices, uploads provide content from the device to the content provider websites, and sync enables synchronization of the device 1802 or 1803 with the cache on the server.

A device 1802 or 1803 connecting to the intermediate web server 1804 for the first time may connect to a device setup service to do the initial device setup, such as setting entering an email account to associate with the aggregation service, set up the content provider websites to be accessed by the device, enter the passwords and user identifications, and establishing preferences such as language. Once the device setup is complete, a persistent TCP/IP connection is established for the client device and the push service. When the intermediate web service 1804 detects that a change has occurred that affects the data for a particular device, a signal is sent to the device via the push service. At this point it is up to the device to decide whether or not to connect to the relevant data service directly and retrieve any new or modified data. For example, the device may poll the server for the information, and present the information to the user via the user interface (e.g., a display). The user can view the information, and decide whether to access the source directly to obtain additional information.

The information pulled from the content provider websites 1806-1808 by plug-ins 1824 is processed in the intermediate web server 1804 and compared to previous information to identify changes.

The information available from the content providers 1806-1808 may be of a wide variety of types. Those content types that are supported by the aggregation service 1804 are monitored for changes. When an event is detected, an item is added to the change list to be provided to the user device. The change list contains all events that have occurred either from initialization or from a last change list anchor. Events include postings, including but not limited to status or comments, news feeds, updates of social network contacts.

More particularly, for each content provider 1806-1808, a set of definitions are provided for the subset of content types that the aggregation service supports. The plug-in 1824 associated with the content provider will pull the supported content from the content provider website 1806-1808. The content may then be reviewed for changes. When a change occurs, the change is communicated to the front end 1818 as part of a change list.

In operation, the server 1804 and a device 1802 each store a change anchor. The server 1804 will continuously pull content from the content provider website 1806-1808 to remain in sync with the content provider website 1806-1808. Each time the back-end portion 1816 pulls content, it checks for a change. If a change is detected it is added to the change list which may be stored, for example, in the memory 1814. The device 1802 syncs to the server 1804 to remain up to date on the changes, and the server 1804 and the device 1802 use the anchors to determine how much information to exchange.

The following terms are associated with the back-end portion of the web server 1804 change syncronization:
server sync—server syncing from the master copy of the data (e.g., the back end syncing from the content provider website such as Facebook™ Twitter™, etc.)
client sync—client program in the mobile device 102 syncing with the front end (the core services server)
CLA—change list anchor—the sample (time or change) at which the last full or partial sync occurred as recorded in the server (recorded at the aggregation service server program)
Change List Versions—change lists may be given a version number to assist in sync tracking
W1—lower sample (beginning) of stored change list window
W2—upper sample (end) of stored change list window
MW—max window size (can be specified as time-span, a number of changes, or a combination of time-span and number of changes)
OFF—a flag indicating whether synchronization is suspended
CA—client anchor—the sample (time or change) at which the last full or partial sync occurred as recorded in the device (recorded in the aggregation service client program).

The following sync transfer queue algorithm can be used when detecting a change during server sync and insure that new information is provided to the device such that the device is updated. The web server 1804 program maintains three numbers for each account: CLA, W1, and W2. The server 1804 program stores the portion of the change list that falls inside the window [W1,W2]. All changes found during a server sync are stamped with a sync anchor equal to the current W2 (i.e., before W2 is incremented by 1). The program suspends server sync (content provider web size sync) once the window size reaches or exceeds the maximum window size mw. Once suspended, the server 1804 will resume server sync when a new client poll is received. The values of CLA, W1 and W2 are updated according to the following state transition rules:

| Event | State transitions |
|---|---|
| initialization | CLA = 0, W1 = 0, W2 = 0, OFF = 0 |
| server sync | W2 = W2 + 1, off = 1 if W2 − |
| | W1 >= MW |
| client sync, W1 <= CA <= W2 | W1 = CA, OFF = 0 |
| client sync, CLA < W1 and | CLA = W2 + 1, W1 = CLA, W2 = |
| (CA < W1 or CA > W2) | CLA, OFF = 0 (aka “change list reset”) |

When the client 1802 or 1803 polls for changes, if the client anchor CA falls inside [W1, W2], then a partial sync will work and the server sends back changes that fall within [Ca, W2] (and deletes changes older than CA). Otherwise, the server and client starts a full sync. The client needs a full sync if and only if client anchor CA is less than W1 or greater than W2 (i.e., the CA is outside the window). In this case, the client anchor CA is “invalid”. The server 1804 resets its change list if and only if the change list anchor CLA is less than W1 (i.e., the server does not have the full history of the current change list). The server 1804 sends the window [0, W2] to the client, where the “0” tells the client that it should do a full sync.

Although an account to be associated with a single device, a users may want more than one device to sync to the same user account in the aggregation service. In the absence of change list resets, multiple devices work as well as a single device. In case of a change list reset, a race condition could happen between the multiple devices that would cause change lists constantly resetting on the server. For example device 1 polls for changes, sending an invalid CA. The server 1804 does not have full history of current change list, so it resets its change list. Device 1 again polls for changes, causing W1 to move up. Device 2 then polls for changes, and its CA is guaranteed to be invalid because of the change list reset caused by the polling of Device 1. The server 1804 is then forced to reset its change list again. Device 2 may then poll for changes again, causing W1 to move up. If Device 1 then polls for changes, and its CA is guaranteed to be invalid because of the change list reset and the server 1804 is forced to reset its change list again.

To avoid this race condition, the server 1804 can keep one acknowledged client anchor (“ACA”) for each device, and only move W1 up when the smallest ACA is greater than the current W1. Alternatively, the server may create a buffer zone for W1, i.e., server won't move W1 all the way up to CA, but to a minimum of CA or W2−MW/2.

In the context of synching with content providers, (e.g., Facebook™), due to the fact that the content provider processor 1816 (i.e., SNP processors or the back end portion) do not have the master copy of the data (i.e., the data from Facebook™ or one of the other content provider websites 1808-1808 is not copied in total), and the server 1804 doesn't store the complete history of changes locally, the server 1804 will need to reset (i.e., reconstruct from scratch) change lists from time to time (e.g., when devices go way out of date). As a consequence, the same timestamp/sync anchor could mean different things in the context of change lists constructed at different times.

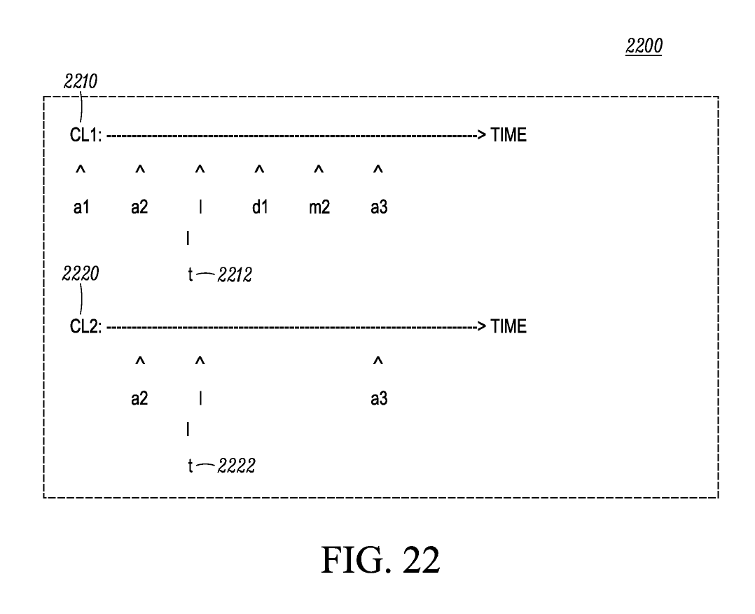

Consider the following sequence of events 2200 illustrated in FIG. 22. In FIG. 22, aX means “add item X”, mX means “modify item X”, and dX means “delete item X”.

As seen in FIG. 22, the server starts with change list CL1 (2210) with only (m2, a2) stored locally in memory 1814, and the client has (a1, a2). The client sends a sync anchor t (2212), which is out of date so the server scratches CL1, and rebuilds the changelist, CL2 (2220) with (a2, a3) stored locally in memory 114. The client then comes back with its sync anchor t (2222) and the server sends back (a3). The client now has (a1, a2, a3), and missed (d1). What should have happened is that the server sends (a2, a3) back and notifies the device to do a full sync. If this send fails, when the client comes back yet again with t, the server may force a full sync or just send (a3) back.

To avoid this problem, a version number can be saved with the change list, not just the individual changes. That is, every time the change list is reset on the server, the change list's version is incremented by 1. Then when an old version number is received from the client, the server will know unequivocally that the client device needs a full sync. In another embodiment, the web server 1804 may store a client anchor for each device and force a full sync when the stored client anchor is out of sync with the sync anchor (e.g., t in the example above) received from the device. For any given change list CL and any given change C, there is an anchor(C)<version (CL) if and only if C comes from a change list whose version is lower than that of CL, then the server need not communicate an extra version number between the server and the client—the server only needs to store the version of the current change list on the server, and compare incoming client sync anchors with this version number to determine if the client is out of version (and thus needs a full sync). The server can achieve this by picking the sync anchors and the change list versions from the same sequence of numbers.

One consequence of this approach is that the server can no longer use external timestamps (e.g., those that come with Facebook™ messages) as sync anchors, but rather assigns its own sync anchors.

The intermediary web server 1804 may provide content to the mobile device 1802-1803 in whatever language it pulled by the back-end from the content provider website 1806-1808. For example, if customer's Facebook™ preference is French, Facebook™ will send content in French, and the content will pass through aggregation services of the intermediary web server 1804 in French. This is consistent with the direct relationship of user devices and social network providers, wherein the account holder cannot change language preferences on their device, but rather selects the language on the social network provider web site.

When a change is detected by the back-end 1816 in a “content type” supported by the web server 1804 (i.e., the aggregation service), the back-end 1816 will notify the front-end portion 1818 to send notice to the user device 1802 or 1803.

The web server 1804 may also sink a news feed. News sources may selected by the mobile device service provider (e.g., the cellular carrier) or the user device. The intermediary web server 1804 can provide local content for each of the markets and languages wherein user devices are utilized. In one embodiment the intermediary web server 1804 does may not translate the language of the content, but may just pass through what the back-end portion 1816 pulls from the news service content provider.

The web server 1804 may also sink an admin feed. Admin feed messages can be created by the system administrator, they are localized and they are sent to the user device in the correct language for the device.

The web server 1804 may also sink contacts, such as a friends list. Given that contacts are not often updated, the front-end 1818 of the aggregation service may synchronizes them infrequently, for example not more than once or twice a day. Providers that support asynchronous change notifications are the exception to this process and such changes are synchronized immediately.

When the intermediary web server 1804 back-end 1816 detects a contact has been updated in a social network website, it sends a low-priority signal to the aggregation service client program stored in device 1802 or 1803 over the push channel. Upon receipt of this signal the aggregation services client will initiate a 2-way sync operation by calling the aggregation service's synchronization web services in the front-end of server 1804.

The aggregation services client may also allow the user to initiate a sync manually. For example, the device 1802 may include a menu by which the user can request a sync with the web service front end. Changes to contacts on the aggregation service client program may be synchronized with the web server in a “lazy” fashion. The client program will batch up changes for a configurable period of time before sending them to the server front-end 1818.

As discussed above, a Friend Feed is information that pertains to contacts/friends in the social networking website provider's network. When the aggregation service detects new feed elements it sends over the push channel a low-priority signal to the aggregation service client program in the user device. Upon receipt of this signal the client will fetch the feed from the aggregation service using the appropriate web service polling exchange. The feed may contain elements from several content providers 1806-1808.

A status is typically set manually by the user for most content providers, but the aggregation services client program can support instant messaging (IM) style presence as well. A status is monitored for the subscriber (self-status) and for all of associated friends (friend-status). Self-status may also be set in the provider by the aggregation services client program using the appropriate web service. When the aggregation service web server back-end detects a change in status (self or friend) it sends a high-priority signal to the aggregation services client program over the push channel. This push signal can advantageously contain the status value in its payload.

Social networking providers that support status will have an entry in the provider settings. Each provider will include status settings that define: the mapping of the provider to a provider ID, maximum length of status text, if mood is supported, a list of moods and/or a list of available reactions. In one embodiment, the user or provider may enter a null or an empty string to clear a status.

If the user is setting a mood, the user may provide an identification of the mood, a description of the mood, select a predefined picture depicting the mood or provide a url for a user selected picture.

The web server 1804 back-end 1816 plug-ins 1824 can obtain status and mood updates directly from the social networking sites and notify the core web service 1828 of any changes. Status and mood updates may contain the following information: a type (STATUS, MOOD, STATUS_AND_MOOD), an action (clear status or update status), a content provider (e.g., one of content provides 1806-1808), an aggregation service account id, an external id, a friend id if the update is for a friend, a status text and/or a post date. If the update is a MOOD or STATUS_AND_MOOD update, the update may include the id, description, picture name and/or picture url as discussed above. The id, description, picture name, and picture url are included to support custom moods. The Id is often a number and the description, picture name, and picture url are text.

Some social networking providers allow users to act on a status. Facebook™, for example, allows users to comment on a status. Twitter™ allows users to indicate favorite status as well as to reply to status. Status reactions provide this capability and are very similar to friend actions and are very similar to friend feeds and friend feed reactions.

One benefit of using the aggregation server 1804, for example, is that need to permanently store any of the changes or updates on the server is advantageously eliminated by doing periodic voluntary resetting of change lists. As a result client devices will have to perform more full syncs with the aggregation server 1804.

Because server sync is suspended when the window size reaches MW, a few missed pushes may cause service outage for a device in absence of client polling. Certain measures can be adopted to make this less likely to happen. For example, instead of sending pushes only if there are pending changes since last W2, pushes can be sent as long as there are pending changes since W1 (or since each device's ACA in the multiple devices case). This approach does result in redundant pushes being sent and hence redundant polls by the client, but the latter penalty can be minimized if W1 (or each device's ACA in the multiple devices case) is included in the push message.

The core web services application server 1828 includes core-services applications whose primary function is to receive data from the back-end 1816 (the social-networking processor (SNP)) and package it for delivery to a client device. These apps include friend feed, social-networking friends, messaging/mail, and news. They may have several properties in common: data flow may be one-way from the server to the client, no client changes may be committed back to the core web services application server 1828 and data is not maintained persistently in the core web services application server 1828.

The front-end 1818 can provide a sync transfer queue, a transient mechanism for sending data down to the client device 1802 or 1803 through a sync channel. The applications in the core web services application server 1828 can register their sync app ID with the transfer queue, which in turn registers with a synch engine, controlled by the front end 1818, as a proxy for the application. The transfer queue allows for an enqueueing of one or more entries into the queue. Each entry can specify a number of fields that are opaque to the queue, including a blob of data; the name of the provider; whether the item constitutes an addition, a modification or a deletion, and a unique ID for the entry. The sync transfer queue doesn't care about the values assigned to any of these fields; it only sequences data in the order that it was queued. The application does not acquire any locks during an enqueue. The queue allows an application to continuously add data into the queue.

The front-end 1818 can also provide tracking of a client state through a sync anchor for each application. This sync anchor may not be exposed to the applications. The front end 1818 may further provide removal of data from the queue when it has verified that the client has received it. This verification can be determined easily when the client comes in for its next update request; the front end 1818 can assume that the client device has received and processed any entries with prior sync anchors.

The front-end 1818 can clean up application data after an expiry period. Each application can specify any number of quota-size and duration pairs (e.g., allow no more than 1000 entries after a day, allow no more than 100 entries after a week, and allow no entries older than a month). The core web services application server 1828 may have a custodian service that routinely checks the queue and sees if the queue for any client device is out of compliance. The custodian service can satisfy the quota by deleting records that it has already sent to the client. Otherwise, the custodian service will flush all of that application's data in the queue for the over quota device.

The front-end 1818 can invoke an application-supplied callback when the queue cannot fulfill a client's update request. This can occur if a device has been wiped (e.g., erased), or if a user has been offline long enough that the custodian service has flushed the queue. In this case, the application is informed that the queue needs to be reset, and the application is expected to requeue the data from scratch. The client is returned an error code that indicates that it's anchor is no longer valid, and it is expected that the client will reset back to anchor 0. The queue goes into a reset state until the application indicates that it has repopulated the queue. Until that time, the queue returns zero entries for any client update request.

The front-end 1818 may also allow the application to force a reset of the queue for a device. This may be necessary if the application detects that the back-end portion has undergone a catastrophic failure, and can no longer provide differential changes to the app.

The application in the core web services application server 1828 can provide the queue with a callback that can translate a list of queue entries into a valid change list for the client. Since the queue is data-agnostic, the application may interpret the queue data before it can be handed back to the sync engine for transmission to the device. The queue can be database-backed. A lock is acquired whenever a client makes an update request or the queue is reset, but this does not prevent applications from continuing to shovel data into the queue.

The Aggregation service web server 1804 exposes two sync-related web service calls.

The first call is a POST method called updates. This call retrieves change lists from the server that the client program can use to merge in the latest server changes. State information on the client is maintained via a sync anchor for each sync app, which is a long value that is initially set to zero. When a client requests server changes for a given sync app ID, the client provides its current anchor as a parameter. The server returns a formatted list of changes, along with the latest server anchor. After the client successively merges the server changes, it must update its anchor to the server's value. The client can specify a page-size parameter to limit the size of the changelist; in this case, an “is_more” flag is set to indicate that the client needs to fetch more updates. The update can be a batching call that allows the client to fetch server updates for multiple sync app ids simultaneously, which can help to reduce the number of roundtrips.

The second call is a POST method called commit, which sends the client's change list to the server 1804. The client 1802 again specifies its last anchor in the request. Note that the server 1804 will reject the commit request (through a specific error response) if the client 1802 is not updated to the last server version. In this case, the client 1802 should call update and merge the server's latest changes before retrying. Thus, the client should generally call update prior to committing its changes.

The client program detects and resolves any conflicts. Commits must be conflict-free, and thus conflicts may only result when the client fetches a server update and attempts to merge it into its local data store, which may contain competing client changes. In general, there are three kinds of conflicts that the client must handle:
Server-mod-client-mod. Both the client and server have made changes to a particular data item since the last successful sync.
Server-mod-client-delete. The server is trying to modify a data item that the client has deleted since the last successful sync.
Server-delete-client-mod. The server is trying to delete an item that the client has modified since the last successful sync.

Note that the sync web service calls are completely agnostic as to the format of the sync data that is exchanged between the client and server applications. The server and client change lists are opaque blobs that the endpoints exchange via the sync framework. In this sense, the sync web service calls are principally an anchored transport mechanism between the two endpoints.

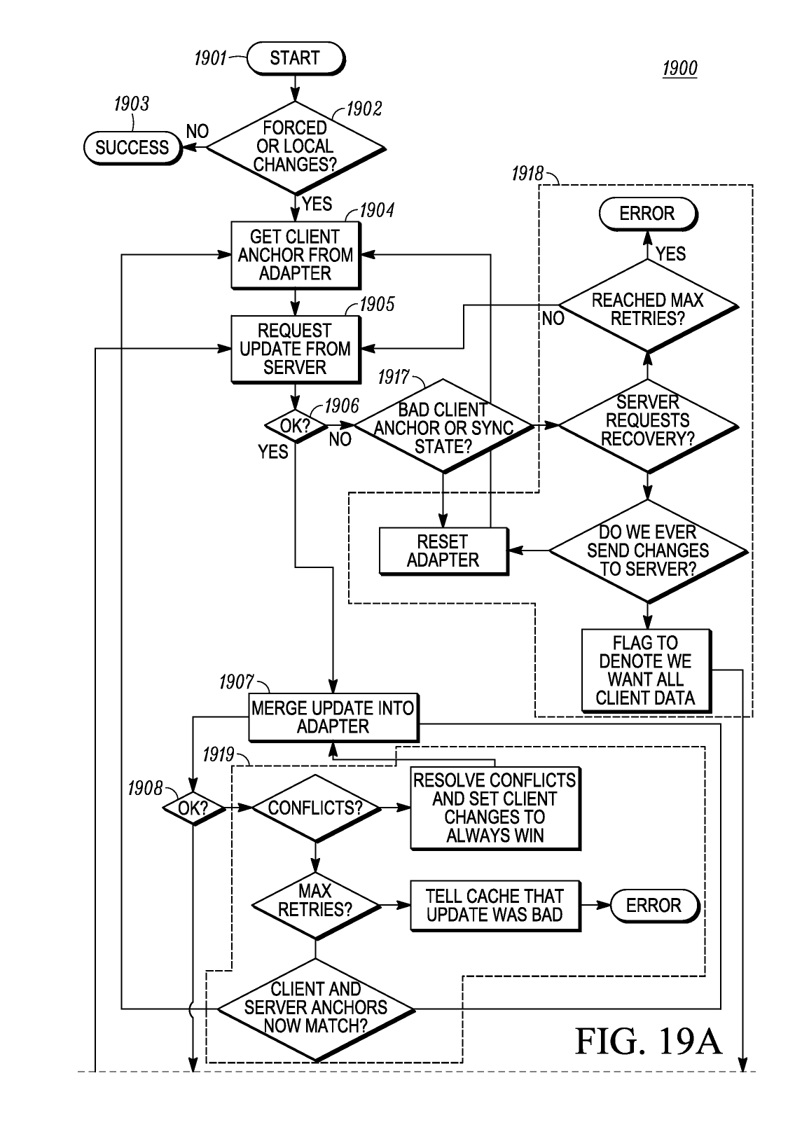

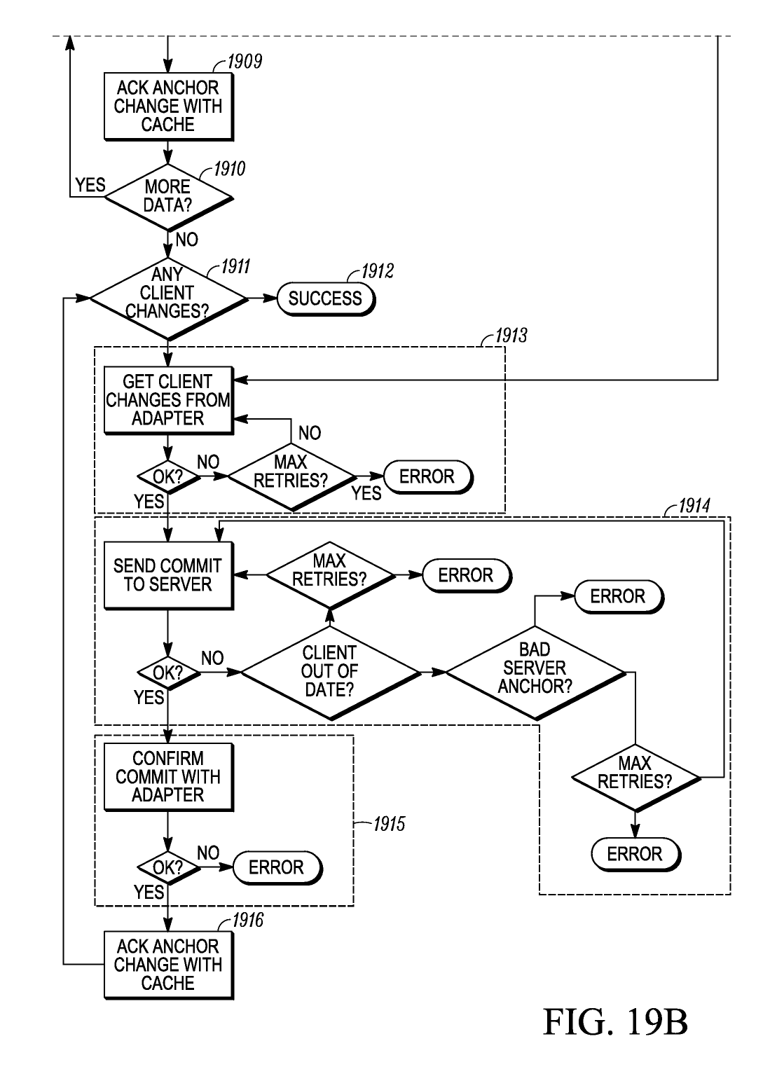

The Aggregation service web server 1804 may also have an aggregation service sync protocol handler, a synchronous finite state machine, which is described in the FIG. 19. Once a aggregation service sync task is dequeued by the sync engine controller, the controller calls the handler's executeSync( )method, which proceeds down the chart beginning at START. Although the executeSync call blocks until completion, there is a timeout (typically 2 minutes, though this is configurable) for the entire task to finish.

FIG. 19 is a flowchart 1900 which illustrates an exemplary sync operation. The simplest scenario results from following the flowchart in FIG. 19, straight down from START 1901. If the sync is forced (i.e., is the result of a server push notification or an explicit force by another app) or if the sync adapter associated with the handler has local changes, the sync proceeds (Step 1902). If the handler has no changes, the process ends. (Step 1903). If there are changes, or the synch is forced, the handler obtains the client's anchor (Step 1904), and calls into the sync WS handler to get differential server changes. (Step 1905). If the request is successful (Step 1906), the handler now has a blob (a byte array) to merge into the adapter via the updateClient( )call. (Step 1907). If the merge succeeds (Step 1908), the client adapter must have updated its anchor to the server's anchor, and this value is sent to the cache (Step 1909). A handler may be configured to retrieve updates in pages; a page size of 10 indicates that the client only wants records with the next 10 anchor values relative to the client. If pages are used, the handler will continue fetching and merging updates until explicitly told that there is no further data on the server. (Step 1910). Next, the handler determines if there are any local client changes (Step 1911). If there are no client changes, the process ends (Step 1912). If there are client changes the handler retrieves the changes (Step 1913) and commits the changes to the server. (Step 1914). The handler will then confirm that the commit was successful (Step 1915). If the commit was successful, the server will send down its new anchor. (Step 1916) The anchor is given to the adapter when the commit is confirmed; the adapter must assume that the commit failed until it receives the confirmation. Finally, the new anchor is relayed to the cache (Step 1916).

The side branches of the flowchart 1900 illustrate how several failure cases are handled. The server may reject the client anchor in an update request. This will happen if the anchor is negative, or if the client submits an anchor that is larger than the server anchor (with one exceptional case below). In this case, the client is told to flush its data and start from scratch. (Step 1917). The server might surmise that the client is in a corrupt state and ask the client to request (Step 1917). This is essentially the same case as above. The server might the request a recovery (Step 1918), which indicates that the client needs to send all of its data up to the server (a full sync) so that the server can recover from the client data. This might occur in the course of disaster recovery, or when a client is migrated to a new cloud (moves from one server 104 to another server 104 that does not have its data). The server can also detect a need for recovery if the server anchor is zero, while the client anchor is non-zero.

The flowchart also illustrates a conflict handling process (Step 1919). The conflict handling may be done, for example, on the client program. The server might tell the client program that it is out of date when the latter tries to commit device changes. For simplicity, the server only allows commits when the client is updated to the latest server data. As a consequence, there are never server-side conflicts.

One of the fundamental features of an aggregation service client phone (e.g., mobile device 1802 of FIG. 18) is the ability for it to be updated with new data from the various social networks that a user is signed up for in a timely and efficient manner. In order to do this, it has been determined that, the aggregation service includes a mechanism to send notifications to the device so that it can know when to retrieve new data from the Aggregation Service Core services application server 1818 of FIG. 18.

In order to provide such a service it has it is desirable for notifications to be sent to the user device 1802 or 1803 over a push channel. The push channel may be an always on TCP/IP connection using XMPP as the basis for the messaging protocol. One example of a system that can be used as the basis for the messaging, is the Jabber XCP server (www.jabber.com).

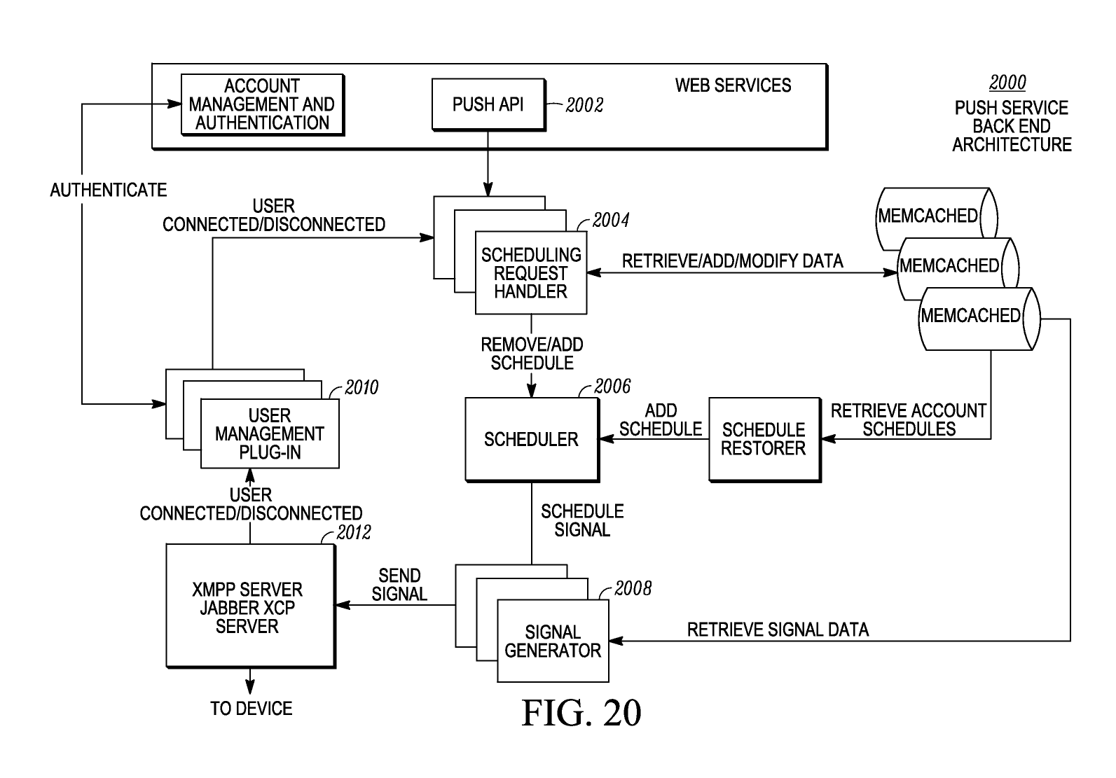

FIG. 20 illustrates the server side PUSH architecture 2000 for an exemplary push channel which may be implemented by Push server 1830 in FIG. 18. The PUSH architecture 2000 includes a Push Service notification API 2002, a Push Service request handler 2004, a Push Service Scheduler 2006, a Push Service XMPP message generator 2008 and a Push Service Authentication plug-in 2010 to Jabber XCP 2012.

The Push Service Notification API 2002 is used by the back-end services (e.g., push server 1830 of FIG. 18) to send notifications and data to a particular account device. In one embodiment the API may be defined as follows:

public class SignalData {

public enum Action {

ADD, REPLACE, DELETE

};
Constructs a new SignalData object
* @param key - A key which can be matched against when looking for this data

item

* @param data - A string which holds the opaque data to be sent to the client
* @param maxDelay - The maximum number of seconds to wait before sending

this data

* @param expiresAfter - Number of seconds from the current time at which to delete

this data

* @param Action - The action to take on this particular data item
* Action.ADD - Adds the data item regardless of key
* Action.REPLACE - If there is another data item that matches this key, then replace

it. Otherwise, add the data item.

* Action.DELETE - Find the data item matching the current key and delete it. In this

key and data may be null.

*/
public SignalData(String key, String data, int maxDelay, int expiresAfter, Action

action);

/*
* Simple getters
*/
public String getKey( );
public String getData( );
public int getMaxDelay( );
public int getExpiresAfter( );
public Action getAction( );

}
public interface Signaling {

/**
* Prepares to queue up a list of data to be sent to a device associated with a particular

account.

* @param appId - The id of the application from which this data was sent
* @param accountId - The id of the account of the device to which this data is to be

sent

* @param deviceId - The id of the device to which this data is to be sent
* @param SignalData - A list of data items to send to the device. The action to take

on each piece of data is embedded which each pice of data

*/
public void sendPushData(String appId, String accountId, String deviceId,

SignalData[ ] data);

}

The sendPushData method constructs a web service call which will call the Push Service Request Handler (PSRH) 2004. The PSRH 2004 is a server which exposes a web-service call which may be represented as a RESTful resource as follows: /blur-services-1.0/ws/push/signaldata. In one embodiment, the Push Service Request Handler 2004 carries out the following operations on each POST:
deserialize the push data;
check to see if there is already data posted for this particular account id—device id;
if there is already data posted, then add/replace or delete the data based on the action sent with each data item;
if there is no data, then create a new queue for this account id—device id and add the data to it;
expire any data on the queue as necessary;
save data back to data store;
for every data item that is added, generate a new sequence id for that data item and store it; and
if the API call fails before it ever gets to this service then the lost message will not be recorded. One solution is for the API itself to store the sequence id in the database so that it such misses will be captured.

The storing of sequence ids in the database is necessary since the API is bound to stateless servers go through each of the data items and get the smallest max delay value and add it to the current time if the stored schedule time is greater then the above value then send schedule request to the scheduler

When the push service request handler 2004 receives a data item that triggers a schedule update, it sends a request to the Push Service scheduler 2006 to schedule a message to be sent. The Push Service scheduler 2006 is a server that exposes a single resource via a RESTful url. The RESTful body, for example, may be [{“blurAcctId”:“ . . . ”, “providers”:[“facebook”, “myspace”, . . . ]}, . . . ]. Preferably there will be only one of these schedulers per cloud, but there may be more. The Push Service scheduler 2006 is preferably a dedicated server, however, in other embodiments the Push Service scheduler 2006 may be part of another server. The Push Service scheduler 2006 keeps all of its schedules in an internal memory (not shown). The Push Service scheduler 2006 can use HTTP 1.1 persistent connections along with a binary protocol to ensure optimum throughput. In one embodiment, when a new schedule request is made, the Push Service scheduler 2006 may deserialize the schedule (the schedule contains only an account_id, device_id and schedule time) and place the schedule on the scheduling queue.

In a background processing thread, the scheduling queue is waited on and at the appropriate moment a web service call is made to the push service xmpp message generator 2008 to generate the XMPP message.

The Push Service XMPP Message Generator 2008 creates XMPP messages in response to requests from the Push Service Scheduler 2006. In one embodiment, for each request, the Push Service XMPP Message Generator 2008 may get the account_id and device id from the request, find all data associated with the account id and device id in the data store and retrieve the data and delete it from the data store. The Push Service XMPP Message Generator 2008 may package the data into an XMPP message element and send the XMPP message is sent to the XMPP Server 2012.

The account setup process for a client device (e.g., mobile device 1802 of FIG. a8) can make a call to the XMPP server 2012 to create an XMPP account. Alternatively, in order to get rid of this extra call and to facilitate authentication, a component can be used for the XMPP server 2012 which will utilize the aggregation-services authentication architecture (e.g., the core services processor 1818 to both validate and retrieve information about a particular account.

During device setup, a user can create a new account (an aggregation services account) which can advantageously be associated with a specific device. The data associated with this action will be stored in the accounts database in whatever way the accounts service decides to store it. The XMPP server 2012 may have a component which acts as a packet filter attached to the XMPP server. When the component receives an authentication request it gets the appropriate auth tokens from the request The component then uses those tokens to make a web service call to the accounts application to authenticate the user. The component then sends a signal indicating user authentication success or failure to the XMPP server 2012.

A secondary component may also be attached to the XMPP server 2012 which can also acts as a packet filter. This secondary component will look for presence packets instead of authentication packets. Since all XMPP clients send out a presence packet in order to receive messages, any XMPP client successfully attached to the web server (e.g., web server 1804 in FIG. 18) will send an XMPP presence packet. This secondary component can detect presence packets and let the Push Service Request Handler 2004 know when a client was connected or not connected. This enables the Push Service Request Handler 2004 to tell the Push Service Scheduler 2006 whether or not it needed to handle scheduling for a particular client or not.

The push channel is a best effort service that provides timely notifications to the device 1802. The push channel may not ensure that all data sent down the channel reaches the device 1802. In fact, the requirement is that the device be able to operate even when the push channel is not activated. There are a few use cases that support this requirement. First, there are times when the device will not be able to activate the push channel due to spotty coverage. In such instances it may be most optimal to manually synchronize the data without activating the push channel. Also, since the push channel is an always on connection, if a phone goes into roaming mode the service may want to turn off the push channel. Thus, the main responsibility of the push service is to provide timely notifications and provide a means of detecting that pushes were missed to the device.

The push service sends notifications as opaque, application specific, discrete data to the device 1802. Each piece of data is marked with a sequence id that starts from zero and which rolls over back to zero after a threshold is reached, for example, 2\hat{0}31. In one embodiment, the sequence id may be generated as follows. The Core-service server 1828 detects that a push is necessary and prepares for the data to be pushed to device 1802. The Core-service server 1818 then calls the Push API, which can be controlled by push server 1830, with the prepared data. The Push API then retrieves the account_id/device_id. The Push API uses the account_id/device_id to lookup the next sequence id from a persistent store. The Push API then marks the data with the sequence id and sends the data to the Push Request Handler. The Push API then returns a SUCCESS message back to the Core-service, for example, core service server 1828. The Core-service server 1828 receives the SUCCES message and considers the message to be sent.

If the Push API fails to retrieve a sequence id, the Push API throws an exception and the push message is never sent. When this occurs, the Push API could store a history of the event and when the sequencing mechanism returns to working order, it could then reset the sequence based upon the stored history.

If the Push API is unable to send the push to the Push Request Handler, the Push API may throw a different exception. When this occurs, because the sequence id has already been incremented in the persistent store, the next push will receive the next sequence id and if the next push happens to make it to the device 1802, the device 1802 will now be out of order. Alternatively, if the Push Request Handler crashes before it sends the request to the Scheduler and the push message is never sent, gaps in the sequence can occur. In these situations, the device 1802 may request a full synch.

The aggregate server 1804 may provide a unified feed to the client device 1802. When multiple feeds are requested by the user device 1802 to be sent from the intermediate web server 1804, the unified feed can be employed to provide all of the feed data. The unified feed contains one or more feeds of various feed types. The goal of the unified feed is to allow a client to get all its feeds with a single request instead of making a separate request to get friend feed data, News feed data, and other data. The feeds may be, for example, a friend feed which may include updates about a user's friend available from social networking sites such as Facebook™, MySpace™, Twitter™, LinkedIn™ The feeds may also be a news feed including, for example, news information available from RSS feeds which may be from a variety of sources, Yahoo™ News, Digg™, etc. Alternatively, the feed may be a weather feed, which may include weather information from sources such as Yahoo™ Weather, or an admin feed, which may include service status information.

As discussed above, feeds can be gathered from a variety of sources by the aggregation server 1804, such as from the respective plug-ins 1824 for Facebook™ or the News feed. The feeds can be posted per user, to the web services server 1828. Feed specific web services post the feeds in a common feed format, to a feed mill. When the feed mill receives feeds, it sends a low priority notification to the push manager as discussed above. Feeds accumulate in the feed mill and after some time or event, the push manager sends a push to the client. For example, the client 1802 can make a single request to get all its feeds.

In one embodiment, two protocols can be employed by the aggregate server 1804 to provide the unified feeds feature. The first protocol defines how the feed specific web services (such as the Friend Feed web service, the News Feed web service, etc.) will interact with the feed mill web service. When a feed specific web service has feed data to send to the feed mill web service, it makes an HTTP POST method request, using a relative request URI such as /ws/feedmill/0/feedGrain/accountlD Included in the request body will be the feed data already in the common feed format along with the feed type. The server will respond with an HTTP status code.

The second protocol defines how the feed mill will interact with the client 1802. When the client 1802 requests its feeds from the feed mill, it makes a simple web services call which contains the sequence numbers for each feed type processed by the client. The server response will contain all the feed data.

The “Unified Feed” is described with respect to “Feed Mill” terminology. Feed data sent to the feed mill web service will be sent using a common feed format. This is so that arbitrary data from various sources can be handled in a consistent manner. Below is the common and uncommon data that the server can expect to receive.

Common Data can includes a provider, an account id, body type, a category, an ID, a link, a summary, a post time a title, an action and/or geotags. The provider of the feed is found in Friend Feed, News Feed Weather Feed and Admin Feed. The account ID can be the aggregation service Account ID. A Friend Feed can also include an Account ID. The Friend Feeds may include a body and body type, News Feeds and weather feeds include atomContent. Admin feeds can also include a body and body type. One or more categories, as defined by the Aggregation Services. Friend Feed and Admin Feed include type and subtype. The feel can include one or more links. Friend Feed can include one or more URL, streamURL or links to media items. News Feed and Weather Feed can include atomLink. Admin Feeds can also include URL. The News Feed and Weather Feed can include atomSummary. Admin Feed can include a summary. The feeds may include the time each item is posted. The feeds can also include a title and a title type for the feed or the data in the feed. News Feed and Weather Feed can include atomTitle. The feeds may also include one or more actions that can be performed and geographical identification meta data.

The feeds may also include uncommon data types, such as an externalID, the provider-side user ID of the user is found in Friend Feed, a contactID, anaggregation services ID may be found in Friend Feed and an externalContactID, the content provider website ID of contact is found in Friend Feed.

An exemplary interaction between a client 1802 and a aggregate server 1804 is discussed below using the following terminology:
Feed Type—A specific type of feed (ie. news, friend, admin, weather . . . );
Feed Grain—A specific entry in a given feed type. As an example, for a news feed, a feed grain could be an individual news item. The actual data contained within each type of feed is dependent on the type of feed, although they will all be in the same format (see Lien). Each feed grain is treated as an opaque string to the feed mill;
Feed Pellet—A collection of a specific type of feed grains;
Feed Bag—the data send from the server to the client, composed of one or more pellets;
Feed Trough—Component on the client that deals with handing out feed pellets sent from the server;
Feed Mill—component on the server that deals with gathering feed pellets from multiple sources and packages them up in a feed bag to be sent to the client; and
Feed Silo—Component on the server that stores feed grains until requested by the device. Basically it wraps a DB table underneath.

An Application on the client 1802 wishing to consume a given feed type will first register with the feed trough. This registration will simply involve indicating which feed type a given application is interested in consuming and the method, such as an Android™ intent, that should be used to notify the application when new data is present. A given application may be permitted to be registered for many feed types. When the device 1802 is an Android™ device, when a feed pellet is received on the client an Android intent will be sent to all registered applications containing the feed type of data included in this intent, the actual feed pellet sent from the server (the registered applications often have a way of parsing this data), the sequence number for this feed pellet, and an application secret shared between the feed trough and the application (set at registration time) so that the application can verify this intent came from the feed trough.

The feed trough will also provide a way for applications to unregister themselves for a given feed type. The feed trough can also provide a mechanism in which applications can inform it of the last sequence number for a given feed type they have finished processing. This information will be used in communications with the feed mill to indicate the last feed pellet the client has so the feed mill can determine which data it needs to send the client. If multiple applications are registered for a given feed type then the minimum sequence number will be kept and sent to the feed mill.

The feed trough fetches data from the feed mill in response to being told by the push manager that data is waiting for it on the server. Potentially a mechanism will also exist by which the user could initiate the fetching of feeds manually, if they deem it necessary. Only one fetch request from the feed trough will be permitted at once, and in the event another is requested while one is in process the second will fail (with an appropriate error code).

There can be one web services call the feed trough will make to fetch it's feeds. For example, can be of the following HTTP GET form (minus any auth/login data that needs to be sent), /ws/feedmill/0/feedMe/accountID?news=X&admin=Y&friend=Z where accountID is the user's account ID and X, Y, and Z are the last sequence numbers the client has processed for the feed types news, admin and friend respectively. Only feed types the device is setup for (via some external setup mechanism) will be specified in the above line. Dealing with the error cases from this call (userNotAllowed, userNotFound, systemBusy, etc.) may be indicated to the user. In the case that the system is busy the server can back off using some interval which has been configured (potentially via an admin/config feed).

Since the processing of the actual feed pellet is done in the application process, and could potentially be time consuming, a feed trough fetch request could end up receiving the same data since the sequence numbers might not have had a chance to be updated. This occurrence should be infrequent but could be caused by a user initiated feed trough fetch immediately after completion of a push manager feed trough fetch, if many pushes are sent from the server in rapid succession indicating that there is feed data available for the client, the device crashes immediately after partially/completely receiving the feed bag or in permitting multiple applications to be registered for the same feed type, a rogue application could never update it's sequence number (or update to a bogus value).

Since the sequence number applies to the entire feed pellet, which may contain numerous feed grains, the registered applications will have to tell the feed trough that they have processed the entire feed pellet even if in reality they only care about a subset of the feed grains. In essence the processing of a given feed pellet is all or nothing, no finer granularity is offered. Failure to update the feed trough with the sequence number will result in permitting multiple applications to be registered for the same feed type.

As mentioned above, the client request takes the form of a simple web services call which contains the sequence numbers for each feed type processed by the client.

The server response to the client request contains the actual feed bag which will be described below.

A feed bag header (FBH) may have several elements, for example, a version, a content type (e.g., DATA or ERROR) or a number of feed pellets contained (only for DATA case) or error codes in the case of an ERROR type. Each feed pellet can also contain a header (FPH) which contains a feed type, a length of feed pellet and a sequence number of feed pellet. In one embodiment, a feed bag may looks as follows: (FBH)(FPH)(Feed Pellet Data)(FPH)(Feed Pellet Data)(FPH)(Feed Pellet Data) . . . An the error case, for example, may simply contain an (FBH).

The feed mill will have to deal with requests coming in from two different locations, (1) the device asking for it's feeds, as discussed above, and (2) the app processors providing specific feed type feed grains for a given user. The app processors can provide feed grains to the feed mill via a HTTP POST call, which in one embodiment may look as follows: /ws/feedmill/0/feedGrain/accountID, where the actual feed grain (in the common format) and feed type will be included in the request body. The feed mill responds with an appropriate HTTP status code. After each successful feed grain addition a low priority notification is sent to the push manager indicating that feed data is available for the client. Each user will have a feed silo which will contain all the feed grains waiting to be delivered to the device. The table can advantageously include a column for a feed type, a sequence number (unsigned int (a monotonically increasing value), and a feed grant data (string array (perhaps of a max size)).

Each row in the table may correspond to a feed grain added via the HTTP POST call above. To limit the number of entries in a user's feed table there can be a configurable maximum number of rows per feed type. What happens when this limit is hit will fall into 2 categories:
1. Aging is allowed—In this case when a processor attempts to add a feed grain for a feed type that is already at the limit the oldest feed grain is removed.
2. Aging is not allowed—In this case the addition actually fails and an error is sent back (via a HTTP status code) to the app processor.

After the feed grains are stored, the feed mill acts to provide information in response to a feed trough's request (poll) for it's feeds (information). The feed mill gets the request for a specific user's feeds, queries the user's feed silo for all feeds, taking into account the sequence numbers the request specifies, constructs a feed bag and sends it to the device and removes old feed grains (based on the request sequence numbers) from the user's feed silo.

Since each feed type feed grain is a row in the user's feed table there are multiple database calls needed to actually add the feed grain. In one embodiment, for example, the feed mill may get the number of rows currently used by this feed type. If the number of rows is greater than a maximum number of rows and if aging is allowed, remove the oldest entry. If aging not allowed, the feed mill may return an error. The feed mill may then add feed grain to table.

No locking may be required on the feed table. This is because each row is independent and the process of getting all the feeds at a given point in time shouldn't conflict with adding of new rows since the two operations don't affect the same set.

A batch mechanism exist may be used to add the same feed grain to multiple users (i.e., tell all Twitter™ users the site is down). To accommodate the batch mechanism another HTTP POST web service call can be employed which will, in one embodiment, may take the form of “/ws/feedmill/0/feedGrainForMany,” where the actual feed grain along with a list of users will be included in the request body. The exact format of the user list will depend on the interaction between the master users table and the feed mill.

The aggregation service client application, for example an application loaded on the client device 1802, can use two separate content providers, with different levels of security, to access contact data. The aggregation services's contact design may be constructed with some important goals in mind:
Contact storage on the device should conform to the standards for the client device 1802 (e.g., Android™ standards when using an Android™ device).
Contact data should be kept in sync with the network services Contact Data.
Each contact should be presented to the user as a single individual, since that is how the user thinks of the contact.

Many contacts will be obtained directly from email servers or social network websites 1806-1808. Some of these networks have terms of service which prohibit access by third-party applications to their contact data. For this reason, contacts from social networks (hereafter referred to as friends) will be kept in a separate database in the client 1802. This restriction, combined with the goal to present merged individuals, presents technical challenges, as the contact records being merged in the UI must be gathered from separate databases. Hereafter this document uses these terms:
Contacts—Refers to people stored in the standard Android database.
Friends—Refers to people stored in the private social networking database.
All Contacts—Refers to the union of contacts and friends.
Merged Contacts—Refers to the intersection of contacts and friends

On the device, contacts are stored in a database that is shared by all applications. The aggregation service extends standard contacts to add additional data and capabilities. Aggregation Services client contacts will be a superset of standard contacts; third-party applications will be able to access contacts using the standard API.

In addition to the extended contacts database, the aggregation services contact introduces a parallel database for social networking friends. This database has additional security to prevent access by third-party applications. In most ways, the schema and behavior of the database is the same as for contacts, although there are a few differences; groups are not supported in friends. If the user adds a friend to a group, aggregation services automatically creates a contact with a copy of the friend's data, and adds the contact to the group. Also, to allow for identities merged across contacts and friends, the friends database contains references to contact identities.

Users may configure a device 1802 to use information from a variety of providers 1806-1808. This information may include email, contacts, photos, and social networking events. Examples of common contact providers are Google™, Yahoo™, and Facebook™. Users may also import data from ActiveSync to get email contacts, for example, or from their previous phone via a subscriber identity module (SIM) card or a cabled connection. Providers may be added when initially configuring the device, or at any time thereafter, by accessing set-up. Additionally, carriers may provider may provide contacts from the carrier 1820 directly to the plug-in 1824 whereby contacts can be downloaded to the device via the server front end portion.

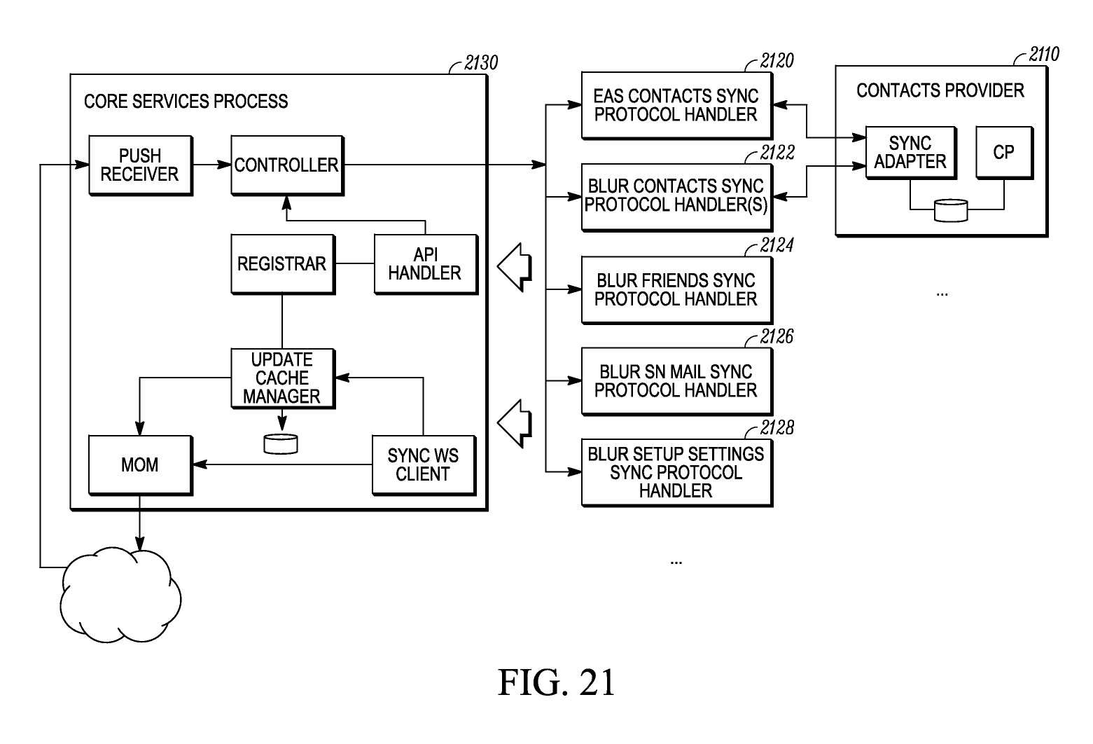

FIG. 21 illustrates an exemplary method for importing contacts in accordance with one embodiment. Each contact imported from a content provider 2110 is stored as a separate contact record. Contacts that refer to the same individual are shown as one individual in the user interface (“UI”), but the records are still kept separate in the database.

Aggregation services will support multiple sync adapters 2220-2128 in communication with a core services processor 2130. This includes Google's default sync adapter for gmail™ contacts, an Address Book adaptor, and adapters written for the aggregation services, including Exchange ActiveSync (EAS), social networking contacts, and contacts synced to the aggregation service. Each of these sync adapters must identify contacts they sync onto the device as their own, so that changes to a contact are only synced back to the original source. For adapters written for aggregation services, a new column in the contacts database is used to identify the sync source. Contacts without a value for this column are assumed to belong to Google™ or another third party.

One of the contact sources will be identified as the default address book, to which contacts created on the device are added. Alternatively, the default contact source could be the Aggregation service's contacts. The user may be able to choose which address book is the default, and which address book should be used for a particular contact

While contacts from different providers are stored as separate contact records, regardless of whether they actually refer to the same individual, the UI always attempts to present contacts to the user as individuals.

A new “identity” table may be created in the same database as the clients contacts. There is one row in the table for each individual. A new column can be added to the “people” table indicating which individual the contact record belongs to. The identity table may not be synced with the aggregation server 1804. It is created dynamically on the client device 1802 as contacts are added. The exception is that the user may manually merge or un-merge contact records. These manual changes to identities should be preserved, and so are synced with the aggregation server 1804.

When contacts are added on the client device 1802, they are matched with other contact records to determine if they refer to the same individual. If there is no match, a new row is added to the identity table. The identity column in the people table is updated to point to the identity row.

New content URLs within the contact authority may be available to access identities rather than people. Many aggregation service code will use these URLs to access contacts.

The identity table includes columns to store the most recent social networking status update from the person. This data can be displayed on an “identity badge” widget which appears throughout the product, including various contact screens, home screen loop cards, and message addressing.

All user interface views or edits of a contact will actually operate on a set of contact records that aggregation services believes are the same person. The set of contact records is taken from the identity table.

Any merging strategy contains the danger of generating two types of errors: over-merging (i.e. presenting separate individuals as one person) and under-merging (i.e. presenting one individual as separate people). It is envisioned that the aggregation services server will err on the side of over-merging, for these reasons:
It is easier to solve one category of error than it is to solve both.
It is more likely that a single individual will be stored in multiple providers than it is that two individuals will reasonably appear to be the same person.
If Aggregation services over-merges, it is easy for the user to identify data that actually belongs to a different person.
If Aggregation services under-merges, it would appear to the user as “missing” data. This would be upsetting to the user, and finding the other contact record that should have been merged would be difficult.

The user can decide when aggregation services has over- or under-merged contacts. This is done from the “Sources” section of the contacts details activity.

Contacts are merged by Aggregation services when one of the following is true: the records have exactly the same name, the records share a phone number and one of the records identifies the number as either mobile or work, the records share an email address unless both of the records identify it as a home email and both records have been identified as the owner of the phone.

Records may not be merged if they were synced from the same source (e.g., two Facebook™ friends with the same name will NOT be merged). Note that when contacts are created on the client device 1802, copies of the contact are created for each writable source. Thus two contacts created on the phone with the same name will likely merge together, since the aggregation services version of the first will merge with the version of the second.

In the contacts application, the user can create groups or import them from a service provider. The user will use these groups to filter the set of contacts he views as well as to communicate with them (email/sms).

Because the group membership table contains references to the table of contacts, social networking friends cannot technically be members of groups. The aggregation services gets around this problem by creating a dummy contact record when the user adds a friend to a group. None of the contact's data (phones or addresses) are added to the dummy record.

A person can belong to more than one group. When creating a new group and assigning a member, the user has the option of which email or phone to use for the member when contacting this group. For example, the group may be contacted using a respective primary phone or email. This may be the default method of contacting the group. Alternatively, the group may be contacted using a different email and/or phone or all emails and/or phone numbers.

When modifying the group, a user can change the members of the group. In addition, though, a user may also change the contact methods that will be used for each member when contacting that group. Groups may be filtered, for example, in a “View contacts” screen, where a user can, for example, filter the set of contacts by group via a pull-down.

A user can email or sms a group. In one embodiment, the user does this via a menu option from the “View contacts” screen. In the email application, a user may choose a group as a recipient of an email. When picking the group, the user can temporarily override the email addresses that will be used for each member. If the user does not override, the default email specified by the user for each member will be used. More likely though, the primary email will be used since most users will not specify an explicit email address for each member of the group.

When sending the email to a group (or perhaps when choosing a group to email to), the UI will indicate whether each member of the group possesses an email and will be able to receive it.

A table may be added to the contacts database to keep track of the most recent communication the owner has had with each contact, using each mode of communication. In the contacts application, the recent tab of the list view mentions the most recent communication using any mode of communication. A history tab of the contacts details view lists the most recent activity on all of the contacts communication methods.

| | | | | | | Social |
|---|---|---|---|---|---|---|
| Column | Call Log | Friend Feed | SMS | MMS | Email | Message |
| | CallLog | FriendFeed | Telephony | Telephony | Email | SNMessaging |
| | .Calls | .Items | .Sms | .Mms | .Message | .SN*Columns |
| recent_kind | R_K_PHONE | R_K_SOCIAL | R_K_SMS | R_K_MMS | R_K_EMAIL | R_K_SN_MSG |
| recent_type | TYPE | 0 | SMS_TYPE_PHONE | SMS_TYPE_PHONE | 0 | 0 |
| | | | or _EMAIL | or _EMAIL | | |
| person | search | FRIEND_ID | PERSON_ID | search | search | FRIEND_ID |
| recent_friend | search | TRUE | search | search | search | TRUE |
| account_id | search | 0 | search | search | search | ACCOUNT_ID |
| item_id | _ID | _ID | _ID | _ID | _ID | _ID |
| icon_uri | null | PROVIDER | null | null | null | find provider |
| | | | | | | from account |
| event_time | DATE | PUB_DATE | DATE | DATE | DATE_SENT | DATE_SENT |
| subject | null | TITLE | SUBJECT | SUBJECT | SUBJECT | SUBJECT |
| body | NUMBER | CONTENT | BODY | null | PREVIEW | BODY |
| title | NUMBER | null | ADDRESS | FROM | FROM | null |

When a contact is created on the device 1802 (or the Aggregation services service 1804) it is by default added to all writable provider groups. The user may choose not to include one of these groups, thus not syncing the new contact to that service. Read-only provider groups are not offered. This section is called “Providers”. The term “read-only contact” means a contact record that belongs to a read-only provider group. Such record may never be modified, including their group membership. Other contacts are termed “writable”.

Other contact groups are also offered to the user, but these are not selected by default. This section can be called “Groups”. New fields are added to all writable contact records. Fields belonging only to read-only contacts are not editable. Fields that are found in at least one writable contact are editable. Whenever a field is edited, that field data is written to all writable contact records, even if the record did not previously contain the field. Essentially, this slowly propagates contact information among the user's providers. If a field that belonged to both read-only and writable contacts is modified, then both old and new values of the field will now be displayed. The old value will no longer be editable.

Fields that belonged to read-only contacts may not be deleted. Fields that belonged to writable contacts disappear when deleted. Fields that belonged to both read-only and writable contacts may be deleted, but would only be removed from the writable contacts. The field would thus still appear in the details, but would not be read-only.

When the user deletes a contact, a confirmation dialog asks whether the contact should also be deleted from all of the writable providers to which the contact belongs. If the answer is yes, all writable contact records are deleted. If the contact also belongs to read-only providers, then the dialog warns that the contact may not be deleted from that provider.

Contacts added to a provider website generate new contact records, just as during the import process. Changes made on the provider are reflected in the corresponding contact record in Aggregation services. When a contact is deleted on a provider, it has the effect of removing the corresponding contact record from that provider group. It does NOT delete the contact from Aggregation services's contacts. Contacts imported from one provider may be added to other providers in Aggregation services's UI. This has the effect of copying the contact from one provider to another—a feature not easily accomplished through the providers themselves. Removing a contact from a provider group deletes that contact from the provider's address book. If a user decides not to sync with a provider any more, they are asked whether to remove all contact records imported from that provider.

On the device 1802, the push service will receive push data notifications. It will look at the sequence number for every data item and check to see if any have come out of sequence. If it detects such a scenario, it will broadcast an intent indicating the occurrence of such an event. The Intent receivers may be required to decide what they want to do. The push service will not discard any data even in the event of an out of sequence situation. It will continue to fire intents for all data items it detects.

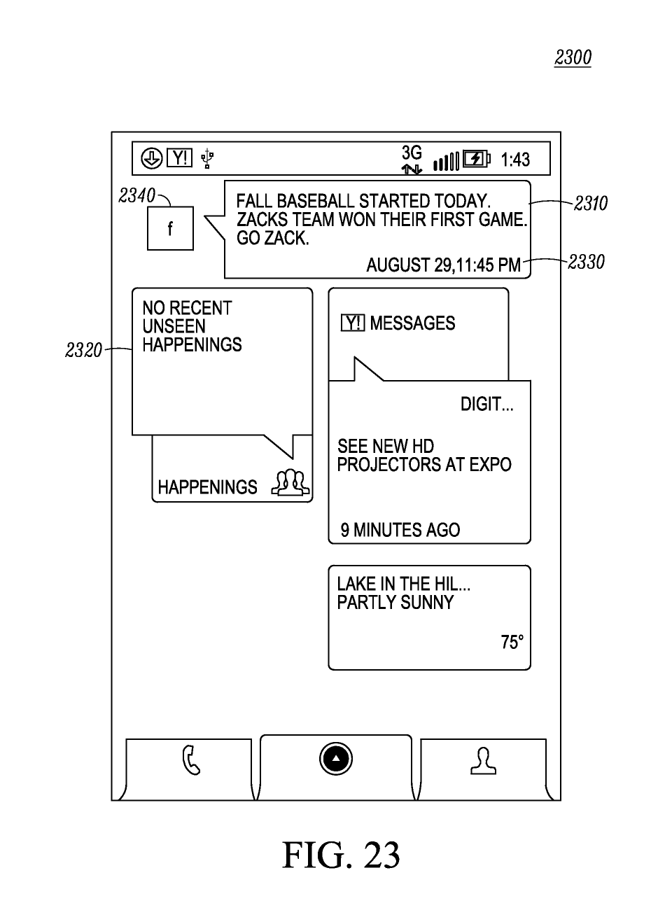

An exemplary portion of the user interface is illustrated in FIGS. 23-30. The social networking status resides on the home screen 2300. It allows the user to view their most recently updated statuses 2310 on the phone or social networking sites, as well as providing a means to push status updates to social networking sites. It is a core part of the social networking experience. Status updates are included in a number of social networking services, including Facebook™, MySpace™, and Twitter™ (where it is known as a tweet). Users use status updates to communicate to their friends what they are doing, where they are going, or any other “micro-blogging” thoughts.

The user has the ability to update their social networking status from the home screen (FIG. 23) of the user device 1802 or 1803. In order to update their own status, the user clicks on the current status 2310 and a text field will be presented by which the user can enter changes.

The home screen status 2310 will display the most recent status updated on a social networking website that has been linked to the user's aggregation service account (e.g., Facebook in the illustrated screen). If the user interface does not have a status displayed on the home screen 2300, the space may be filled by text indicating that tapping the area will allow the user to enter a status. The status 2310 will be pushed to one or more user selected social networks that the user belongs to. For example, upon selecting to enter a status 2310, the user interface will present the user with a pull-down menu from which the content provider website where the action will be sent can be selected. The user can select one or more of the content provider websites.

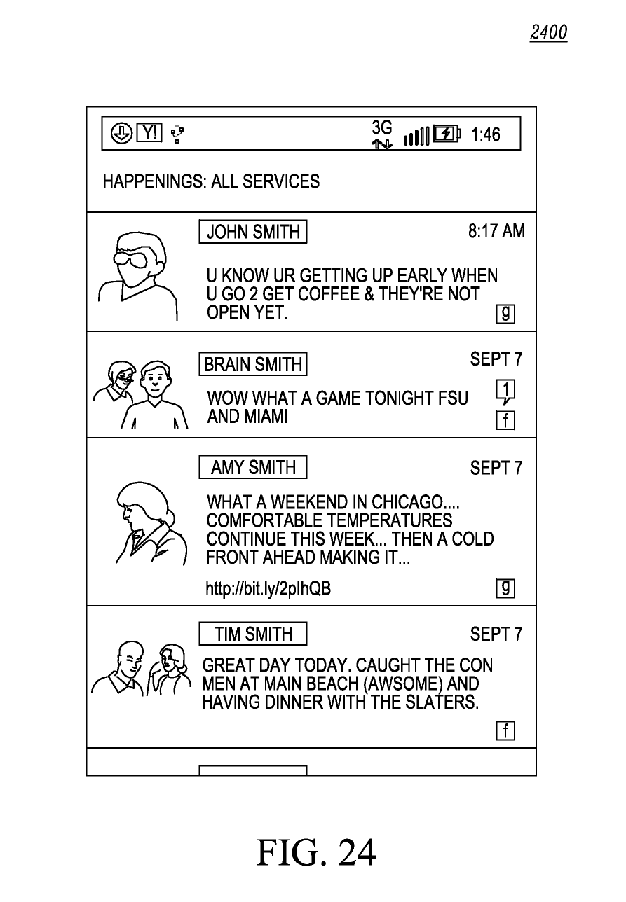

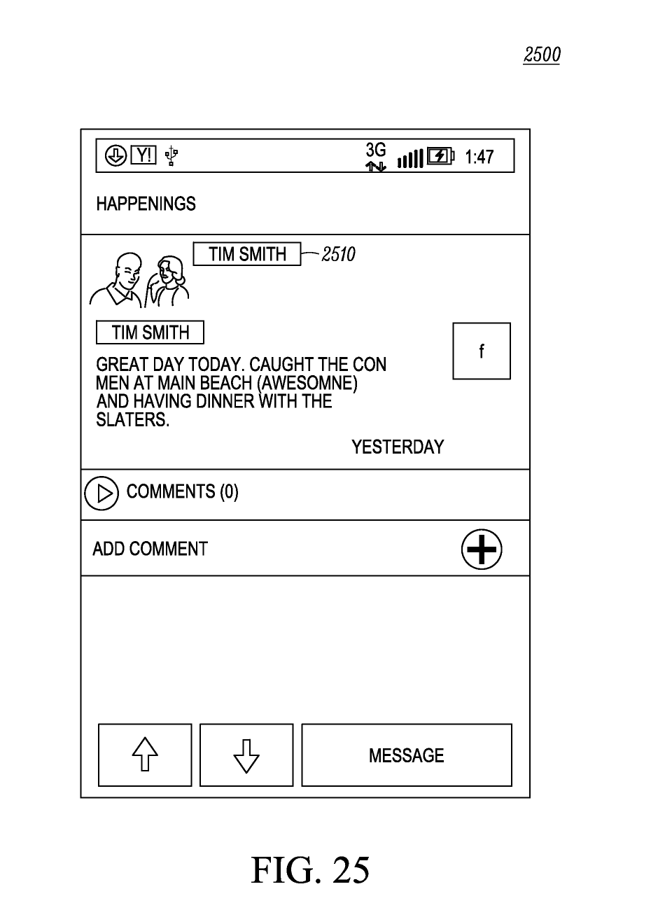

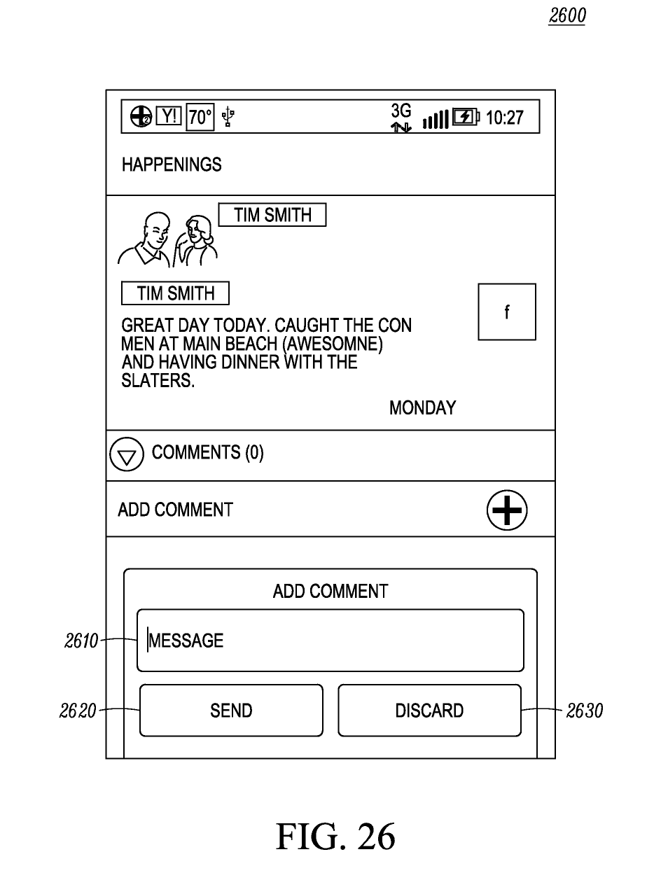

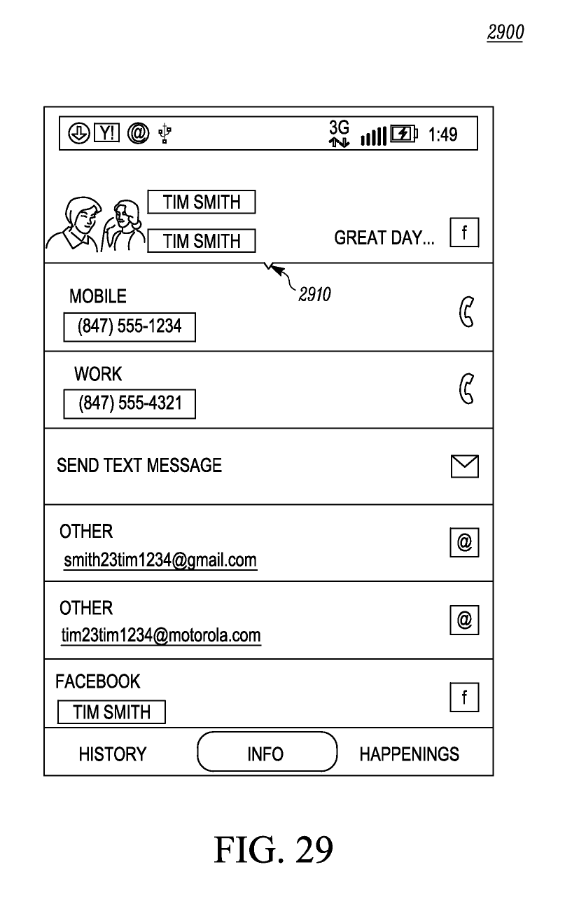

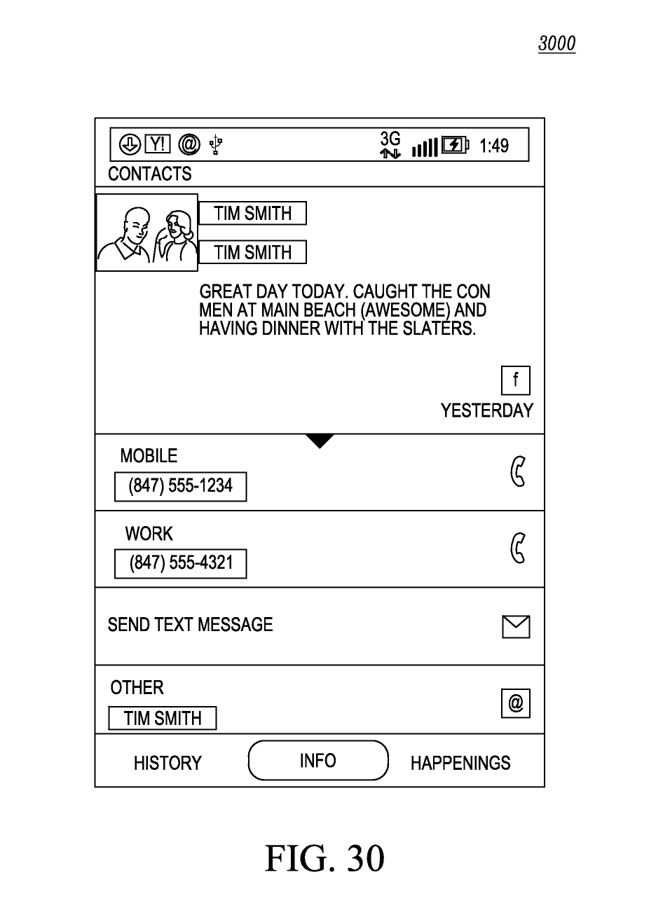

The most recent status of friends 2320 may also be displayed in the home screen, under the exemplary headline “happenings.” FIG. 24 illustrates an exemplary happening screen 2400 if a user clicked on the happenings headline 2320 in FIG. 23. As seen in FIG. 24, the happening screen 2400 includes several status updates from an account the user is following. FIG. 25 illustrates an exemplary screen 2500 after a user selects one of the status updates illustrated in FIG. 24. As seen in FIG. 25, the user is presented with the option of adding a comment to the status update. FIG. 26 illustrates an exemplary screen 2600 after the user has selected to add a comment to the status update illustrated in FIG. 25. As seen in FIG. 26, an area 2610 is provided for the user to enter a comment. The screen 2600 may also provide a send button 2620 to send the comment and a discard button 2630 to discard/cancel the comment. In one embodiment, if the user selects the name 2510 of the friend as illustrated in FIG. 25, the contact information for the selected friend, if available, may be brought up on the screen. FIG. 29 illustrates the friends contact information after the friends name was selected. As seen in FIG. 29, the users mobile and work numbers, multiple email addresses and the friends accounts on the various content providing servers 1806-1808 may be viewable by the user. If the user selects the down arrow 2910 on FIG. 29, the friends current status 3010 on one of the content providing servers 1806-1808 may brought up on the mobile device 1802, as illustrated in FIG. 30.

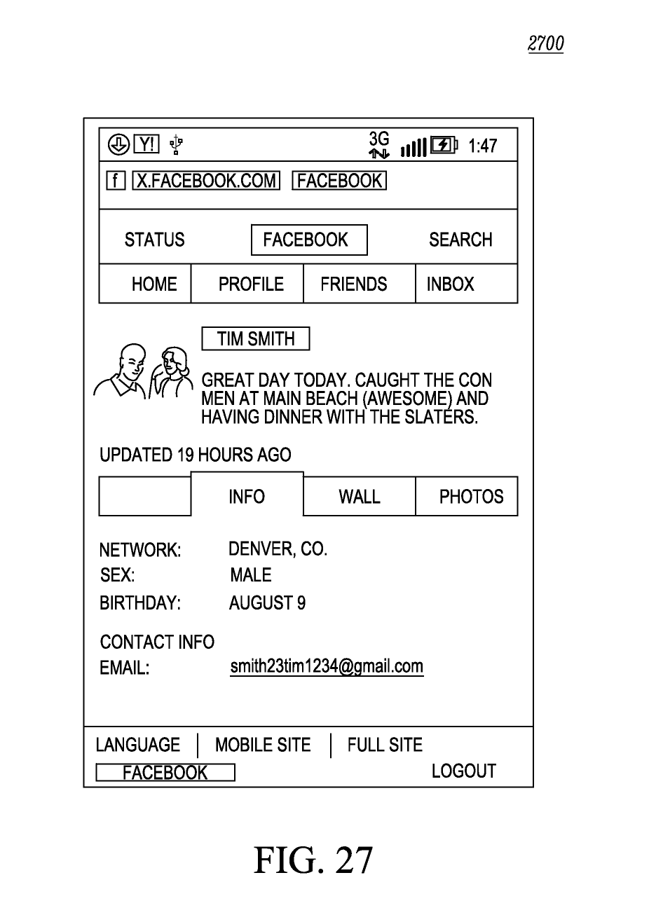

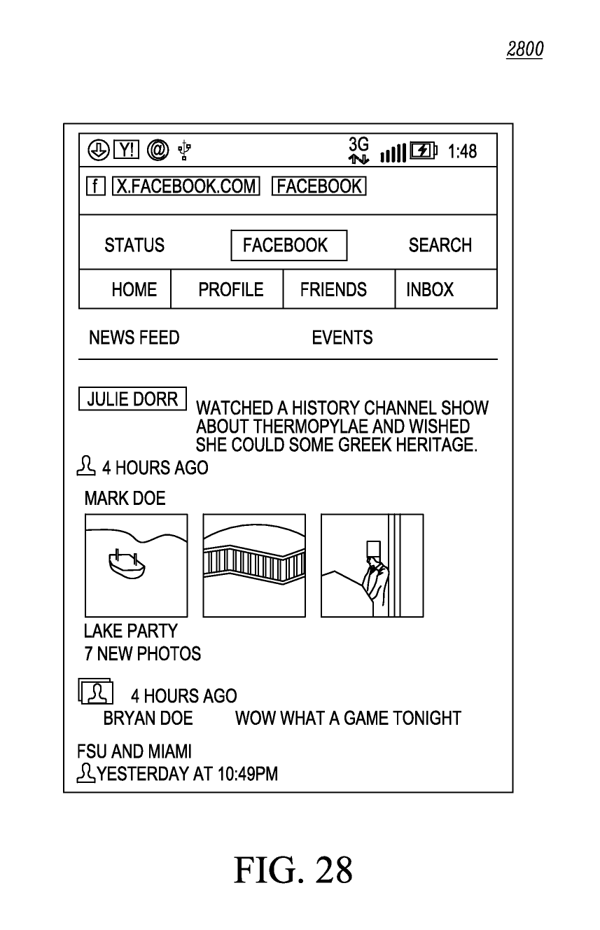

As discussed above, a user of the device 1802 may connect directly to one of the web content providers 1806-1808. FIG. 27 illustrates an exemplary screen 2700 after a user has selected the friend illustrated in FIG. 25. As seen in FIG. 27, after selecting the friend “Tim” in FIG. 25, the client device 1802 is taken directly to the friends account which, in this exemplary embodiment, is Tim's Facebook™ page. FIG. 28 illustrates another screen 2800 where a direct connection to one of the web content providers has occurred. As seen in FIG. 23, the screen 2300 may include a visual indication (logo) 2340 of each of the services next to the appropriate boxes to indicate which service that status is for. Accordingly, if a user selects the logo 2340, the user may be taken directly to the corresponding service, as seen in FIG. 28.

Status updates should arrive on the device in a timely manner. For example, they should arrive on the device screen in less than 15 minutes of being set by the device 90+% of the time. In other words, the user sets their status on the device 1802 user interface, it is updated on content provider website 1806, and returns to the device 1802 after being updated by the aggregation service in less than 15 minutes. It is envisioned that the status will preferably be updated in less than 5 minutes while the user is active on the device 1802.

Cleared statuses set from a website 1806-1808 (e.g., Facebook™ MySpace™) may not be reflected on the home screen. The home screen 2300 will just reflect the most recently set status from each service. MySpace™ has an existing functionality that if a user sets both mood and status to null, the status is automatically set to “is in your extended network.” Since this is the way MySpace™ has their APIs working and MySpace users are used to it, this functionality will continue to occur when a null status and mood is set from the service online or from the device.

For MySpace™ status updates (most recent update is from MySpace™ website or most recent update from the device was a MySpace™ only update), a “mood” is supported and displayed at the same time as the status. The home page user interface (UI) 2300 also preferably includes the date and time of the last status update 2330.

If a user has not linked a social networking account to their aggregation service account, the social network status area will not appear. It is envisioned that the home screen chips will realign, centered vertically to occupy part of the space left by the absence of the SN status.

As discussed above, a user may select or click on the status 2310 to update the status brings the user to the status update user interface. The UI includes the list of all of their current statuses on all of the social networks that the user has linked to their Web server 1804 aggregation service account. There may also be a visual indication (logo) 2340 of each of the services next to the appropriate boxes to indicate which service that status is for. The UI space for entering the new status may be pre-populated with “is . . . ” which can be erased by backspacing.

When one service, such as MySpace™ is the only service selected, the status and mood are both pre-populated with the user's current status and mood on MySpace™. This allows for a user to update just status or mood without accidentally clearing either. Each service can be updated separately by changing the status text of each individual social networking site (one at a time). When updating MySpace™ only, the UI also supports the selection of mood. Selecting a mood allows a user to enter text to jump to a certain point in the mood list (not filter) and allows the user to scroll through the list.

The user may have the option to select “All” to update all services at once. Updating the status and selecting “All” services replaces all the below services with the new status update. The status is pushed to all the social networks that the user has linked to their Web server 104 aggregation service account. When updating “All” services includes MySpace, mood is not an option to update for MySpace and the mood is set to no mood.

If a user only has one service linked to their Web server 1804 aggregation service account that supports status, there is no drop down menu and no option for “All.” The only service link is simply listed as the destination service. In one embodiment, the status on the home screen is the most recently update status, whether it came from the mobile device or a social networking service. The status on the home screen should have some icon 2340 next to it that identifies where that status update originated from (ex. mobile device, Facebook, Twitter, etc.) In one embodiment, the User can click on the Content Provider Icon 2340 in the screen 2300 and jump to direct access to the Content provider.

Sending a blank status can clear the status from the particular service selected, or all services if selected (note, Twitter has no notion of clear status, so the previous status will remain intact). The application's last screen/condition will be stored during other activities on the phone and the user will return to this last screen upon completing any activity that interrupted the user's activity in the SN Status Update utility (for example following received a phone call).

One reaction supported in the Happenings application is to respond to Twitter items with an @Reply. This will result in a new “me” status being sent to the core service, and will be reflected on the home screen, and in the Twitter line of the list of statuses (if a user has a Twitter account supported).

When a status is sent to Web server 1804 aggregation service services, the status may be sent in a “fire and forget” method, meaning that no confirmation will be sent to the user that the action went through to the social networking service (although as per UI, a toast confirmation that the reaction has been sent off from the device is shown). Status updates will only be able to be posted if their characters do not exceed the maximum characters allowed. The length of status updates allowed is dependent on the service to which the status is being uploaded. For example, Facebook™ currently allows 160 characters , MySpace™ currently allows 160 characters and Twitter™ currently allows 140 characters. if “All Services” is selected, the least common denominator shall be the limiter (ex. if Twitter™ is included, max is 140).

A counter may be displayed counting down when 30 characters or less are allowed. The counter can display negative numbers when the maximum number of characters is exceeded. If a user switches mode of post (example, changes from Twitter to Facebook™), the counter can be adjusted accordingly (or disappear if a user now has over 30 characters left to type).

If a user selects “Post” while the count is negative, a dialog appears indicating the post can not proceed and explain which services have a maximum that is exceeded.

The Web server 1804 aggregation service user interface provides a limited image of a Facebook™ page. It may show. For example, in happenings 2320, a friends picture and name in a list. The Facebook™ picture may be downloaded from Facebook™ directly, and retained on the device as a contact. It will be saved on the server when the device syncs to the server. Clicking on the area of the screen shows the name, their main picture, their last status and any comments on that status. You can click on the persons' name to open the direct access connection to the Facebook™ mobile for that person's wall. Alternatively, you can click on Facebook™ icon to jump to Facebook™ direct access (not through the aggregation service).

For News feeds, such as the RSS feeds discussed above, a brief comment and a picture are may be pushed to the device. The picture will be displayed with a brief summary. The user may click on the article to get additional information from the content provider. This process can be automated by recognizing the file input fields—they are of the special HTML type file—and prompting the user to select pictures to include. However, this can be further enhanced by configuring the steps needed to make an update. For each social website, server can include a script which specifies actions which the user can perform on that site, and how to send those actions to the site over a standard HTTP connection; the browser would then present these actions to the user in a menu, prompt for the required inputs, and send the whole lot off to the site.

The Core Web Services will support social network messaging through the Sync framework and actions upon messages through an SNMAIL application (processor proxy).

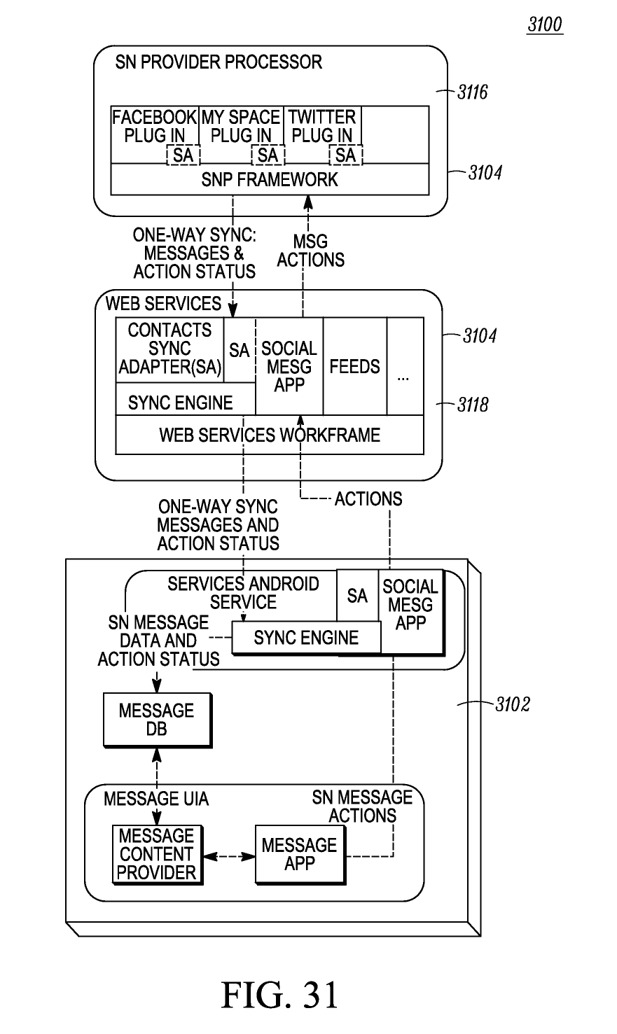

FIG. 31 illustrates the exemplary messaging layers in an exemplary aggregate service system 3100. Actions such as status updates, photo uploads, messages, and comments, are sent from the device 3102 to the web server front end portion 3118. The actions are input in a universal format that is independent of the destination content provider website, other than the identity of the target being included. The front end communicates the message and the back-end processor 3116, which handles the action in the plug-in dedicated to the content provider website. For example, if the action is post a message to Facebook™ and Twitter™, the universal message of the device is formatted in the Facebook plug-in and the Twitter plug-in. Each of the plug-ins will persist in uploading its respective properly formatted content to the content provider website for Facebook™ and Twitter™.

As also illustrated in FIG. 31, the messages and their attributes and action status codes are sent to the device via one-way sync after being pulled by the back-end 3116 and sent to the front end 3118. The service call to update messages and action status will be done via a synchronous one-way sync call.

The back-end 3116 support the communication to and from the social networks themselves. The front-end 3118 and device 3102 maintain sync engine by which certain information, such as contacts, are synchronized between the device and the server 104.

The server 3104 can send the provider settings to the device 3102 via the accounts setup service. This is only one-way (from the service to the device) and does not require sync to make this work. A category for Messages is created on the device which can contain the allowed message attributes supported by each provider and the allowed actions that can be performed on the data.

The Web server 3104 aggregation service phone should maintain a database of messages that contain the provider ID and all the fields to support a message plus the sync meta data. For receiving data from the service, the device must handle a change list of message attributes and action status from the service. This includes all the attributes of a message. For example, the change list may contain:

Synch Message Change List
<< Synch Message Change List Item 1 >>
<< Synch Message Change List Item 2 >>
<< Synch Message Change List Item 3 >>
. . .
<< Synch Message Change List Item n >>

Synch Message Change List Item

changeType = <CHANGE|ADD|REMOVE>
contents = <Message Attributes>

Message Attributes

toAddressList: String list*
fromAddress:String
body
providerID:Long
mesgGUID:Long
messageState:enum/Integer(Read,Unread, etc.)
[subject:String]
[ThreadID:Long]
[attachmentUrlList:String List]
[folderName:String]
[flag:Integer]
[importance:Integer]

The items in brackets are those that are optional. Not all providers support subject, for example. The data type with a ‘*’ is an optional list where 1 or none may be in the list (Facebook™ supports multiple addressees whereas others support only one, for example). The mesgGUID is the global ID shared between the device and the service. The ID between the provider and the service may be a different ID. It is assumed that all providers support referencing messages by a GUID.

In this approach, the following are the assumptions: 1. Actions are passed to service via WS call. The action format is defined below; 2. The server returns an immediate OK saying that the action is accepted for processing or returns an error if it could not queue this action; 3. The server asynchronously processes this request (in the processor) and when finished, issues a Push to the device with the Push Manager; and 4. The device, using one-way sync, the client submits a GET request with its last server anchor and this results in a response body containing messages and action status as defined by the sync protocol (e.g., HTTP GET to /ws/sync/1/update/{account_id}/{device_id}/{app_id}/{last_serve_anchor}?devkey=and roid&format=json). The sync app_id field will be 3 for SNMail.

The device recognizes that PUSH is not reliable and must timeout and retry the action again if it expected a PUSH response. If the PUSH channel is knowingly disconnected (eg in the Roaming case), the device must perform an action and message sync with a polling interval. In one embodiment, there are 2 timeout conditions: 1. The action sending WS call may timeout; and 2. The push may never be received. In either case, the client application must handle these timeouts.

The status table may contain useful information to the client. In one embodiment a status code of 1 indicates that the process finished successfully, a status code of 0 indicates that data is received and an action is in progress and a status code of −1 may indicate that an error occurred. An Action ID may shared by the service and the device. This may be needed to allow the service to report back on the status of the action (synced back to the device with 1-way sync to the Status table). Sync the data received back via sync is through a classic synchronous one-way sync, there are no changes required to the sync framework.

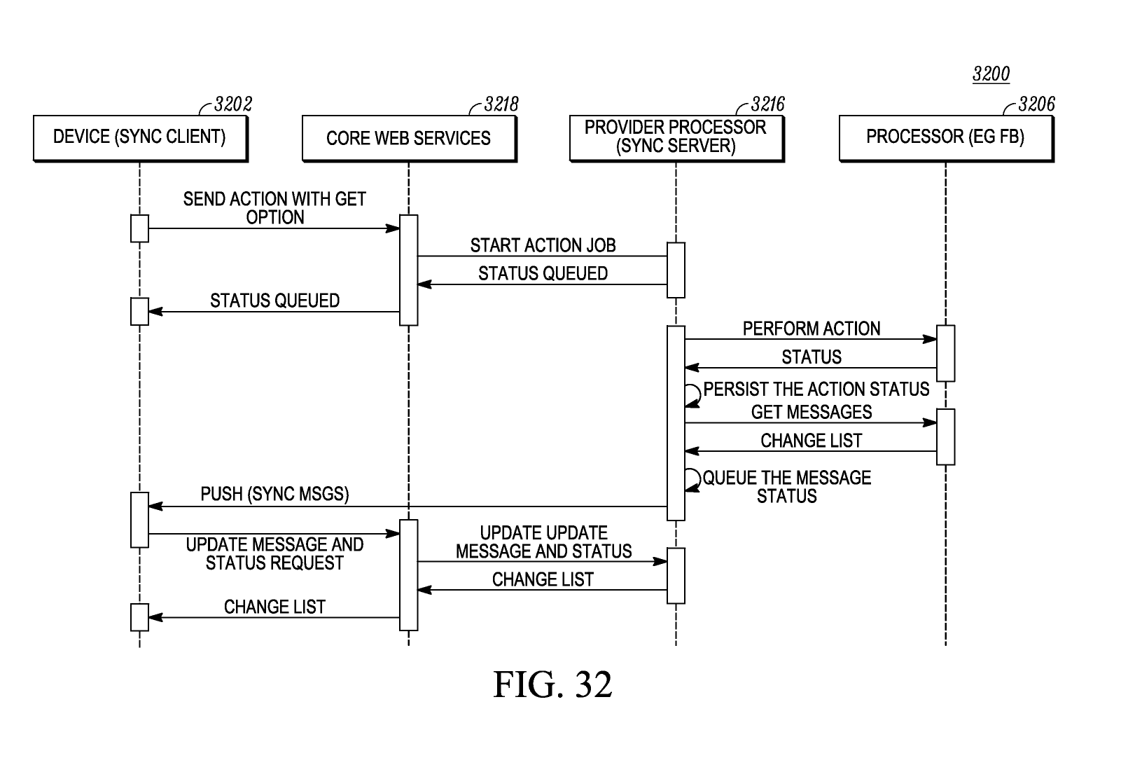

FIG. 32 illustrates an exemplary protocol in accordance with one embodiment. Message actions can be sent to an SNMail application utilizing a Friend Feed -like protocol. The server may need an argument of the action which is the message ID that the server is acting on. For example, the snmail action WS call is of this format: /ws/snmail/$version/$res/$accountid/$deviceid?<standardparams>(Version 1 SNMAIL Action WS API, $res is a resource that is ‘a’ for actions.)

Exemplary message attributes are:

| Name | Value |
|---|---|
| Body | utf8-string with body data |
| Folder Name | utf8 String with the folder name |
| Subject | utf8 String with subject data |
| ReadState | boolean (false = unread, true = read) |
| Priority | Integer |
| Flag | Integer |
| AttachURL | utf8 String |
| ThreadID | Long |
| MessageID | Long |
| ToMemberIDs | destination list: [“id1”, “id2”, “id3”, . . . , “id<n>” |
| ToSmtpAddresses | destination email address list: |
| | [“address1@mail.com, . . .] |

Actions can be prefaced by an action header. The action header may contain the following:

| Name | Description |
|---|---|
| actionID | Long GUID identifying this action |
| actionType | Type of the action to perform (see below in actions) |
| providerName | Identifier for the provider |

The actions may be one or more of the mfollowing:

| Action Type | Description | Params |
|---|---|---|
| sendMsg | Send a new message | <message attributes> |
| | for a given provider | |
| replyMsg | Reply to an existing | <message attributes> |
| | message | |
| deleteMsg | delete a message | messageID, folderName |
| | | (MySpace only) |
| deleteThread | Delete a thread | threadID |
| forwardMsg | Forward a message to a | <message attributes> |
| | contact | |
| markReadMsg | Mark the read state as | messageID, folderName |
| | read for a message | (MySpace only) |
| markUnReadMsg | Mark the read state as | messageID, folderName |
| | unread for a message | (MySpace only) |
| moveMsg | Move a message to a | messageID, folderName |
| | given folder | |
| flagMsg | Flag a message for | messageID, flag |
| | follow-up | |
| setPriMsg | Set a message priority/ | messageID, priority |
| | importance | |
| replyThread | Reply to an existing | <message attributes> |
| | thread | |
| forwardThread | Forward a thread | <message attributes> |
| markReadThread | Mark the read state as | threadID |
| | read for a thread | |
| markUnReadThread | Mark the read state as | threadID |
| | unread for a thread | |
| moveThread | Move a thread to a | threadID, folderName |
| | given folder | |
| flagThread | Flag a thread for | threadID, flag |
| | follow-up | |
| setPriThread | Set a thread priority/ | threadID, priority |
| | importance | |
| createFolder | Create a storage folder | folderName |
| | for the message | |
| syncMessages | Force a provider get | anchor, [limit (integer |
| | of messages (on | max # to go get)] |
| | demand sync) | |

Actions and parameters can be sent as a JSONArray and lilts can be sent as JSON arrays. The action result can be stored by the server in a Status table which is subsequently synced by the client. For code-level enforcement and efficiency purposes, action types will be transmitted as an ENUM rather than a name whose value will be shared by the client and server. The syncMessages action has an anchor as a parameter because the sync action is done in the background. The anchor will tell the processor if the device may have been wiped of its messages by sending anchor 0.

The snmail app can have a notification API to implement the push to devices when a sync is required. This may be, for example, the URI: /ws/snmail/0/n

It is specifically intended that the present invention not be limited to the embodiments and illustrations contained herein, but include modified forms of those embodiments including portions of the embodiments and combinations of elements of different embodiments as come within the scope of the following claims.

What is claimed is:

1. An aggregate service server, configured to communicate with a user device and a plurality of different content providers, comprising:
a processor configured to obtain content from the plurality of different content providers and further configured to push the obtained content to the user device.

2. The aggregate service server of claim 1, wherein the processor is further configured to receive a status update from the user device and to transmit the status update to a corresponding one of the plurality of content providers.

3. The aggregate service server of claim 1, further comprising:
a plurality of plug-ins, each corresponding to a respective one of the plurality of content providers and configured to transmit and receive communications from the corresponding content provider.

4. The aggregate service server of claim 3, further comprising:
a memory,
wherein the processor is further configured to receive an update from one of the plug-ins, to assign a priority to the update and to store the update and the assigned priority in the memory.

5. The aggregate service server of claim 4, wherein the processor is further configured to schedule a push to the user device based upon the assigned priority to the received update.

6. The aggregate service server of claim 5, wherein the processor is further configured to receive a request for data from the user device and is further configured to push any updates stored in the memory to the user device.

7. The aggregate service server of claim 6, wherein the request for data is a single request for updates from all of the content providers.

8. The aggregate service server of claim 4, wherein each plug-in is configured to reformat the received update into a format compatible with the user device.

9. The aggregate service server of claim 7, wherein the processor is further configured to push the received content to a plurality of user devices associated with a single account by:
monitoring the content pushed to each of the user devices; and
pushing content to each of the user devices based upon the monitoring.

10. A method of controlling communications between a client device and a plurality of content providers using an intermediate server, comprising:
receiving, by the intermediate server, an update from one of the plurality of content providers;
assigning, by the intermediate server, a priority to the received update; and
scheduling, by the intermediate server, a push of the received update to the client device based upon the assigned priority.

11. The method of claim 10, further comprising:
receiving, by the intermediate server, a single request from the client device for an update; and
pushing updates, by the intermediate server, to the client device from all of the content providers in response to the single request.

12. The method of claim 10, further comprising:
monitoring the updates that have been pushed to the client device; and
pushing updates to the user devices based upon the monitoring.

13. The method of claim 10, further comprising:
reformatting the received update into a format compatible with the client device.

14. The method of claim 10, further comprising:
periodically pushing updates to the client device.

15. The method of claim 10, further comprising:
pushing an update to the client device when the update is assigned a high priority.

16. An intermediate server, configured to communicate with a user device and a plurality of different content providers, comprising:
a memory;
a content provider processor configured to obtain updates from the plurality of different content providers and to store the updates in the memory; and
a core services processor configured to push the updates stored in memory to the user device.

17. The intermediate server of claim 16, wherein the content provider processor is further configured to reformat the obtained updates from the plurality of different content providers into a format compatible with the user device.

18. The intermediate server of claim 16, wherein the core services processor assigns a priority to the obtained updates stored in the memory.

19. The intermediate server of claim 18, wherein the core services processor schedules a push of the obtained updates stored in memory to the user device based upon the assigned priority.

20. The intermediate server of claim 16, wherein the core services processor deletes the obtained updates from the memory after the obtained updates have been pushed to the user device.
